(19) United States
(12) Patent Application Publication
(10) Pub. No.: US 2026/0329760 A1
(43) Pub. Date: Oct. 22, 2026

(54) Interconnecting CXL Memory Pools in Mixed Environments

(71) Applicant: UnifabriX Ltd., Haifa (IL)

(72) Inventors: Ronen Aharon Hyatt, Haifa (IL); Gaya Opal Hyatt, Haifa (IL); Ethan Sharon Hyatt, Haifa (IL); Gil Thieberger, Kiryat Tivon (IL)

(73) Assignee: UnifabriX Ltd., Haifa (IL)

(21) Appl. No.: 19/723,941

(22) Filed: Jun. 29, 2026

Related U.S. Application Data
(63) Continuation-in-part of application No. 19/707,827, filed on Jun. 15, 2026.
Application No. 19/707,827 is a continuation-in-part of application No. 19/315,590, filed on Aug. 31, 2025.
Application No. 19/315,590 is a continuation of application No. 18/611,472, filed on Mar. 20, 2024, now Pat. No. 12,423,226.
Application No. 18/611,472 is a continuation-in-part of application No. 18/495,743, filed on Oct. 26, 2023, now abandoned.
(60) Provisional application No. 63/419,688, filed on Oct. 26, 2022.

(51) Int. Cl. G06F 12/02

(52) U.S. Cl. CPC G06F 12/0246

(57) ABSTRACT

Implementations for producing a unified representation of memory access tracking across a CXL fabric. A first analyzer associated with a first portion of the CXL fabric produces first telemetry of memory accesses at a first resolution comprising a multi-level heat-map of accesses to memory regions in the first portion. A second analyzer associated with a second portion of the CXL fabric produces second telemetry of memory accesses at a second resolution, lower than the first resolution, comprising a binary hot-or-cold classification of memory regions in the second portion. A computer receives the first telemetry and the second telemetry and produces the representation of memory access tracking across the CXL fabric comprising values calculated based on the first telemetry and from the second telemetry, the representation usable by a memory tiering algorithm to determine mapping of memory regions across the CXL fabric.

### CROSS-REFERENCE TO RELATED APPLICATIONS

This Application is a Continuation-In-Part of U.S. Patent Application No. 19/707,827, filed Jun. 15, 2026, which is a Continuation-In-Part of U.S. Patent Application No. 19/315,590, filed Aug 31, 2025, which is a Continuation of U.S. Application No. 18/611,472, filed Mar. 20, 2024, now US Patent No. 12,423,226, which is a Continuation-In-Part of U.S. Application No. 18/495,743, filed Oct 26, 2023, which claims priority to U.S. Provisional Patent Application No. 63/419,688, filed Oct 26, 2022.

### BACKGROUND

Compute Express Link (CXL) is a cache-coherent interconnect standard used between processors, accelerators, and memory devices. A CXL fabric may include hosts, memory pools, and CXL switches, with memory resources distributed across the fabric. A given CXL fabric may include products of different vendors and different generations of the CXL specification, deployed together in a single fabric. Memory tiering software and hardware may determine mapping of memory regions across the memory resources of a CXL fabric, and may revise the mapping over time.

### SUMMARY

In various implementations, a system comprises a CXL fabric comprising memory resources distributed across hosts, memory pools, or CXL switches; a first analyzer associated with a first portion of the CXL fabric and configured to produce first telemetry of memory accesses at a first resolution, the first telemetry comprising a multi-level heat-map characterizing intensity of accesses to memory regions in the first portion of the CXL fabric; a second analyzer associated with a second portion of the CXL fabric and configured to produce second telemetry of memory accesses at a second resolution lower than the first resolution, the second telemetry comprising a binary hot-or-cold classification of memory regions in the second portion of the CXL fabric; and a computer configured to receive the first telemetry from the first analyzer and the second telemetry from the second analyzer, and to produce a representation of memory access tracking across the CXL fabric based on the first telemetry and the second telemetry, the representation comprising values calculated based on the first telemetry and the second telemetry, the representation usable by a memory tiering algorithm to determine mapping of memory regions across the CXL fabric.

In other implementations, an apparatus comprises an IC package comprising processing cores coupled via a coherent interconnect; at least one CXL port within the IC package and configured to communicatively couple the apparatus to a CXL fabric, the CXL fabric comprising memory resources distributed across hosts, memory pools, or CXL switches; and circuitry within the IC package and coupled to the coherent interconnect, configured to receive first telemetry produced by a first analyzer at a first resolution, the first telemetry comprising a multi-level heat-map characterizing intensity of accesses to memory regions in a first portion of the CXL fabric; receive second telemetry produced by a second analyzer at a second resolution lower than the first resolution, the second telemetry comprising a binary hot-or-cold classification of memory regions in a second portion of the CXL fabric; and produce, based on the first telemetry and the second telemetry, a representation of memory access tracking across the CXL fabric, the representation comprising values calculated based on the first telemetry and the second telemetry, the representation usable by a memory tiering algorithm to determine mapping of memory regions across the CXL fabric.

In yet other implementations, a method comprises producing, by a first analyzer associated with a first portion of a CXL fabric, first telemetry of memory accesses at a first resolution, the first telemetry comprising a multi-level heat-map characterizing intensity of accesses to memory regions in the first portion of the CXL fabric, the CXL fabric comprising memory resources distributed across hosts, memory pools, or CXL switches; producing, by a second analyzer associated with a second portion of the CXL fabric, second telemetry of memory accesses at a second resolution lower than the first resolution, the second telemetry comprising a binary hot-or-cold classification of memory regions in the second portion of the CXL fabric; receiving, by a computer, the first telemetry from the first analyzer and the second telemetry from the second analyzer; and producing, by the computer based on the first telemetry and the second telemetry, a representation of memory access tracking across the CXL fabric, the representation comprising values calculated based on the first telemetry and the second telemetry, the representation usable by a memory tiering algorithm to determine mapping of memory regions across the CXL fabric.

### BRIEF DESCRIPTION OF THE DRAWINGS

FIG. 1A illustrates an example of a system comprising first and second analyzers utilized for memory tiering;

FIG. 1B illustrates an example of an apparatus comprising an IC package, which receives telemetry from first and second analyzers, and produces representation of memory access tracking across CXL fabric;

FIG. 1C illustrates an example of a method for producing first and second telemetry at different resolutions usable for memory tiering;

FIG. 2A illustrates an example of a system that includes CXL.mem handling logic and a memory traffic analyzer;

FIG. 2B illustrates an example of a CPU that includes processing cores, CXL.mem handling logic, and a memory traffic analyzer;

FIG. 2C illustrates an example of a method for identifying candidate memory addresses for promotion or demotion;

FIG. 3A illustrates an example of a processor including a resource composer, a memory traffic analyzer, and cores, couple to entities via CXL ports;

FIG. 3B illustrates an example of a memory pool including a resource composer and a memory traffic analyzer, coupled to entities via CXL ports;

FIG. 3C illustrates an example of a method for managing mapping of portions of remote memory address regions to DRAMs of different back-end entities;

FIG. 4A illustrates an example of a system comprising a storage system with an NVMe device, CXL memory expanders, and a processor hosting a resource composer that aggregates per-expander telemetry and determines mapping of NVMe cache elements across the CXL memory expanders;

FIG. 4B illustrates an example of a storage system in which a CXL memory expander (comprising DRAM), coupled to a processor in parallel to an NVMe device, provides DRAM cache for the NVMe device;

FIG. 4C illustrates an example of a method for caching lines corresponding to data of an NVMe device in DRAM of a CXL memory expander;

FIG. 5A illustrates an example of a processor having a first CXL port coupled to a CXL memory device and a second CXL port coupled to an accelerator, together with a memory traffic analyzer;

FIG. 5B illustrates an example of a method of producing a combined memory-access tracking output from telemetry of CXL.mem traffic and telemetry of CXL.cache traffic;

FIG. 6A illustrates an example of a system in which NVMe storage elements are coupled to a CXL fabric, a memory traffic analyzer grades memory resources contributed across the CXL fabric, and a resource composer couples graded subsets of the memory resources as cache to the NVMe storage elements;

FIG. 6B illustrates an example of a system in which a processor integrates a memory traffic analyzer and a resource composer that grade memory resources and couple graded subsets of the memory resources as cache to NVMe storage elements through CXL ports;

FIG. 6C illustrates an example of a method for coupling higher-grade and lower-grade subsets of memory resources as caches to NVMe storage elements;

FIG. 7A illustrates an example of a processor configured to expose an NVMe device to a first entity and to harvest underutilized memory from DRAM at one or more additional entities;

FIG. 7B illustrates an example of a system comprising a logical device, a memory traffic analyzer, and a plurality of entities coupled via CXL;

FIG. 7C illustrates an example of a method for mapping portions of an NVMe namespace's LBA space to harvested-and-graded DRAM regions across contributing entities;

FIG. 8A illustrates a processor comprising a memory tiering engine integrated together with processing cores, coupled via CXL to a memory pool that aggregates DRAM from external entities;

FIG. 8B illustrates a system comprising a memory pool, which aggregates DRAM from second and third entities, and exposes a remote memory address region;

FIG. 8C illustrates an example of a method for exposing a remote memory address region aggregated from multiple DRAMs of multiple different entities;

FIG. 9A is an example of an apparatus that translates addresses between an entity and a memory pool;

FIG. 9B is an example of a processor that translates addresses between an entity and a memory pool;

FIG. 9C illustrates an example of a method for translating addresses carried by received requests to addresses within an address space of a memory pool aggregating two or more sources;

FIG. 10A illustrates an example of a processor that exposes dynamic capacity blocks of memory to an external host over a CXL port;

FIG. 10B illustrates an example of a method for exposing dynamic capacity of memory that changes during runtime of the external host without requiring a reset of the external host;

FIG. 11A illustrates an implementation in which a processor aggregates DRAM contributed via CXL, and exposes the aggregated DRAM as a DRAM cache for a controller of an NVMe device;

FIG. 11B illustrates an example of a system in which a DRAM cache for a controller of an NVMe device may be mapped to DRAM contributed by multiple entities coupled to the NVMe device via CXL; and

FIG. 11C illustrates an example of a method for allocating cache elements of a DRAM cache for an NVMe controller.

### DETAILED DESCRIPTION

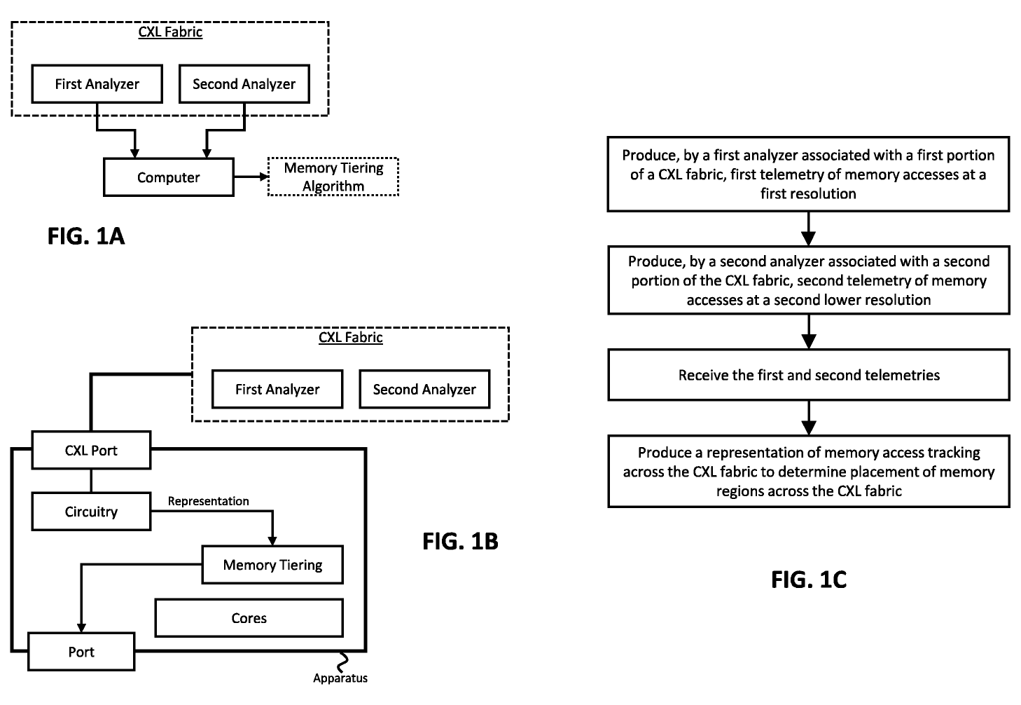

FIG. 1A illustrates an example of a system comprising a CXL fabric, a first analyzer in a first portion of the CXL fabric, a second analyzer in a second portion of the CXL fabric, and a computer that produces a representation of memory access tracking across the CXL fabric based on telemetry from the first analyzer and the second analyzer. The representation is utilized by a memory tiering algorithm.

A CXL fabric assembled from products of different vendors and different specification generations may include memory access tracking analyzers of different resolutions and different output formats. Some analyzers may produce a multi-level intensity value per memory region; other analyzers may produce a single-bit hot-or-cold indication per memory region. A memory tiering algorithm that consumes telemetry directly from such heterogeneous analyzers may be unable to make coherent mapping decisions across the CXL fabric, because the intensity scales, region sizes, temporal granularities, and access-type filters of the underlying analyzers may differ. The subject matter described below addresses this through a computer that consumes telemetry from at least two analyzers of different resolutions and produces a representation of memory access tracking across the CXL fabric, the representation usable by the memory tiering algorithm without the algorithm having to interpret each underlying telemetry source separately.

In various implementations, a system comprising: a Compute Express Link (CXL) fabric comprising memory resources distributed across at least one of hosts, memory pools, or CXL switches; a first analyzer associated with a first portion of the CXL fabric, the first analyzer configured to produce first telemetry of memory accesses at a first resolution, wherein the first telemetry comprises a multi-level heat-map characterizing intensity of accesses to memory regions in the first portion of the CXL fabric; a second analyzer associated with a second portion of the CXL fabric, the second analyzer configured to produce second telemetry of memory accesses at a second resolution lower than the first resolution, wherein the second telemetry comprises a binary hot-or-cold classification of memory regions in the second portion of the CXL fabric; and a computer configured to receive the first telemetry from the first analyzer and the second telemetry from the second analyzer, and to produce a representation of memory access tracking across the CXL fabric based on the first telemetry and the second telemetry, wherein the representation comprises values calculated based on the first telemetry and the second telemetry, and wherein the representation is usable by a memory tiering algorithm to determine mapping of memory regions across the CXL fabric. The first analyzer may be implemented as a circuit within a host of the CXL fabric, as a circuit within a CXL switch, or as a circuit within a CXL device, and may include a counter database, a sampling circuit, a tag-based access tracker, or any combination thereof, that produces values for the memory regions identified by the first analyzer. The second analyzer may be implemented as a circuit within a CXL device, a circuit within a CXL switch, a circuit within a CXL memory pool, or as firmware operating on a controller of any of the foregoing, that emits a hot-or-cold indication per memory region based on a threshold and an epoch. The computer may be implemented as a circuit within a host processor, as instructions executed by a controller of a CXL switch, as a finite state machine within an integrated circuit package, or as firmware executing on an embedded controller of a fabric manager. Producing the representation by the computer may include the following operations: (1) receiving the first telemetry from the first analyzer and the second telemetry from the second analyzer through respective interfaces; (2) for each memory region appearing in the first telemetry or the second telemetry, determining a value for the representation from a contribution derived from the first telemetry, a contribution derived from the second telemetry, or both, depending on which of the first telemetry or the second telemetry covers the memory region; (3) populating the representation with the determined values per memory region of the CXL fabric; and (4) making the representation accessible to the memory tiering algorithm through an interface. The computer may produce a per-memory-region value of the representation independently of the underlying resolution at which each contribution was produced, so that the same producing operation may apply across analyzers that produce telemetry at any resolution within a range from a single-bit hot-or-cold indication to a multi-bit intensity value. At the low corner of the resolution range, a contribution derived from a hot-or-cold indication of the second telemetry may be mapped to a single value of the per-memory-region value of the representation; a contribution derived from a multi-bit intensity value of the first telemetry may be mapped to a multi-bit value of the per-memory-region value of the representation. Because the representation comprises values derived from the first telemetry and from the second telemetry, the memory tiering algorithm may operate on the representation without separate evaluation of each underlying telemetry source, and mapping of memory regions across the CXL fabric may be determined for memory regions in the first portion of the CXL fabric and memory regions in the second portion of the CXL fabric jointly.

In some implementations of the system, at least one of: (i) the first analyzer comprises a spatio-temporal (ST) analyzer, the ST analyzer comprising a counter database configured to maintain access counters associated with the memory regions in the first portion of the CXL fabric and a temporal decay function configured to reduce values of the access counters over time, wherein the multi-level heat-map is derived from values of the access counters of the counter database; (ii) the second analyzer comprises a CXL Hot-Page Monitoring Unit defined by a CXL specification, and the second telemetry comprises a hot list produced by the CXL Hot-Page Monitoring Unit and accessible to the computer; or (iii) the memory tiering algorithm comprises an autonomous tiering algorithm configured to issue, based on the representation, instructions to migrate at least a portion of the memory regions among the memory resources of the CXL fabric, without intervention by an operating system of any of the hosts of the CXL fabric. The counter database of the spatio-temporal analyzer may be implemented in on-die SRAM, in attached DRAM, or in a register file of an embedded controller, and the temporal decay function may be implemented as a periodic shift operation, as a multiply-and-subtract operation, or as a saturating arithmetic operation applied to each access counter on each epoch boundary. The hot list of the CXL Hot-Page Monitoring Unit may be exposed through a memory-mapped register interface read by the computer on a polling basis or on an event-driven basis. The autonomous tiering algorithm may execute on a controller of the computer or on a separate processor coupled to the computer, and may issue migration instructions through a fabric management command interface. Any one of the spatio-temporal analyzer, the CXL Hot-Page Monitoring Unit, and the autonomous tiering algorithm may be combined with the computer of the system such that the computer consumes the access counters or the hot list and supplies the representation to the autonomous tiering algorithm. Because each of these structural anchors may correspond to a distinct vendor-specific or specification-defined entity, the representation may be produced across CXL fabrics that include analyzers and tiering circuits of different origin.

In some implementations of the system, the computer comprises a Central Processing Unit (CPU), the CPU comprising processing cores coupled via a coherent interconnect, the computer configured to produce the representation by accessing the first telemetry and the second telemetry through the coherent interconnect, and wherein at least one of: (i) the computer is integrated in a same integrated circuit package as the processing cores, and the computer is configured to produce the representation without the first telemetry and the second telemetry traversing a link external to the integrated circuit package; (ii) the CPU comprises a memory controller, the computer is integrated with the memory controller, and the computer is configured to access at least one of the first telemetry or the second telemetry via the memory controller; (iii) the CPU comprises a Memory Management Unit (MMU) configured to translate virtual addresses to physical addresses within a host physical address (HPA) space, and the computer is configured to map at least one of the values of the representation from a device physical address space utilized by one of the analyzers to the HPA space, utilizing translations of the MMU; or (iv) the CPU comprises at least one CXL port configured to receive the second telemetry over a CXL link external to the CPU, and the first analyzer is integrated in the CPU and configured to produce the first telemetry from memory access requests traversing the coherent interconnect. The computer integrated in the integrated circuit package may be implemented as a fixed-function circuit on a die of the integrated circuit package, or as firmware executing on an embedded controller of the integrated circuit package. The memory controller of the CPU may include a circuit that maintains access counters for the memory regions accessible through the memory controller and may forward the access counters to the computer over an internal bus of the integrated circuit package. The translations of the MMU may include translations between the HPA space and a device physical address space exposed by a CXL device, such that values of the representation may identify memory regions by addresses within the HPA space regardless of which physical address space each underlying telemetry source uses. The first analyzer integrated in the CPU may be implemented as a probe circuit on the coherent interconnect, sampling memory access requests traversing the coherent interconnect at a configurable rate. Each of these alternatives may be combined with the computer producing the representation by mapping values derived from the first telemetry and from the second telemetry to a common intensity scale, such that the producing of the representation and the mapping of the values may both occur within the integrated circuit package. Because at least one of the first telemetry or the second telemetry may be consumed by the computer through paths internal to the integrated circuit package, latency between production of the underlying telemetry and availability of the representation to the memory tiering algorithm may be reduced relative to consumption through paths external to the integrated circuit package.

In some implementations of the system, at least one of: (i) the computer comprises a fabric manager, the fabric manager configured to receive the first telemetry and the second telemetry through a fabric management command interface defined by a CXL specification, and to provide the representation through the fabric management command interface to the memory tiering algorithm; or (ii) the computer comprises a fabric controller separate from the first analyzer and from the second analyzer, the fabric controller communicatively coupled to the first analyzer through a first link and to the second analyzer through a second link, the fabric controller configured to receive the first telemetry through the first link and the second telemetry through the second link. The fabric manager may be implemented as instructions executing on a processor of a management host, as firmware on a baseboard management controller, or as a circuit within a fabric management apparatus. The fabric management command interface defined by the CXL specification may be used both to receive the first telemetry and the second telemetry from the analyzers and to deliver the representation to the memory tiering algorithm, such that the standardized command interface may carry traffic of either direction. The fabric controller separate from the first analyzer and from the second analyzer may be implemented as a stand-alone integrated circuit communicatively coupled to the analyzers through CXL links, Ethernet links, or PCIe links forming the first link and the second link. Because the fabric manager and the fabric controller are alternative implementations of the computer, the representation may be produced by a circuit local to the management plane of the CXL fabric in either case.

In some implementations of the system, at least one of: (i) the first analyzer is integrated with a host of the CXL fabric, and the second analyzer is integrated with a CXL Type 3 device of the CXL fabric, the CXL Type 3 device exposing host-managed device memory (HDM) to the host; (ii) the first analyzer is integrated with a Central Processing Unit (CPU) of a host of the CXL fabric, and the second analyzer is integrated with at least one of a CXL memory pool, a CXL Global Fabric-Attached Memory Device (GFD), or a CXL switch; or (iii) the system further comprises a third analyzer associated with a third portion of the CXL fabric and integrated with a CXL switch of the CXL fabric, the third analyzer configured to produce third telemetry of memory accesses traversing the CXL switch, and the computer is further configured to produce the representation further based on the third telemetry. The first analyzer integrated with the host may be implemented as a circuit on a coherent interconnect of the host, on a memory controller of the host, or on an integrated CXL port of the host. The second analyzer integrated with the CXL Type 3 device may be implemented as a circuit on the CXL device that observes memory access requests received over CXL.mem. The second analyzer integrated with the CXL memory pool, the CXL Global Fabric-Attached Memory Device, or the CXL switch may be implemented as a circuit on a port of the respective device. The third analyzer integrated with the CXL switch may be implemented as a circuit observing memory access requests as the requests are forwarded between ports of the CXL switch, and the computer may further combine third telemetry from the third analyzer with the first telemetry and the second telemetry to produce the representation. Because the analyzers are integrated with different entity types of the CXL fabric, the representation may include memory access values across portions of the CXL fabric residing in circuits of different vendors and different generations of CXL specifications.

In some implementations of the system, the computer is further configured to produce the representation by performing at least one of: (i) mapping the values calculated based on the first telemetry and the values calculated based on the second telemetry to a common intensity scale, and populating values of the representation per memory region of the CXL fabric on the common intensity scale; (ii) assigning, to memory regions classified by the second telemetry as hot, a first value on a common intensity scale, and assigning, to memory regions classified by the second telemetry as cold, a second value on the common intensity scale lower than the first value; (iii) combining the values calculated based on the first telemetry with the values calculated based on the second telemetry according to a weighting selected such that the values calculated based on the first telemetry contribute to the representation differently from the values calculated based on the second telemetry; (iv) producing a fabric-wide heat-map normalized across the first portion of the CXL fabric and the second portion of the CXL fabric, the fabric-wide heat-map providing intensity values per memory region on a common scale regardless of which of the first analyzer or the second analyzer produced the underlying telemetry for that memory region; or (v) determining, for at least one memory region within the second portion of the CXL fabric, an intensity value of the representation by combining a hot-or-cold value calculated based on the second telemetry for the at least one memory region and an auxiliary value calculated based on a previously-determined intensity for the at least one memory region maintained by the computer. The common intensity scale may be a numerical range stored in a register of the computer, with a low value indicating cold and a high value indicating hot, and the computer may use a quantization circuit or a quantization instruction sequence to map values derived from the first telemetry and from the second telemetry onto this range. The assignment of a high value to memory regions classified as hot and a low value to memory regions classified as cold may be performed by a lookup table, a comparator circuit, or instructions executing on a controller. The weighting may be applied by a multiplier circuit configured to multiply each contribution by a configurable weight register, the weight registers being writable through a fabric management command interface. The fabric-wide heat-map may be stored as an array indexed by memory region identifier and populated by the computer in passes over the first telemetry and the second telemetry. The auxiliary value derived from a previously-determined intensity may be stored in a per-memory-region cache or in a circular buffer of recent intensities, and the computer may average, weight, or otherwise combine the auxiliary value with a hot-or-cold value to produce the intensity value of the representation. Each of these reconciliation forms may be combined with the computer being implemented within a CPU, such that the reconciliation may be performed within the integrated circuit package of the CPU. Because the values derived from the first telemetry and the values derived from the second telemetry may be expressed on a common intensity scale or in a fabric-wide heat-map, the memory tiering algorithm may compare memory regions in the first portion of the CXL fabric with memory regions in the second portion of the CXL fabric on a comparable basis.

In some implementations of the system, the computer is further configured to perform at least one of: (i) issuing, based on the representation, a migration directive to at least one entity of the CXL fabric, the migration directive identifying at least one memory region of the CXL fabric for migration and a destination among the memory resources of the CXL fabric for the at least one memory region, wherein the at least one entity of the CXL fabric comprises at least one of a CXL switch or a host of the CXL fabric; or (ii) reconfiguring, based on the representation, at least one of the first analyzer or the second analyzer, wherein reconfiguring comprises adjusting at least one of an analysis granularity, an access-type filter, a sampling rate, an epoch duration, a threshold, or a range of memory regions analyzed. The migration directive may be encoded as a command message delivered over a CXL link to a CXL switch identifying a source memory region by address range and a destination memory resource by port identifier, or alternatively as a command delivered to a host of the CXL fabric identifying the source and destination by host-physical-address ranges. Reconfiguration of an analyzer may be issued as a register write to a configuration register of the analyzer through a fabric management command interface. The migration directive and the reconfiguration may both be combined with the computer producing the representation on a common intensity scale, such that the migration target and the reconfiguration target may be selected based on the same per-memory-region values of the representation. Because the computer issues migration directives or reconfigures the analyzers based on the representation, telemetry produced by the analyzers may be focused, over successive epochs, on memory regions that the representation identifies as candidates for mapping change.

In some implementations of the system, at least one of: (i) the first analyzer is configured to produce the first telemetry at a first temporal granularity, the second analyzer is configured to produce the second telemetry at a second temporal granularity coarser than the first temporal granularity, and the second temporal granularity is at least an order of magnitude longer than the first temporal granularity; (ii) the first telemetry characterizes accesses to memory regions of a first size corresponding to a cache-line granularity, and the second telemetry characterizes accesses to memory regions of a second size larger than the first size and corresponding to a page granularity; (iii) the first analyzer is associated with a CXL link configured to support CXL.mem traffic, the second analyzer is associated with a CXL link configured for at least one of CXL.cache traffic or CXL.io traffic, and the computer is further configured to produce the representation by combining the first telemetry and the second telemetry with weightings selected based on differences between the CXL protocols carrying the underlying memory access requests; or (iv) the first telemetry comprises a heat-map structure providing per-region intensity values, the second telemetry comprises an event-stream structure providing time-ordered indications of accesses, and the computer is further configured to derive intensity values from the event-stream structure for inclusion in the representation. The temporal granularity of an analyzer may be set by an epoch register that controls the period over which access counts are accumulated before being emitted to the computer. Cache-line and page granularities of memory regions may be selected by configuring an analyzer's address-masking circuit such that the lower bits of an access address are discarded to a configurable depth. The CXL link sub-protocol carried by a given link may be identified through link-training state maintained in a controller of the link, and weightings applied by the computer to telemetry derived from each sub-protocol may be configured through a register file readable through a fabric management command interface. The event-stream structure of the second telemetry may be implemented as a circular buffer of timestamped access records, and the computer may convert the event stream to intensity values by counting events per memory region within a sliding time window. Each of these heterogeneity dimensions may be combined with the computer producing the representation on a common intensity scale, such that the dimension-specific differences between the first telemetry and the second telemetry may be normalized in the representation. Because the analyzers may differ along any of these dimensions while the computer normalizes the values derived from the telemetry to a per-memory-region representation, the representation may be produced from telemetry sources whose underlying parameters differ.

In some implementations of the system, at least one of the first analyzer, the second analyzer, or the computer is communicatively coupled to another entity through a link based on at least one of NVLink, Ultra Accelerator Link (UALink), or Ethernet Scale-Up Networking (ESUN), and wherein the representation comprises values characterizing memory access patterns to memory accessible through the link. The link based on NVLink, on Ultra Accelerator Link, or on Ethernet Scale-Up Networking may be terminated at a physical-layer circuit that communicates with the analyzer or the computer through an internal interface of the host or device hosting the analyzer or the computer. The representation may include intensity values for memory regions accessible through the link in addition to memory regions accessible through CXL links of the CXL fabric, and the memory tiering algorithm may select mapping destinations including memory accessible through the link. Because memory regions on the far side of a non-CXL scale-up link may be represented in the representation, the memory tiering algorithm may operate across heterogeneous interconnects spanning CXL and non-CXL scale-up technologies.

In some implementations of the system, the hosts of the CXL fabric comprise at least one of a server host, a graphics processing unit (GPU) host, or an artificial intelligence accelerator host, and wherein the mapping of memory regions across the CXL fabric determined by the memory tiering algorithm balances memory accessibility between memory of the hosts and memory of the memory pools according to access patterns indicated by the representation. A server host may be implemented as a multi-socket x86 or Arm server, a GPU host may be implemented as a discrete GPU coupled to a CXL fabric, and an artificial intelligence accelerator host may be implemented as a tensor-processing or sparse-compute accelerator with at least one CXL port. The memory tiering algorithm may evaluate access patterns per host and may rebalance memory regions between memory of the host and memory of a memory pool to keep frequently accessed memory regions closer to the consuming host. Because the representation describes accesses across heterogeneous host types in a common form, the mapping of memory regions may take account of access patterns from different host architectures within the same CXL fabric.

In some implementations of the system, the first analyzer comprises hardware counter circuitry configured to maintain multi-bit access counts per memory region of the first portion of the CXL fabric, wherein the second analyzer comprises a hot-page detection circuit configured to identify, per memory region of the second portion of the CXL fabric, whether an access count exceeds a configurable threshold during an epoch, and wherein the computer is further configured to incorporate, into the representation, the multi-bit access counts of the first analyzer and the hot-page identifications of the second analyzer mapped to a common intensity scale. The hardware counter circuitry may be implemented as a bank of saturating counters with one counter per memory region, indexed by a hash of the memory region address. The hot-page detection circuit may be implemented as a comparator circuit comparing per-region access counts to a threshold register, with a flag register accumulating hot-page identifications during an epoch and being read by the computer at epoch boundaries. The multi-bit access counts and the hot-page identifications may be incorporated into the representation by a quantization circuit of the computer that maps the multi-bit access counts to a high-resolution range of the common intensity scale and maps the hot-page identifications to a single discrete value on the common intensity scale. Because the multi-bit access counts and the hot-page identifications are mapped to a common intensity scale, the memory tiering algorithm may operate uniformly on the representation even when the analyzers contributing to the representation produce telemetry of different output formats.

FIG. 1B illustrates an example of an apparatus comprising an IC package with processing cores, a coherent interconnect, at least one CXL port, and circuitry within the IC package configured to receive telemetry from a first analyzer and a second analyzer and produce a representation of memory access tracking across a CXL fabric.

In various implementations, an apparatus comprising: an integrated circuit (IC) package comprising processing cores coupled via a coherent interconnect; at least one Compute Express Link (CXL) port within the IC package, the at least one CXL port configured to couple the apparatus to a CXL fabric, the CXL fabric comprising memory resources distributed across at least one of hosts, memory pools, or CXL switches; and circuitry within the IC package coupled to the coherent interconnect, the circuitry configured to: receive first telemetry produced by a first analyzer at a first resolution, wherein the first telemetry comprises a multi-level heat-map characterizing intensity of accesses to memory regions in a first portion of the CXL fabric; receive second telemetry produced by a second analyzer at a second resolution lower than the first resolution, wherein the second telemetry comprises a binary hot-or-cold classification of memory regions in a second portion of the CXL fabric; and produce, based on the first telemetry and the second telemetry, a representation of memory access tracking across the CXL fabric, wherein the representation comprises values calculated based on the first telemetry and the second telemetry, and wherein the representation is usable by a memory tiering algorithm to determine mapping of memory regions across the CXL fabric. The integrated circuit package may comprise a monolithic die, a multi-die package interconnected by an interposer, or a chiplet-based package with chiplets coupled by a die-to-die interface. The processing cores may comprise general-purpose cores, accelerator cores, or a combination thereof. The circuitry may be implemented as a fixed-function circuit located on a die of the integrated circuit package, as firmware executing on an embedded controller of the integrated circuit package, or as instructions executing on a subset of the processing cores. The operations of the circuitry may proceed as follows: (1) the circuitry receives the first telemetry through an internal port of the integrated circuit package coupled to the first analyzer, the internal port being part of the coherent interconnect, a fabric management command interface, or a register file shared with the first analyzer; (2) the circuitry receives the second telemetry through one of the at least one CXL port, through a fabric management command interface, or through a port coupled to a second internal source of the second analyzer; (3) the circuitry produces, for each memory region appearing in the first telemetry or the second telemetry, a value calculated based on at least one of the first telemetry or the second telemetry; and (4) the circuitry populates the representation in a buffer of the integrated circuit package and exposes the representation through a register file, a memory-mapped region, or a fabric management command interface. The circuitry may produce the representation in the integrated circuit package independently of which sub-protocol of CXL carries the underlying memory access requests, so that the same producing operation may apply across different CXL link configurations to which the at least one CXL port is connected. At the low end of the apparatus configuration range, the apparatus may have one CXL port and one core complex; at the high end, the apparatus may have many CXL ports and many core complexes. Because the circuitry resides within the integrated circuit package and is coupled to the coherent interconnect, the first telemetry and the second telemetry may be consumed by the circuitry over paths internal to the integrated circuit package where the analyzers contributing the telemetry also reside in the integrated circuit package, and over external CXL links where the analyzers reside outside the integrated circuit package, and the representation may be made available to the memory tiering algorithm in either case.

In some implementations of the apparatus, the first analyzer is within the IC package and configured to produce the first telemetry from memory access requests traversing the coherent interconnect, the second analyzer is external to the IC package and configured to produce the second telemetry from memory access requests received at a CXL device of the CXL fabric, and wherein at least one of: (i) the IC package further comprises a memory controller coupled to the coherent interconnect, and the circuitry is integrated with the memory controller and configured to access at least one of the first telemetry or the second telemetry via the memory controller, without traversal of a link external to the IC package for that access; or (ii) the IC package further comprises a Memory Management Unit (MMU) configured to translate virtual addresses to physical addresses within a host physical address space, and the circuitry is configured to translate, utilizing the MMU, addresses associated with the first telemetry or the second telemetry from a device physical address space utilized by one of the analyzers to the host physical address space, prior to populating values of the representation. The first analyzer within the integrated circuit package may be implemented as a probe circuit on the coherent interconnect or as a counter circuit integrated with a port of the coherent interconnect, while the second analyzer outside the integrated circuit package may be implemented as a circuit on a CXL device of the CXL fabric exposing HDM. The circuitry integrated with the memory controller may share a register file with the memory controller, such that telemetry-related register reads and writes may be issued by the circuitry over internal paths of the integrated circuit package. Because the circuitry may consume telemetry within the integrated circuit package through the memory controller or the MMU, the representation may be assembled with reduced reliance on links external to the integrated circuit package.

In some implementations of the apparatus, the circuitry is further configured to perform at least one of: (i) producing the representation by mapping the values calculated based on the first telemetry and the values calculated based on the second telemetry to a common intensity scale, the common intensity scale spanning the first portion of the CXL fabric and the second portion of the CXL fabric; (ii) issuing, based on the representation, a migration directive over the at least one CXL port to an entity of the CXL fabric, the migration directive identifying at least one memory region of the CXL fabric for migration and a destination among the memory resources of the CXL fabric for the at least one memory region; or (iii) reconfiguring, based on the representation, at least one of the first analyzer or the second analyzer by adjusting at least one of an analysis granularity, a sampling rate, an epoch duration, or a threshold. The common intensity scale may be a fixed-point numerical range stored in a register of the circuitry, and the mapping to the common intensity scale may be performed by a quantization circuit of the circuitry. The migration directive may be encoded as a CXL command formatted in a buffer of the circuitry and transmitted through one of the at least one CXL port to a CXL switch or to a CXL device of the CXL fabric. Reconfiguration of an analyzer may be encoded as a register-write command sent through the at least one CXL port to the analyzer's configuration register, or to a fabric management command interface that forwards the command. These operations may be combined such that the circuitry issues the migration directive and the reconfiguration in successive operations based on the same representation. Because the circuitry performs the mapping, the migration directive, and the reconfiguration within the integrated circuit package and through the at least one CXL port, control and data paths may be unified at the integrated circuit package.

In some implementations of the apparatus, at least one of: (i) the first analyzer comprises a spatio-temporal (ST) analyzer comprising a counter database and a temporal decay function configured to reduce values of access counters of the counter database over time; (ii) the second analyzer comprises a CXL Hot-Page Monitoring Unit defined by a CXL specification; or (iii) the circuitry is configured to operate as a fabric manager, the circuitry configured to expose a fabric management command interface defined by a CXL specification to a memory tiering algorithm executing on the processing cores or on a remote host, and to deliver the representation to the memory tiering algorithm through the fabric management command interface. The counter database of the spatio-temporal analyzer may reside in on-die SRAM or in a register file local to the analyzer, and the temporal decay function may be implemented as a shift register or as an arithmetic decay applied per epoch. The CXL Hot-Page Monitoring Unit may produce a hot list accessible to the circuitry over the coherent interconnect or over the at least one CXL port. The fabric management command interface defined by the CXL specification may be exposed by the circuitry to consumers on the processing cores through a memory-mapped region of the integrated circuit package, and exposed to consumers on a remote host through one of the at least one CXL port. Because the circuitry of the integrated circuit package may operate as a fabric manager using a standardized command interface, the representation produced by the circuitry may be consumed by either a local memory tiering algorithm executing on the processing cores or a remote memory tiering algorithm through a single delivery interface.

In some implementations of the apparatus, the IC package further comprises a CXL device exposing host-managed device memory (HDM) to at least one of the hosts of the CXL fabric, and wherein the circuitry is configured to identify, based on the representation, memory regions within the HDM that are candidates for promotion or demotion among the memory resources of the CXL fabric. The CXL device within the integrated circuit package may be implemented as a Type 3 device exposing a region of memory within the integrated circuit package as HDM to a host through one of the at least one CXL port. Candidates for promotion may be identified as memory regions of the HDM whose intensity values in the representation exceed a promotion threshold; candidates for demotion may be identified as memory regions whose intensity values fall below a demotion threshold. Because the circuitry identifies candidates within the HDM based on the representation that already covers other portions of the CXL fabric, candidate selection may take account of access patterns to memory regions outside the integrated circuit package.

In some implementations of the apparatus, at least one of: (i) a CXL port of the at least one CXL port is further configured to operate over a physical layer based on a non-CXL scale-up interconnect comprising at least one of NVLink, Ultra Accelerator Link (UALink), or Ethernet Scale-Up Networking (ESUN), and the representation comprises values characterizing memory access patterns to memory accessible through the non-CXL scale-up interconnect; or (ii) the processing cores comprise at least one hidden core, the at least one hidden core isolated from user access and configured to execute at least a portion of the operations of the circuitry, the at least a portion of the operations comprising at least one of receiving the first telemetry, receiving the second telemetry, or producing the representation. The CXL port operating over a physical layer of NVLink, Ultra Accelerator Link, or Ethernet Scale-Up Networking may be implemented as a port whose physical-layer circuit can be configured at link-training time to use either a CXL physical layer or one of the non-CXL physical layers, with the upper protocol layers carrying CXL traffic in either case. The hidden core may be implemented as a processing core that is not exposed to operating system enumeration, and may execute firmware that performs operations of the circuitry while exposing the representation through an interface visible to the operating system without exposing internal state of the operations to the operating system. Because the operations of the circuitry may be performed by a hidden core or carried over a non-CXL scale-up physical layer, the apparatus may participate in CXL fabrics that span scale-up technologies and may execute the operations on resources isolated from general processing workloads.

In various implementations, a method comprising: producing, by a first analyzer associated with a first portion of a Compute Express Link (CXL) fabric, first telemetry of memory accesses at a first resolution, wherein the first telemetry comprises a multi-level heat-map characterizing intensity of accesses to memory regions in the first portion of the CXL fabric, and wherein the CXL fabric comprises memory resources distributed across at least one of hosts, memory pools, or CXL switches; producing, by a second analyzer associated with a second portion of the CXL fabric, second telemetry of memory accesses at a second resolution lower than the first resolution, wherein the second telemetry comprises a binary hot-or-cold classification of memory regions in the second portion of the CXL fabric; receiving, by a computer, the first telemetry from the first analyzer and the second telemetry from the second analyzer; and producing, by the computer based on the first telemetry and the second telemetry, a representation of memory access tracking across the CXL fabric, wherein the representation comprises values calculated based on the first telemetry and the second telemetry, and wherein the representation is usable by a memory tiering algorithm to determine mapping of memory regions across the CXL fabric. The method may be performed on a hardware substrate comprising at least the first analyzer, the second analyzer, and the computer, where the first analyzer and the second analyzer are circuits located in respective portions of the CXL fabric, and the computer is implemented as instructions executed by a processor coupled to a memory storing the instructions, as firmware on an embedded controller, or as a circuit within an integrated circuit package. Producing the first telemetry may include the first analyzer counting memory access requests per memory region and emitting a multi-bit intensity value per memory region; producing the second telemetry may include the second analyzer comparing per-region access counts to a threshold and emitting a hot-or-cold indication per memory region. Receiving by the computer may be performed through a polling sequence, an interrupt-driven handler, or a push-based notification from each analyzer. Producing the representation by the computer may include: (1) ingesting the first telemetry and the second telemetry into a buffer of the computer; (2) for each memory region appearing in the first telemetry or the second telemetry, computing a value of the representation from the corresponding contribution of the first telemetry, the second telemetry, or both; and (3) writing the representation to a storage area accessible to the memory tiering algorithm. The method may be performed independently of which specific format the multi-level heat-map of the first telemetry or the binary hot-or-cold classification of the second telemetry uses, so that the same steps may apply across analyzers that produce telemetry at any resolution within a range from a single-bit hot-or-cold indication to a multi-bit intensity value. Because the steps produce a representation that combines values calculated based on the first telemetry and the second telemetry, the memory tiering algorithm may make mapping decisions across the CXL fabric without separate handling of each underlying telemetry source.

In some implementations of the method, the computer comprises a Central Processing Unit (CPU) comprising processing cores coupled via a coherent interconnect, and wherein at least one of: (i) the computer is integrated in a same integrated circuit package as the processing cores, and producing the representation is performed without the first telemetry and the second telemetry traversing a link external to the integrated circuit package; (ii) producing the representation comprises mapping the values calculated based on the first telemetry and the values calculated based on the second telemetry to a common intensity scale, and populating values of the representation per memory region of the CXL fabric on the common intensity scale; or (iii) producing the representation comprises combining the values calculated based on the first telemetry with the values calculated based on the second telemetry according to a weighting selected such that the values calculated based on the first telemetry contribute to the representation differently from the values calculated based on the second telemetry. The computer integrated in the integrated circuit package may execute the steps as firmware on an embedded controller within the integrated circuit package, with the first telemetry and the second telemetry held in registers of the integrated circuit package while the representation is produced. The mapping to the common intensity scale may be performed by a quantization step that converts each value into a fixed-point number in a numerical range. The weighting may be applied by multiplying each contribution by a configurable weight before summing the contributions into the value for the corresponding memory region of the representation. These steps may be combined such that the computer integrated in the integrated circuit package both maps the values to the common intensity scale and applies the weighting. Because producing the representation may occur within the integrated circuit package using a common scale or a configurable weighting, delivery of the representation to the memory tiering algorithm may proceed with reduced reliance on links external to the integrated circuit package and with reduced sensitivity to the specific formats of the first telemetry and the second telemetry.

In some implementations, the method further comprises at least one of: (i) issuing, by the computer based on the representation, a migration directive to at least one entity of the CXL fabric, the migration directive identifying at least one memory region of the CXL fabric for migration and a destination among the memory resources of the CXL fabric for the at least one memory region; (ii) reconfiguring, by the computer based on the representation, at least one of the first analyzer or the second analyzer by adjusting at least one of an analysis granularity, a sampling rate, an epoch duration, or a threshold; or (iii) producing the first telemetry by the first analyzer at a first temporal granularity, and producing the second telemetry by the second analyzer at a second temporal granularity at least an order of magnitude coarser than the first temporal granularity. Issuing the migration directive may include constructing a command message in a buffer of the computer and transmitting the command message over a CXL link, an Ethernet link, or a PCIe link to a CXL switch or a host of the CXL fabric. Reconfiguring an analyzer may include issuing a register-write command to the analyzer's configuration register through a fabric management command interface. Producing the first telemetry and the second telemetry at different temporal granularities may include configuring an epoch register of each analyzer to the desired duration. These operations may be combined such that the computer issues the migration directive and reconfigures one of the analyzers based on the same representation produced from telemetry of differing temporal granularities. Because the computer may issue migration directives, reconfigure the analyzers, or vary the temporal granularity of the analyzers based on the representation, the analyzers may track memory regions identified by the representation as candidates for mapping change over successive epochs.

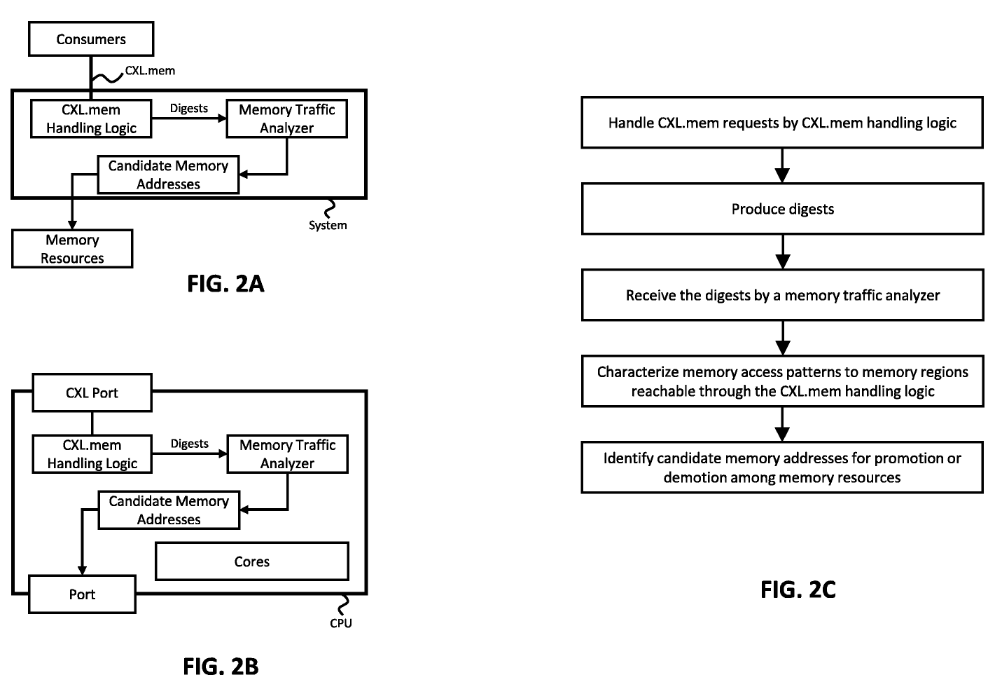

FIG. 2A illustrates a system that includes CXL.mem handling logic and a memory traffic analyzer. The CXL.mem handling logic may receive CXL.mem requests from one or more consumers external to the system and may handle the CXL.mem requests. The CXL.mem handling logic may produce digests of the CXL.mem requests and may convey the digests to the memory traffic analyzer, with the digests including subsets of fields of the CXL.mem requests such as addresses carried by the CXL.mem requests or identifiers of the consumers associated with the CXL.mem requests. The memory traffic analyzer may characterize, based on the digests, memory access patterns to memory regions of one or more memory resources reachable through the CXL.mem handling logic. Based on the characterization, the system may identify candidate memory addresses for promotion or demotion among the memory resources.

Some implementations characterize memory access patterns in systems that handle CXL memory traffic. The systems include, by way of example and without limitation, switches through which CXL.mem traffic passes between consumers and memory resources, CPUs having CXL ports configured to communicate according to CXL.mem with memory resources external to the CPU, memory pools comprising internal memory and connectivity to one or more external memory resources, CXL memory expanders, and resource composers configured to allocate memory regions of the memory resources to consumers. The characterization may inform identification of candidate memory addresses for promotion or demotion among memory resources reachable through CXL.mem handling logic of the system, where the memory resources may differ in access latency, available bandwidth, or capacity per stored unit. The digests received by the memory traffic analyzer may be produced one per CXL.mem request, with each such digest comprising a subset of fields of that single CXL.mem request, or may be produced for a plurality of CXL.mem requests, with such a digest summarizing fields collected from the plurality of CXL.mem requests, for example over a time window or over a region of memory. The memory regions may include address ranges such as a 64-byte cache line, a 4 KiB page, a 2 MiB page, a 1 GiB region, or a multi-page region. The memory resources may include containers of memory such as a memory pool, a CXL memory expander, the memory behind a CXL port of a host, or a global fabric-attached memory device. The memory regions may reside within the memory resources; the characterization may be produced over the memory regions; and tiering decisions may move memory content between the memory resources.

In various implementations, a system comprising: CXL.mem handling logic configured to handle CXL.mem requests, wherein CXL denotes Compute Express Link; and a memory traffic analyzer configured to receive, from the CXL.mem handling logic, digests of the CXL.mem requests handled by the CXL.mem handling logic, the digests comprising subsets of fields of the CXL.mem requests, the subsets comprising at least addresses carried by the CXL.mem requests or identifiers of consumers associated with the CXL.mem requests; wherein the memory traffic analyzer is configured to characterize, based on the digests, memory access patterns to memory regions reachable through the CXL.mem handling logic; and wherein the system is configured to identify, based on the characterization, candidate memory addresses for promotion or demotion among memory resources reachable through the CXL.mem handling logic. The system may be implemented as a switch having a plurality of ports through which CXL.mem traffic passes between consumers and memory resources, as a CPU having one or more CXL ports configured to communicate according to CXL.mem with external memory resources, as a memory pool comprising internal memory and connectivity to one or more external memory resources, as a CXL memory expander, or as a resource composer configured to allocate memory regions of memory resources to consumers. The CXL.mem handling logic may be implemented as a controller, as a finite state machine in an integrated circuit of the system, or as instructions executing on an embedded processor of the system. The memory traffic analyzer may be implemented as a circuit, as a hardware processor executing instructions, or as a combination of a circuit and instructions executing on the hardware processor.

The CXL.mem handling logic may be configured to handle CXL.mem requests by: (1) receiving the CXL.mem requests on one or more ports of the system; (2) processing the CXL.mem requests, the processing optionally including parsing of fields of the CXL.mem requests; and (3) forwarding the CXL.mem requests along paths toward memory resources targeted by the CXL.mem requests, or completing the CXL.mem requests locally when the CXL.mem requests target memory internal to the system.

The memory traffic analyzer may be configured to receive the digests by: (1) accepting, from the CXL.mem handling logic, data records, the data records comprising the subsets of fields of the CXL.mem requests; (2) storing the digests in a buffer or register file of the memory traffic analyzer; and (3) optionally sampling or filtering the digests to reduce a rate of digests processed by the memory traffic analyzer. The memory traffic analyzer may be configured to characterize the memory access patterns by: (1) extracting, from the received digests, the addresses or the identifiers of the consumers present in the digests; (2) mapping the addresses to memory regions within the memory regions reachable through the CXL.mem handling logic, the mapping optionally based on a programmable granularity such as cache-line granularity, page granularity, or multi-page granularity; (3) updating per-region statistics for the mapped memory regions, the per-region statistics comprising at least one of access counts, access frequencies, access recencies, or decay-weighted access intensities; and (4) producing the characterization as a collection of the per-region statistics for the memory regions reachable through the CXL.mem handling logic.

The system may be configured to identify the candidate memory addresses for promotion or demotion by: (1) selecting, based on the per-region statistics, memory regions whose statistics indicate elevated access activity as candidates for promotion to a memory resource with lower access latency or higher available bandwidth; (2) selecting memory regions whose statistics indicate diminished access activity as candidates for demotion to a memory resource with higher capacity or lower cost per stored unit; and (3) outputting the candidate memory addresses, for example to a memory tiering engine that initiates migration of memory content.

The memory traffic analyzer may operate by aggregating per-region statistics derived from the digests, so that the characterization may produce a meaningful indication of access intensity at any number of memory regions or for any number of memory resources reachable through the CXL.mem handling logic. The memory regions may include a single memory region within a single memory resource; the memory regions may include large numbers of memory regions distributed across a plurality of memory resources reaching through cascaded switches in a CXL fabric. The memory traffic analyzer may operate at any number of consumers communicating CXL.mem traffic through the CXL.mem handling logic, with the per-consumer differentiation depending on the identifiers of the consumers present in the digests rather than on the number of consumers.

CXL.mem-based pooling and tiering of memory resources may impose a challenge of obtaining access pattern information at a location through which the CXL.mem traffic passes, and at a granularity appropriate to mapping decisions, without consuming a level of bandwidth or storage that would be impractical at the rate at which CXL.mem requests are handled. Because the digests comprise subsets of fields of the CXL.mem requests rather than full CXL.mem requests, the memory traffic analyzer may consume less bandwidth and less storage than would be required to convey full CXL.mem requests, while retaining sufficient information for the characterization of access patterns to enable identification of the candidate memory addresses for promotion or demotion.

In some implementations of the system, the digests comprise both addresses carried by the CXL.mem requests and identifiers of consumers associated with the CXL.mem requests; and wherein the memory traffic analyzer is configured to produce, based on the digests, per-consumer characterizations of the memory access patterns differentiated by the identifiers of the consumers. The identifiers of the consumers may include port identifiers identifying the ports of the system through which the CXL.mem requests are received, Logical Device Identifiers (LD-IDs) carried by the CXL.mem requests, source identifiers derived from routing prefixes of the CXL.mem requests, or combinations thereof. The per-consumer characterizations may be maintained as separate per-region statistic tables, one table per identifier of a consumer, or as a single table indexed by both region and identifier of the consumer. Because the memory access patterns are differentiated by the identifiers of the consumers, candidate memory addresses for promotion or demotion may be identified for mapping decisions specific to the consumers.

In some implementations of the system, the digests further comprise read/write indications; wherein the memory traffic analyzer is configured to produce, based on the digests, a read access characterization of the memory regions and a write access characterization of the memory regions, the read access characterization separated from the write access characterization; and wherein the system is configured to identify the candidate memory addresses for promotion or demotion based on at least one of the read access characterization or the write access characterization. The read/write indications may include bit fields of the CXL.mem requests indicating master-to-subordinate read messages, master-to-subordinate write messages, or opcode-dependent indications. The read access characterization and the write access characterization may be maintained as separate per-region statistic tables, or as a single table with separate read and write counters per memory region. Because read and write access patterns may differ for the same memory region, separate identification of candidate memory addresses based on each characterization may produce mapping decisions accounting for write-heavy regions and read-heavy regions independently.

In some implementations of the system, the memory resources reachable through the CXL.mem handling logic comprise a first memory resource and at least a second memory resource; wherein the first memory resource is reachable via a first port of the system, the first port configured to communicate according to CXL.mem; wherein the second memory resource is reachable via a second port of the system, the second port configured to communicate according to CXL.mem; wherein the CXL.mem handling logic is configured to handle CXL.mem requests targeting the first memory resource and CXL.mem requests targeting the second memory resource; and wherein the candidate memory addresses identified for promotion or demotion comprise candidate addresses for migration from the first memory resource to the second memory resource or from the second memory resource to the first memory resource. The first memory resource and the second memory resource may differ in access latency, available bandwidth, or capacity per stored unit. For example, the first memory resource may include DRAM in a memory pool and the second memory resource may include memory reached through a remote host. The first port and the second port may include different port types of the system, such as a CXL port and a switch port. Because the memory access patterns are characterized across memory regions of different memory resources, candidate memory addresses for migration between the first memory resource and the second memory resource may be identified based on differences in access intensity correlated with the differences in resource characteristics.

In some implementations of the system, the digests further comprise at least one of (i) CXL.mem opcodes of the CXL.mem requests, or (ii) indications of whether the CXL.mem requests are Master-to-Subordinate (M2S) messages or Subordinate-to-Master (S2M) messages; and wherein the memory traffic analyzer is configured to distinguish memory access patterns based on the at least one of the CXL.mem opcodes or the M2S/S2M indications. The CXL.mem opcodes may include indications of memory read operations, memory write operations, metadata write operations, or other CXL.mem operations defined for memory access. The M2S indications may identify requests originated by masters and the S2M indications may identify responses originated by subordinates. Because the memory access patterns are distinguished based on the CXL.mem opcodes or the M2S/S2M indications, the characterization may separately reflect data-access patterns and metadata-access patterns, or master-originated and subordinate-originated activity.

In some implementations of the system, the digests further comprise timestamps; wherein the memory traffic analyzer is configured to derive, based on the timestamps in the digests, at least one of access frequency, access recency, or decay-weighted access intensity for the memory regions; and wherein the memory traffic analyzer comprises a Spatio-Temporal (ST) analyzer configured to apply a temporal decay function to past access activity in producing the access recency or the decay-weighted access intensity. The timestamps may include time values assigned to the digests at the CXL.mem handling logic at the time the digests are produced, or time values assigned at the memory traffic analyzer at the time the digests are received. The temporal decay function may include an exponential decay, a linear decay, a stepped decay over time windows, or a moving-average decay. The ST analyzer may be implemented as a circuit comprising a buffer for the digests, a decay function circuit, and per-region statistic registers, or as instructions executing on a hardware processor that maintain the per-region statistics. Because the decay-weighted access intensity reflects recency in addition to frequency, characterization may distinguish a memory region recently accessed many times from a memory region last accessed long ago even when both have the same total access count.

In some implementations of the system, the memory traffic analyzer is configured to characterize the memory access patterns at a programmable granularity selected from at least two of cache-line granularity, page granularity, or multi-page granularity; wherein the memory traffic analyzer is further configured to sample the CXL.mem requests handled by the CXL.mem handling logic at a programmable sampling rate; and wherein the sampling rate is selectable to trade off between an accuracy of the characterization and at least one of (i) a rate of digests received by the memory traffic analyzer, (ii) a storage capacity used by the memory traffic analyzer, or (iii) a processing throughput required of the memory traffic analyzer. The cache-line granularity may include 64-byte regions corresponding to a typical cache-line size. The page granularity may correspond to a typical page size such as 4 KiB or 2 MiB. The multi-page granularity may correspond to larger regions such as 1 GiB or larger administrative regions. The sampling rate may include a fraction such as one in two, one in sixteen, or one in two hundred fifty-six of the CXL.mem requests handled by the CXL.mem handling logic. The sampling may be performed by a pseudo-random sampler, by a circuit comprising a linear-feedback shift register (LFSR), or by a periodic sampler. Because the sampling rate is selectable, an operator of the system may choose a position on a tradeoff curve between characterization accuracy and analyzer resource consumption appropriate to the deployment.

In some implementations of the system, the memory resources reachable through the CXL.mem handling logic comprise memory reachable via a switch coupled to the system through a CXL link configured to support CXL.mem; wherein the switch comprises a second memory traffic analyzer configured to produce, from CXL.mem requests handled by the switch, a second characterization of memory access patterns to memory regions of the memory reachable via the switch; and wherein the system is further configured to receive the second characterization from the switch and to identify the candidate memory addresses for promotion or demotion based on a combination of the characterization produced by the memory traffic analyzer and the second characterization produced by the second memory traffic analyzer. The switch coupled to the system may include a CXL switch supplementing CXL switching with the second memory traffic analyzer, or a switch implementing a switching fabric and the second memory traffic analyzer as integrated circuits of a same integrated circuit package. The CXL link configured to support CXL.mem may carry CXL.mem traffic between the system and the switch. The system may receive the second characterization from the switch by way of a control-plane message exchanged over the CXL link or over a separate management link between the system and the switch. The combination of the characterization and the second characterization may include a fabric-wide aggregated characterization, allowing identification of candidate memory addresses based on activity observed at multiple points in a fabric. Because the combination spans more than one point of observation, characterization may reflect activity at memory regions beyond those reachable directly through the system's own CXL.mem handling logic.

In some implementations of the system, the system comprises a switch; wherein the switch comprises a plurality of ports, the CXL.mem handling logic, and the memory traffic analyzer; wherein the plurality of ports are configured to carry the CXL.mem requests handled by the CXL.mem handling logic; and wherein placement of the memory traffic analyzer within the switch enables the memory traffic analyzer to characterize, based on the digests, memory access patterns of a plurality of consumers communicating through the plurality of ports. The switch may include an integrated circuit implementing a switching fabric and the CXL.mem handling logic, with the memory traffic analyzer being a further circuit of the same integrated circuit. The plurality of ports may include switch ports as defined by the CXL standard, CXL ports as defined by the CXL standard for non-switch CXL entities, or other port types. The memory traffic analyzer may receive the digests on an internal data path of the switch from the CXL.mem handling logic. Because the memory traffic analyzer is positioned within the switch through which CXL.mem traffic of the plurality of consumers passes, characterization may reflect activity of more than one consumer without requiring separate observation points at each consumer.

In some implementations of the system, the system comprises a memory pool comprising the CXL.mem handling logic and the memory traffic analyzer; wherein the memory pool comprises a plurality of ports configured to carry CXL.mem traffic to and from the memory pool; wherein the memory regions reachable through the CXL.mem handling logic comprise memory regions of memory internal to the memory pool and memory regions of at least one memory resource external to the memory pool and reachable through the plurality of ports; and wherein the memory traffic analyzer is configured to characterize, based on the digests, memory access patterns to the memory regions of the memory internal to the memory pool and to the memory regions of the at least one memory resource external to the memory pool. The memory pool may include an integrated circuit, an integrated circuit package, or an appliance comprising memory devices and circuit logic implementing the CXL.mem handling logic and the memory traffic analyzer. The memory internal to the memory pool may include DRAM devices, persistent memory devices, or other memory devices. The at least one memory resource external to the memory pool may include a remote memory pool, memory of a host, or memory reached through a switch. The plurality of ports may include CXL ports of the memory pool when the memory pool is implemented as a CXL device, switch ports when the memory pool incorporates internal switching, or a combination of port types. Because the memory traffic analyzer characterizes patterns across memory internal to the memory pool and memory external to the memory pool, candidate memory addresses for promotion or demotion may span memory at both locations.

In some implementations, the system further comprises a memory tiering engine configured to receive the characterization from the memory traffic analyzer; wherein the memory tiering engine is configured to determine, based on the characterization, the promotion or demotion of the candidate memory addresses; and wherein the memory tiering engine comprises an autonomous tiering algorithm engine configured to autonomously adjust mapping of memory content across the memory resources reachable through the CXL.mem handling logic based on the characterization. The memory tiering engine may be implemented as a controller, as a processor executing instructions, as a finite state machine, or as a combination of a controller and instructions executing on a processor. The autonomous tiering algorithm engine may include a controller running an autonomous control loop that, based on the characterization received from the memory traffic analyzer, selects promotion or demotion candidates and triggers their migration without intervention by an external operating system or external administrator. Because the memory tiering engine adjusts mapping of memory content across the memory resources autonomously, the system may respond to changes in memory access patterns without external coordination.

In some implementations of the system, consumers of the memory regions comprise a plurality of accelerators interconnected to each other via NVLink, the plurality of accelerators forming a scale-up cluster; wherein the plurality of accelerators are configured to issue CXL.mem requests handled by the CXL.mem handling logic to access the memory regions; and wherein the memory traffic analyzer is configured to differentiate, based on the identifiers of the consumers in the digests, memory access patterns of accelerators of the plurality of accelerators. The plurality of accelerators interconnected via NVLink may include GPUs of a scale-up GPU cluster, the scale-up cluster comprising for example 8, 16, 32, or 64 accelerators. The plurality of accelerators may each issue CXL.mem requests through respective CXL ports of the accelerators to the system. Because the memory traffic analyzer differentiates the memory access patterns of accelerators of the cluster based on the identifiers of the consumers, candidate memory addresses for promotion or demotion may be identified per accelerator, supporting mapping decisions that account for which accelerator most frequently accesses each memory region.

In some implementations of the system, consumers of the memory regions comprise a plurality of accelerators interconnected to each other via UALink, the plurality of accelerators forming a scale-up cluster; wherein the plurality of accelerators are configured to issue CXL.mem requests handled by the CXL.mem handling logic to access the memory regions; and wherein the memory traffic analyzer is configured to differentiate, based on the identifiers of the consumers in the digests, memory access patterns of accelerators of the plurality of accelerators. The plurality of accelerators interconnected via UALink may include accelerators conforming to the Ultra Accelerator Link standard, such as GPUs, TPUs, or other accelerators, the scale-up cluster comprising for example 8, 16, 32, or 64 accelerators. The plurality of accelerators may each issue CXL.mem requests through respective CXL ports of the accelerators to the system. Because the memory traffic analyzer differentiates the memory access patterns of accelerators of the cluster based on the identifiers of the consumers, candidate memory addresses for promotion or demotion may be identified per accelerator, supporting mapping decisions that account for which accelerator most frequently accesses each memory region.

In some implementations of the system, consumers of the memory regions comprise a plurality of accelerators interconnected to each other via Ethernet Scale-Up Networking (ESUN), the plurality of accelerators forming a scale-up cluster; wherein the plurality of accelerators are configured to issue CXL.mem requests handled by the CXL.mem handling logic to access the memory regions; and wherein the memory traffic analyzer is configured to differentiate, based on the identifiers of the consumers in the digests, memory access patterns of accelerators of the plurality of accelerators. The plurality of accelerators interconnected via ESUN may include accelerators conforming to scale-up networking standards for memory-semantic operations over Ethernet, the scale-up cluster comprising for example 8, 16, 32, or 64 accelerators. The plurality of accelerators may each issue CXL.mem requests through respective CXL ports of the accelerators to the system. Because the memory traffic analyzer differentiates the memory access patterns of accelerators of the cluster based on the identifiers of the consumers, candidate memory addresses for promotion or demotion may be identified per accelerator, supporting mapping decisions that account for which accelerator most frequently accesses each memory region.

In some implementations of the system, the system is configured to initiate, in response to the identification of the candidate memory addresses, migration of memory content associated with the candidate memory addresses among the memory resources reachable through the CXL.mem handling logic; wherein the migration is performed at least in part via CXL.mem transactions issued through the CXL.mem handling logic; and wherein the initiation of the migration is performed by the system without reliance on an external operating system to issue migration commands. The migration of memory content may include initiating CXL.mem write transactions to write the memory content of the candidate memory addresses to a target memory resource and CXL.mem read transactions to verify the migration, or atomic CXL.mem transactions that move the memory content between the memory resources. The system may itself orchestrate the migration by issuing the CXL.mem transactions through the CXL.mem handling logic, or the system may delegate the orchestration of the migration to another component of the system while retaining initiation of the migration. Because the migration is initiated by the system without reliance on an external operating system, latency between identification of the candidate memory addresses and initiation of the migration may be reduced relative to migration that requires an external operating system to issue migration commands.

FIG. 2B illustrates a CPU that may include one or more processing cores, a CXL port configured to communicate according to CXL.mem, CXL.mem handling logic, and a memory traffic analyzer, with the processing cores, the CXL port, the CXL.mem handling logic, and the memory traffic analyzer being contained within an IC package of the CPU. A coherent interconnect of the CPU may couple the processing cores and the CXL.mem handling logic. The CXL.mem handling logic may handle CXL.mem requests received via the CXL port from one or more consumers external to the CPU. The CXL.mem handling logic may produce digests of the CXL.mem requests and may convey the digests to the memory traffic analyzer, with the digests including subsets of fields of the CXL.mem requests such as addresses carried by the CXL.mem requests or identifiers of the consumers associated with the CXL.mem requests. The memory traffic analyzer may characterize, based on the digests, memory access patterns to memory regions reachable through the CXL port. Based on the characterization, the CPU may identify candidate memory addresses for promotion or demotion among memory resources reachable through the CXL port.

In various implementations, a Central Processing Unit (CPU) comprising: one or more processing cores; a Compute Express Link (CXL) port configured to communicate according to CXL.mem; CXL.mem handling logic coupled to the CXL port and configured to handle CXL.mem requests received via the CXL port; and a memory traffic analyzer configured to receive, from the CXL.mem handling logic, digests of the CXL.mem requests handled by the CXL.mem handling logic, the digests comprising subsets of fields of the CXL.mem requests, the subsets comprising at least addresses carried by the CXL.mem requests or identifiers of consumers associated with the CXL.mem requests; wherein the memory traffic analyzer is configured to characterize, based on the digests, memory access patterns to memory regions reachable through the CXL port; and wherein the CPU is configured to identify, based on the characterization, candidate memory addresses for promotion or demotion among memory resources reachable through the CXL port. The CPU may be implemented as a server CPU integrated circuit, as an embedded CPU integrated circuit, or as an integrated circuit package comprising one or more CPU integrated circuits. The one or more processing cores may include general-purpose CPU cores, application-specific cores, or a combination of general-purpose CPU cores and application-specific cores, fabricated on a same integrated circuit. The CXL port of the CPU may include a port circuit implementing the physical layer, link layer, and transaction layer of CXL.io, CXL.cache, and CXL.mem according to the CXL standard. The CXL.mem handling logic may be implemented as a controller, as a finite state machine in an integrated circuit of the CPU, or as instructions executing on an embedded processor of the CPU. The memory traffic analyzer may be implemented as a circuit, as a hardware processor executing instructions, or as a combination of a circuit and instructions executing on the hardware processor.

The CXL.mem handling logic may be configured to handle the CXL.mem requests received via the CXL port by: (1) accepting CXL.mem requests at the CXL port from one or more consumers external to the CPU, the CXL.mem requests targeting memory regions reachable through the CXL port; (2) routing the CXL.mem requests through a fabric internal to the CPU, the fabric optionally comprising a coherent interconnect of the CPU; and (3) accessing the memory regions reachable through the CXL port to fulfill the CXL.mem requests, the memory regions optionally comprising memory local to the CPU.

The memory traffic analyzer may be configured to receive the digests by: (1) accepting, from the CXL.mem handling logic, data records, the data records comprising the subsets of fields of the CXL.mem requests; and (2) storing the digests in a buffer or register file of the memory traffic analyzer. The memory traffic analyzer may be configured to characterize the memory access patterns by: (1) extracting, from the received digests, the addresses or the identifiers of the consumers; (2) mapping the addresses to memory regions within the memory regions reachable through the CXL port; (3) updating per-region statistics for the mapped memory regions; and (4) producing the characterization as a collection of the per-region statistics for the memory regions reachable through the CXL port.

The CPU may be configured to identify the candidate memory addresses for promotion or demotion by: (1) selecting memory regions whose per-region statistics indicate elevated access activity as candidates for promotion; (2) selecting memory regions whose per-region statistics indicate diminished access activity as candidates for demotion; and (3) outputting the candidate memory addresses, for example to a memory tiering engine that initiates migration.

The memory traffic analyzer may operate by aggregating per-region statistics derived from the digests, so that the characterization may produce a meaningful indication of access intensity at any number of memory regions reachable through the CXL port. The memory regions may include a single memory region within a single memory resource reached through the CXL port; the memory regions may include large numbers of memory regions distributed across a plurality of memory resources reached through cascaded switches in a CXL fabric.

A CPU performing tiering decisions for memory accessed through CXL.mem may face a challenge of obtaining access pattern information at a location through which the CXL.mem traffic passes and at a granularity appropriate to mapping decisions. Because the digests comprise subsets of fields of the CXL.mem requests rather than full CXL.mem requests, the memory traffic analyzer of the CPU may consume less internal bandwidth and storage of the CPU than would be required to convey full CXL.mem requests, while retaining sufficient information for identification of the candidate memory addresses for promotion or demotion.

In some implementations of the CPU, the memory traffic analyzer is integrated in a same integrated circuit package as the one or more processing cores; wherein the integration in the same integrated circuit package enables transport of the digests from the CXL.mem handling logic to the memory traffic analyzer via an on-package interconnect of the CPU, the on-package interconnect providing bandwidth for conveying the digests without consuming external bandwidth of the CPU for digest transport; and wherein the integration in the same integrated circuit package further enables the memory traffic analyzer to observe CPU-internal state pertinent to the CXL.mem requests, the CPU-internal state comprising at least one of cache state or memory coherence state of the CPU. The integrated circuit package may include a single integrated circuit die comprising the one or more processing cores and the memory traffic analyzer, or a multi-chip package comprising the one or more processing cores and the memory traffic analyzer on separate dies coupled through an on-package interconnect such as a silicon interposer, an organic substrate trace, or a die-to-die bridge. The on-package interconnect may include an on-die bus, a network-on-chip, or a chiplet-to-chiplet interconnect. The memory traffic analyzer may observe the CPU-internal state by tapping snoop messages on a coherent fabric of the CPU, monitoring cache-tag updates, or sampling coherence state of caches of the CPU. Because the digests are transported on the on-package interconnect rather than over an external interface of the CPU, external bandwidth of the CPU available for memory and I/O traffic may be preserved.

In some implementations, the CPU further comprises a coherent interconnect coupling the one or more processing cores to the CXL.mem handling logic and to one or more memory controllers configured to access memory local to the CPU; wherein the memory traffic analyzer is coupled to the coherent interconnect or to the one or more memory controllers; wherein the memory traffic analyzer is configured to receive, via the coupling, digests of memory access transactions comprising digests of the CXL.mem requests handled by the CXL.mem handling logic and digests of memory access transactions targeting the memory local to the CPU; and wherein the memory traffic analyzer is configured to characterize memory access patterns to both the memory regions reachable through the CXL port and memory regions of the memory local to the CPU. The coherent interconnect of the CPU may include a mesh interconnect, a ring interconnect, a crossbar, or a hierarchical interconnect, configured to convey cache-line-granular memory access transactions between the one or more processing cores, the CXL.mem handling logic, and the one or more memory controllers. The one or more memory controllers may include DDR memory controllers, HBM memory controllers, or controllers for other types of memory local to the CPU. The memory traffic analyzer may be coupled to the coherent interconnect by way of a probe interface of the coherent interconnect, or may be coupled to the one or more memory controllers by way of an observation interface of the memory controllers. Because the memory traffic analyzer is coupled to the coherent interconnect or to the one or more memory controllers, the characterization may span memory regions of both the memory local to the CPU and the memory regions reachable through the CXL port, supporting mapping decisions across both local memory and remote memory.

In some implementations of the CPU, the CXL port of the CPU is configured to be coupled to a first switch, the first switch coupled to at least one second switch through at least one CXL link configured to support CXL.mem; wherein the memory regions reachable through the CXL port comprise memory regions reachable through the at least one second switch; and wherein the candidate memory addresses identified for promotion or demotion comprise candidate addresses for migration between a first memory resource and a different second memory resource, the first memory resource being memory reachable through the at least one second switch and the second memory resource being the memory local to the CPU. The first switch and the at least one second switch may include CXL switches, switches supplementing CXL switching with one or more additional functions, or a combination of CXL switches and switches supplementing CXL switching. The CXL link configured to support CXL.mem between the first switch and the at least one second switch may include a CXL link carrying CXL.mem traffic between the switches. The migration of memory content from the memory reachable through the at least one second switch to the memory local to the CPU may include prefetching of memory content into the memory local to the CPU before access by the one or more processing cores. Because the candidate memory addresses span memory in a remote memory resource reached through cascaded switches and memory local to the CPU, mapping decisions may move memory content between memory resources whose access latencies differ by orders of magnitude, supporting access-latency-aware tiering across a CXL fabric.

In some implementations, the CPU further comprises a Last-Level Cache (LLC) with an LLC cache-allocation mechanism configured to determine cache-line allocations to the LLC, and a Memory Management Unit (MMU) with a Translation Lookaside Buffer (TLB) configured to cache address translations; wherein the memory traffic analyzer is configured to provide hints based on the characterization to at least one of: (i) the LLC cache-allocation mechanism, wherein the hints identify cache-line addresses from the memory regions reachable through the CXL port as candidates for caching in the LLC, or (ii) the MMU, wherein the hints identify address translations corresponding to the memory regions reachable through the CXL port as candidates for retention in the TLB; and wherein the LLC cache-allocation mechanism or the MMU is configured to bias respective cache or TLB allocations toward the cache-line addresses or the address translations indicated by the hints. The LLC cache-allocation mechanism may include a remapping-policy controller of the LLC, such as a controller implementing a least-recently-used policy with bias inputs from the memory traffic analyzer. The MMU may include a hardware page-table walker, a TLB cache, and a TLB allocation controller. The hints provided by the memory traffic analyzer may include marks on cache lines or address translations, retention-priority weights, or pin-unpin indications. The LLC cache-allocation mechanism may bias remapping decisions away from cache lines indicated by the hints, and the MMU may bias TLB retention toward address translations indicated by the hints. Because the hints biasing the LLC and the TLB are derived from the same characterization that informs promotion and demotion decisions, fast-path effects on cache and TLB hit rates may complement slower-path effects of memory tiering.

In various implementations, a method comprising: handling, by CXL.mem handling logic, CXL.mem requests, wherein CXL denotes Compute Express Link; producing, from the CXL.mem requests, digests, the digests comprising subsets of fields of the CXL.mem requests, the subsets comprising at least addresses carried by the CXL.mem requests or identifiers of consumers associated with the CXL.mem requests; receiving, by a memory traffic analyzer, the digests from the CXL.mem handling logic; characterizing, by the memory traffic analyzer based on the digests, memory access patterns to memory regions reachable through the CXL.mem handling logic; and identifying, based on the characterization, candidate memory addresses for promotion or demotion among memory resources reachable through the CXL.mem handling logic. The method may be performed by a system comprising the CXL.mem handling logic, the memory traffic analyzer, and one or more processors coupled to a memory storing instructions that, when executed by the one or more processors, cause performance of the handling, producing, receiving, characterizing, and identifying. The handling, producing, receiving, characterizing, and identifying may be performed by hardware circuitry of the system, by instructions executing on the one or more processors, or by a combination of hardware circuitry and instructions executing on the one or more processors.

The handling of the CXL.mem requests by the CXL.mem handling logic may include: (1) receiving the CXL.mem requests on one or more ports of the system; (2) parsing fields of the CXL.mem requests; and (3) forwarding the CXL.mem requests along paths toward memory resources targeted by the CXL.mem requests, or completing the CXL.mem requests locally when the CXL.mem requests target memory internal to the system.

The producing of the digests may include: (1) extracting, from the CXL.mem requests, at least the addresses carried by the CXL.mem requests or the identifiers of consumers associated with the CXL.mem requests, the extracting performed by a circuit of the CXL.mem handling logic or by instructions executing on a processor of the system; (2) assembling the digests as data records comprising the extracted subsets of fields; and (3) optionally appending one or more additional fields to the digests, such as timestamps, read/write indications, CXL.mem opcodes, or other fields of the CXL.mem requests.

The characterizing of the memory access patterns may include: (1) extracting from the received digests the addresses or the identifiers of the consumers; (2) mapping the addresses to memory regions within the memory regions reachable through the CXL.mem handling logic; (3) updating per-region statistics for the mapped memory regions; and (4) producing the characterization as a collection of the per-region statistics for the memory regions reachable through the CXL.mem handling logic.

The identifying of the candidate memory addresses may include selecting memory regions whose per-region statistics indicate elevated access activity as candidates for promotion, selecting memory regions whose per-region statistics indicate diminished access activity as candidates for demotion, and outputting addresses of the selected memory regions for promotion or demotion.

The method may operate by aggregating per-region statistics derived from the digests, so that the method may operate at any number of memory regions or at any number of memory resources reachable through the CXL.mem handling logic. As a low corner case, a single memory region within a single memory resource may be characterized; as a high corner case, large numbers of memory regions distributed across a plurality of memory resources may be characterized. A method for mapping decisions among memory resources of differing access characteristics may face a challenge of producing access pattern information at appropriate locations and at appropriate granularities at a rate sufficient to inform timely mapping decisions. Because the digests comprise subsets of fields of the CXL.mem requests rather than full CXL.mem requests, the memory traffic analyzer may consume less storage and less bandwidth than would be required to receive full CXL.mem requests, while retaining sufficient information for identification of the candidate memory addresses for promotion or demotion.

In some implementations of the method, the digests comprise both addresses carried by the CXL.mem requests and identifiers of consumers associated with the CXL.mem requests; and wherein the characterizing comprises producing per-consumer characterizations of the memory access patterns differentiated by the identifiers of the consumers. The producing of the digests may include extracting both the addresses carried by the CXL.mem requests and the identifiers of consumers associated with the CXL.mem requests, and assembling the digests to include both fields. The producing of the per-consumer characterizations may include maintaining separate per-region statistic tables, one table per identifier of a consumer, or maintaining a single table indexed by both region and identifier of the consumer. Because the per-consumer characterizations are differentiated by the identifiers of the consumers, candidate memory addresses identified through the method may be specific to consumers.

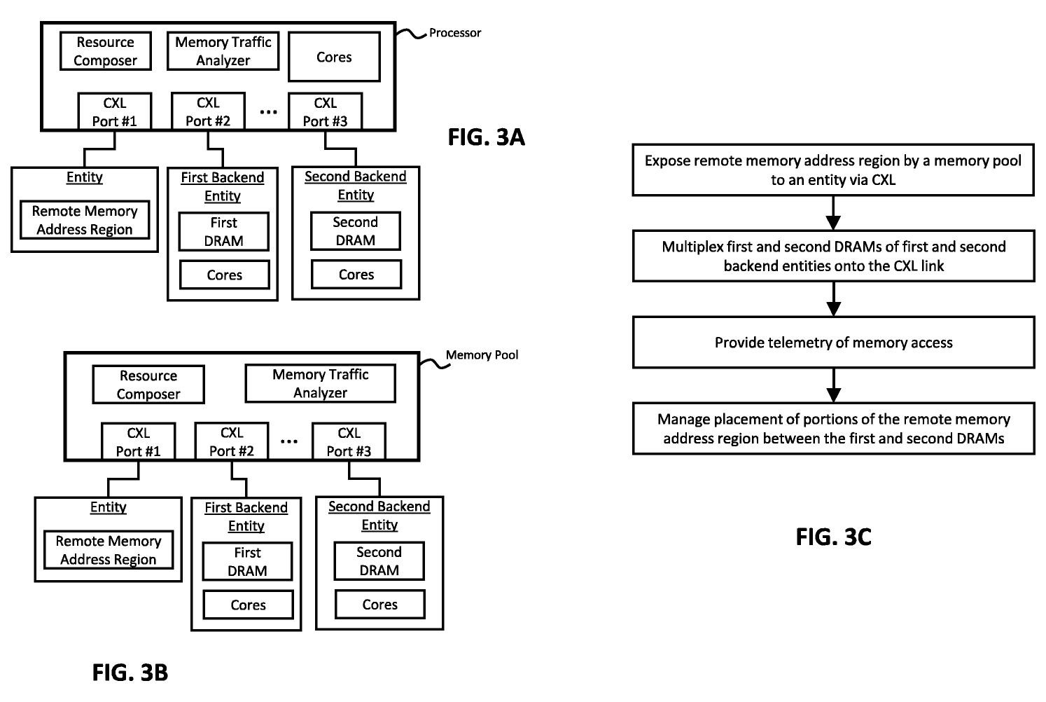

FIG. 3A illustrates an example of a processor including a resource composer, a memory traffic analyzer, cores, and a plurality of CXL ports. One of the plurality of CXL ports is coupled to an entity including a remote memory address region. Another of the plurality of CXL ports is coupled to a first back-end entity including a first DRAM and cores. And another of the plurality of CXL ports is coupled to a second back-end entity including a second DRAM and cores.

In various implementations, a processor comprising: one or more processing cores; a first Compute Express Link (CXL) port configured to communicate according to CXL.mem with an entity over a CXL link, wherein the processor is configured to expose to the entity a remote memory address region via the first CXL port; a second CXL port configured to communicate with a first back-end entity over a first back-end CXL link, the first back-end entity comprising first dynamic random-access memory (DRAM) accessible by one or more processing cores of the first back-end entity; a third CXL port configured to communicate with a second back-end entity over a second back-end CXL link, the second back-end entity comprising second DRAM accessible by one or more processing cores of the second back-end entity; a resource composer configured to map: a first portion of the remote memory address region to the first DRAM, and a second portion of the remote memory address region to the second DRAM; and a memory traffic analyzer configured to provide, to the resource composer, telemetry of memory accesses, the resource composer further configured to use the telemetry to manage mapping of portions of the remote memory address region to the first DRAM and the second DRAM. The processor may be implemented as a CPU, a GPU, a DPU, an accelerator, or other integrated circuit device that includes one or more processing cores. The resource composer may be implemented as hardware logic of the processor, as a finite state machine, as firmware executed on a microcontroller of the processor, or as a hybrid of hardware logic and firmware. The memory traffic analyzer may be implemented as hardware counter circuitry, as firmware sampling memory access transactions, or as a hybrid of hardware sampling and firmware aggregation. The first, second, and third CXL ports may include physical-layer and link-layer circuits that couple the processor to external entities over CXL links. The resource composer may multiplex the first DRAM and the second DRAM onto the CXL link by: (1) maintaining a mapping data structure that associates portions of the remote memory address region with one of the first DRAM or the second DRAM; (2) receiving memory access transactions for the remote memory address region from the first CXL port; (3) determining, using the mapping data structure, which of the first DRAM or the second DRAM serves the portion containing the address of each memory access transaction; (4) forwarding each memory access transaction to the second CXL port or to the third CXL port based on the determination; and (5) returning responses received from the second and/or third CXL ports to the first CXL port. The memory traffic analyzer may provide the telemetry by: (1) observing memory access transactions associated with the remote memory address region; (2) maintaining access-count state for memory address blocks of the remote memory address region; and (3) reporting the access-count state to the resource composer. The resource composer may use the telemetry to manage mapping of portions of the remote memory address region to the first DRAM and the second DRAM by: (1) reading the access-count state from the telemetry; (2) determining whether to migrate memory address blocks between the first DRAM and the second DRAM based at least in part on the access-count state; and (3) updating the mapping data structure to reflect a new mapping following a migration. The first back-end entity and the second back-end entity may each include a host computer system, a server, or other compute system having its own processing cores and its DRAM that the back-end entity also exposes to the processor over CXL. The mapping-management algorithm of the resource composer may operate by per-portion mapping decisions that do not depend on the total number of back-end entities or on the specific size of the remote memory address region, so the resource composer may multiplex any number of back-end entities serving any size of remote memory address region within the claim scope. At the low end of the claim scope, the resource composer may multiplex as few as two back-end DRAMs onto the CXL link with all portions of the remote memory address region drawn from one of the first DRAM or the second DRAM; at the high end of the claim scope, the resource composer may multiplex many back-end DRAMs onto the CXL link with mapping updated periodically based on accumulated telemetry. A limited DRAM capacity may be available to a single consuming entity when single-source memory expansion is used causing inability of static composition arrangements to adapt to observed access patterns. Because the resource composer manages mapping using the telemetry, hot portions of the remote memory address region may be mapped to lower-latency back-end DRAM and cold portions to higher-latency back-end DRAM, and overall access latency and utilization of the back-end DRAMs may be improved relative to static composition arrangements that do not adapt to observed access patterns.

In some implementations of the processor, the resource composer is integrated in a same integrated circuit package as the one or more processing cores; the processor further comprises a coherent interconnect coupled to the one or more processing cores; the resource composer is coupled to the coherent interconnect; and the management of mapping of portions of the remote memory address region to the first DRAM and the second DRAM is performed by the resource composer based at least in part on information received by the resource composer via the coherent interconnect. The integrated circuit package may be a monolithic die or a multi-chip-module package with a chiplet for the one or more processing cores and a chiplet for the resource composer coupled by an on-package interconnect such as a mesh, a ring, or a crossbar. The coherent interconnect may be implemented as a coherent ring, a coherent mesh, or a coherent crossbar of the processor. The information received by the resource composer via the coherent interconnect may include cache coherence state, snoop messages, or memory access transactions associated with the remote memory address region. Because the resource composer is on-package and coupled to the coherent interconnect, the resource composer may receive the information without traversing any external link of the processor, and may make mapping decisions based on on-package state that an off-package composer would otherwise need to obtain through one or more external requests.

In some implementations of the processor, the memory traffic analyzer is integrated in a same integrated circuit package as the one or more processing cores; the processor further comprises a coherent interconnect coupling the one or more processing cores; the memory traffic analyzer is coupled to the coherent interconnect and to the first CXL port; and the memory traffic analyzer is configured to observe memory access transactions issued on the coherent interconnect by the one or more processing cores and memory access transactions for the remote memory address region traversing the first CXL port, the telemetry comprising characterizations derived from both observed sets of memory access transactions. The integrated circuit package may be a monolithic die or a multi-chip-module package with the memory traffic analyzer implemented as a hardware counter array, a programmable sampling circuit, or a finite state machine of the processor. The memory traffic analyzer may observe memory access transactions issued on the coherent interconnect using a snoop tap, and may observe memory access transactions traversing the first CXL port using a counter at the first CXL port's transaction-layer interface. The characterizations may include access counts, access frequency indicators, or temporal access patterns for cachelines or memory address blocks. Because the memory traffic analyzer is on-package and coupled to both the coherent interconnect and the first CXL port, the characterizations may reflect access patterns originating from local processing cores together with access patterns of the remote memory address region, which an off-package analyzer cannot simultaneously observe.

In some implementations, the processor further comprises a Memory Management Unit (MMU); wherein the resource composer is coupled to the MMU; and wherein the management of mapping of portions of the remote memory address region comprises updating, by the resource composer, address mappings of the MMU atomically with respect to memory access transactions of the one or more processing cores, such that a sub-region of the remote memory address region is redirected from one of the first DRAM or the second DRAM to the other of the first DRAM or the second DRAM. The MMU may include page-table walker hardware, a TLB, and translation caching circuitry of the processor. The resource composer may update address mappings of the MMU atomically by: (1) acquiring exclusive access to a portion of the MMU's mapping state through a hardware lock or a barrier signal; (2) writing the new mapping; and (3) releasing the exclusive access after invalidating stale translations cached in the processor. In an alternative form, the resource composer may quiesce memory access transactions for a sub-region of the remote memory address region prior to updating the MMU. Because the address-mapping update is atomic with respect to memory access transactions of the one or more processing cores, sub-region redirection between the first DRAM and the second DRAM may proceed without exposing inconsistent intermediate states to the processing cores.

In some implementations, the processor further comprises a last-level cache (LLC); wherein the memory traffic analyzer is configured to provide hints to the LLC derived from the telemetry, the hints biasing cacheline allocation decisions of the LLC for cachelines belonging to the remote memory address region such that cachelines associated with telemetry indicating higher access frequency are retained in the LLC preferentially over cachelines associated with telemetry indicating lower access frequency. The LLC may include a shared cache of the processor implemented as a set-associative SRAM array with remapping-policy logic. The memory traffic analyzer may provide hints to the LLC by writing remapping-policy bias bits associated with cachelines of the remote memory address region, or by exposing per-cacheline retention scores via a sideband interface to the LLC's remapping-policy circuit. In an alternative form, the memory traffic analyzer may directly modify least-recently-used state of the LLC for cachelines associated with telemetry indicating higher access frequency. Because the LLC's allocation decisions are biased by the hints derived from the telemetry, cachelines of the remote memory address region with higher observed access frequency may be retained in the LLC longer than cachelines with lower observed access frequency, which may reduce subsequent CXL.mem access latency for hot remote-region content.

FIG. 3B illustrates an example of a memory pool including a resource composer, a memory traffic analyzer, and a plurality of CXL ports. One of the plurality of CXL ports is coupled to an entity including a remote memory address region. Another of the plurality of CXL ports is coupled to a first back-end entity including a first DRAM and cores. And another of the plurality of CXL ports is coupled to a second back-end entity including a second DRAM and cores.

In various implementations, a system comprising: an entity; a memory pool coupled to the entity via a Compute Express Link (CXL) link configured to support CXL.mem, the memory pool is configured to expose to the entity a remote memory address region; a first back-end entity coupled to the memory pool via a first back-end CXL link, the first back-end entity comprising first dynamic random-access memory (DRAM) accessible by one or more processing cores of the first back-end entity; a second back-end entity coupled to the memory pool via a second back-end CXL link, the second back-end entity comprising second DRAM accessible by one or more processing cores of the second back-end entity; a resource composer configured to map: a first portion of the remote memory address region to the first DRAM, and a second portion of the remote memory address region to the second DRAM; a memory traffic analyzer configured to provide, to the resource composer, telemetry of memory accesses; and wherein the resource composer is further configured to use the telemetry to manage mapping of portions of the remote memory address region to the first DRAM and the second DRAM. The system may be implemented as a rack-scale composable memory infrastructure, a cluster of servers contributing locally-attached DRAM to a shared memory pool, or a data-center configuration in which a memory pool aggregates DRAM from multiple host computer systems for consumption by an entity over a CXL.mem-attached front-end link. The memory pool may include a CXL switch appliance, a CXL switch ASIC, a memory pool device, a managed CXL device that aggregates back-end DRAM resources, a composite of two or more of the foregoing, or other apparatus that exposes a remote memory address region to an entity over CXL.mem. The resource composer may be implemented as hardware logic of the memory pool, as a finite state machine, as firmware executed on a microcontroller of the memory pool, or as a hybrid of hardware logic and firmware. The memory traffic analyzer may be implemented as hardware counter circuitry, as firmware sampling memory access transactions, or as a hybrid of hardware sampling and firmware aggregation. The resource composer may multiplex the first DRAM and the second DRAM onto the CXL link by: (1) maintaining a mapping data structure that associates portions of the remote memory address region with one of the first DRAM or the second DRAM; (2) receiving, from the CXL link, memory access transactions for the remote memory address region; (3) determining, using the mapping data structure, which of the first DRAM or the second DRAM serves the portion containing the address of each memory access transaction; (4) forwarding each memory access transaction to the first back-end CXL link or to the second back-end CXL link based on the determination; and (5) returning responses received from the back-end CXL links to the CXL link. The memory traffic analyzer may provide the telemetry by observing memory access transactions associated with the remote memory address region, maintaining access-count state for memory address blocks of the remote memory address region, and reporting the access-count state to the resource composer. The resource composer may use the telemetry to manage mapping of portions of the remote memory address region to the first DRAM and the second DRAM by reading the access-count state from the telemetry, determining whether to migrate memory address blocks between the first DRAM and the second DRAM based at least in part on the access-count state, and updating the mapping data structure to reflect a new mapping following a migration. The first back-end entity and the second back-end entity may each include a host computer system, a server, or other compute system having its own processing cores and its own locally-attached DRAM that the back-end entity also exposes to the memory pool over CXL. The mapping-management operation of the resource composer may operate by per-portion mapping decisions that do not depend on the total number of back-end entities or on the specific size of the remote memory address region, so the resource composer may multiplex any number of back-end entities serving any size of remote memory address region within the claim scope. At the low end of the claim scope, the resource composer may multiplex as few as two back-end DRAMs onto the CXL link, with all portions of the remote memory address region drawn from one of the first DRAM or the second DRAM. At the high end of the claim scope, the resource composer may multiplex many back-end DRAMs onto the CXL link, with mapping updated periodically based on accumulated telemetry. A limited DRAM capacity may be available to a single consuming entity in environments that use only single-source memory expansion, where static composition arrangements do not adapt to observed access patterns, and the underutilization of locally-attached DRAM in fleets of compute systems contribute idle DRAM to a shared pool. Because the resource composer manages mapping based on the telemetry, hot portions of the remote memory address region may be mapped to lower-latency back-end DRAM and cold portions to higher-latency back-end DRAM, and overall access latency and utilization of the back-end DRAMs may be improved relative to static composition arrangements.

In some implementations of the system, the memory traffic analyzer comprises a spatio-temporal (ST) analyzer configured to characterize the memory accesses by spatial locality across addresses of the remote memory address region and temporal access patterns over a time window, the telemetry comprising the characterization; and wherein the resource composer is configured to manage mapping of portions of the remote memory address region to the first DRAM and the second DRAM based at least in part on the spatial locality and the temporal access patterns indicated by the characterization. The ST analyzer may be implemented as a hardware sampling circuit, as firmware running on a microcontroller of the memory pool, or as a hybrid of hardware sampling and firmware analysis. Characterizing the memory accesses by spatial locality may include grouping addresses of memory access transactions into address-range bins and counting accesses per bin. Characterizing the memory accesses by temporal access patterns may include sampling access counts over fixed or sliding time windows and recording sequences of accesses with their timestamps. The characterization may be combined with the resource composer's mapping management such that portions of the remote memory address region exhibiting both high spatial locality and high temporal access rate are mapped to lower-latency back-end DRAM. Because the mapping decisions of the resource composer reflect both spatial locality and temporal access patterns from the characterization, the mapping may adapt to workloads that exhibit different combinations of locality and recency in memory accesses.

In some implementations of the system, the memory traffic analyzer comprises hardware analyzer circuitry placed at edges of CXL links of the memory pool, the hardware analyzer circuitry observing memory access transactions traversing the edges and maintaining access-count state per memory address block of the remote memory address region; and wherein the telemetry provided to the resource composer is derived from the access-count state. The hardware analyzer circuitry may be implemented as a counter array, a sampling circuit, or a finite state machine integrated within or adjacent to a CXL port of the memory pool. The hardware analyzer circuitry may observe memory access transactions traversing an edge by inspecting transaction-layer headers, by tapping the data path between physical-layer and link-layer circuits of the port, or by mirroring transactions to a sideband observation channel. The memory address blocks may include cachelines, sub-pages, or page frames of the remote memory address region. The access-count state may be combined with the resource composer's mapping management such that the telemetry derived from edge-observed counts drives the mapping decisions. Because the hardware analyzer circuitry observes memory access transactions at edges of CXL links rather than at host operating systems, the telemetry may be collected on hardware data paths of the memory pool without consuming bandwidth of the host's compute resources.

In some implementations of the system, the hardware analyzer circuitry comprises a plurality of hardware analyzer units, the plurality of hardware analyzer units placed at edges of CXL links of the memory pool comprising at least a first hardware analyzer unit placed at the first back-end CXL link, a second hardware analyzer unit placed at the second back-end CXL link, and a third hardware analyzer unit placed at the CXL link; the plurality of hardware analyzer units observing memory access transactions traversing respective edges; and wherein the memory traffic analyzer aggregates the access-count state from the plurality of hardware analyzer units for provision to the resource composer as the telemetry. Each hardware analyzer unit of the plurality of hardware analyzer units may be implemented as a counter array, a sampling circuit, or a finite state machine integrated within or adjacent to the respective CXL port of the memory pool. The memory traffic analyzer may aggregate the access-count state by collecting per-unit counts via a sideband channel of the memory pool, by polling each hardware analyzer unit periodically, or by receiving asynchronous updates from each hardware analyzer unit upon a count-threshold event. The per-edge access-count state may be combined with the resource composer's mapping management such that mapping decisions for portions of the remote memory address region reflect access patterns observed at both back-end edges and at the entity-facing edge. Because per-edge access-count state is collected at each of the CXL link edges of the memory pool, the memory traffic analyzer may distinguish access patterns at one back-end from access patterns at another back-end and may distinguish access patterns of traffic entering the memory pool from access patterns of traffic leaving the memory pool.

In some implementations of the system, the access-count state is maintained at a granularity not larger than a page frame of the remote memory address region, and the resource composer is configured to use the access-count state to derive a heat-map of the remote memory address region, the heat-map indicating relative access frequency across page frames of the remote memory address region, and to manage mapping of portions of the remote memory address region to the first DRAM and the second DRAM based at least in part on the heat-map. The granularity of the access-count state may be a cacheline (such as 64 bytes), a sub-page region, or a page frame (such as 4 KiB, 2 MiB, or 1 GiB). The heat-map may be derived by mapping access-count values to a multi-level heat scale, by normalizing access-count values across regions of comparable size, or by computing weighted averages of recent access-count values over a sliding window. The resource composer may use the heat-map to identify hot portions and cold portions of the remote memory address region and may place hot portions on the back-end DRAM exhibiting lower access latency. Because the access-count state is maintained at a granularity not larger than a page frame, the heat-map may distinguish portions of the remote memory address region with finer spatial resolution than coarser-granularity counters provide, which may improve the precision of mapping decisions.

In some implementations of the system, the management of mapping of portions of the remote memory address region to the first DRAM and the second DRAM comprises migrating page frames of the remote memory address region between the first DRAM and the second DRAM, the migrating performed based at least in part on telemetry accumulated by the memory traffic analyzer over a plurality of memory accesses preceding the migrating. Page-frame migration may be performed by the resource composer issuing memory read transactions to one of the first back-end CXL link or the second back-end CXL link, writing the read data to the other back-end CXL link, and updating the mapping data structure to redirect subsequent accesses to the new mapping. The accumulated telemetry may include sampled access counts collected over a configurable time window, exponentially-weighted moving averages of access counts, or count differentials between successive observation intervals. The resource composer's migration decision may be combined with thresholds, hysteresis, or rate-limiting circuitry to avoid excessive migration in response to transient access patterns. Because the migrating is performed based on accumulated telemetry rather than on individual memory access transactions, page-frame migration may reflect persistent access patterns rather than transient ones and may avoid migrating page frames in response to short-lived access bursts.

In some implementations of the system, the resource composer is configured to migrate data of the remote memory address region between the first DRAM and the second DRAM by issuing memory access transactions over the first back-end CXL link and the second back-end CXL link, the memory access transactions configured according to CXL.mem; wherein the migration is initiated by the resource composer independently of an operating system of the entity. The memory access transactions issued by the resource composer over the first back-end CXL link and the second back-end CXL link may include CXL.mem read transactions, CXL.mem write transactions, or other CXL.mem transactions sufficient to read data from one back-end DRAM and write data to another back-end DRAM. The resource composer's migration logic may be combined with the mapping data structure such that the migration is initiated within the apparatus without involvement of an operating system of the entity. Because the migration is initiated by the resource composer independently of the entity's operating system, the migration may occur transparently to applications executing on the entity and without consuming compute resources of the entity for migration orchestration.

In some implementations of the system, the resource composer is configured to maintain residency state for the remote memory address region, the residency state indicating for portions of the remote memory address region which of the first DRAM or the second DRAM serves the respective portion; and wherein, in response to availability of one of the first back-end entity or the second back-end entity changing, the resource composer is configured to continue serving portions of the remote memory address region indicated by the residency state to be mapped to a remaining available one of the first back-end entity or the second back-end entity. The residency state may be maintained as a table mapping portions of the remote memory address region to back-end DRAMs, as a content-addressable memory entry per portion, or as a hierarchical data structure encoding which back-end DRAM serves each portion. The resource composer may detect availability changes by polling status registers of the back-end entities, by observing absence of response within a timeout interval, by receiving link-down indications from CXL port circuitry, or by receiving an out-of-band notification from a fabric manager. In response to an availability change indicating that one back-end entity has become unavailable, the resource composer may continue serving portions of the remote memory address region that the residency state indicates are mapped to a remaining available back-end entity, and may report unavailability to the entity for portions that the residency state indicates are mapped only to the unavailable back-end entity. In an alternative form, the resource composer may maintain replicated copies of portions across multiple back-end DRAMs so that, when one back-end entity becomes unavailable, portions originally mapped to that back-end entity may be mapped to a replicated copy in a back-end DRAM of a remaining available back-end entity. Because the resource composer maintains residency state and uses it to continue serving portions when one back-end entity becomes unavailable, the system may degrade gracefully in response to back-end-entity failures rather than losing access to the entire remote memory address region.

In some implementations, the system further comprises a third back-end entity coupled to the memory pool via a third back-end CXL link, the third back-end entity different from the first back-end entity and from the second back-end entity, the third back-end entity comprising third DRAM accessible by one or more processing cores of the third back-end entity; wherein the resource composer is further configured to multiplex the third DRAM onto the CXL link such that a third portion of the remote memory address region exposed via the CXL link is mapped to the third DRAM; and wherein at a given time during access by the entity to the remote memory address region, the first portion is mapped to the first DRAM, the second portion is mapped to the second DRAM, and the third portion is mapped to the third DRAM. The third back-end entity may include a host computer system, a server, or other compute system having its own processing cores and its own locally-attached DRAM. The resource composer may multiplex the third DRAM onto the CXL link in the same manner as the first DRAM and the second DRAM, by extending the mapping data structure to associate portions of the remote memory address region with any of the first DRAM, the second DRAM, or the third DRAM, and by forwarding memory access transactions to the corresponding back-end CXL link based on the mapping. At a given time during access by the entity to the remote memory address region, the first portion, the second portion, and the third portion may be concurrently mapped to the first DRAM, the second DRAM, and the third DRAM respectively. Because the resource composer concurrently serves portions from three or more back-end DRAMs, the architecture may aggregate DRAM capacity and bandwidth from more contributing entities than a two-back-end arrangement may provide.

In some implementations of the system, the first back-end entity comprises a first compute system independently executing an operating system kernel instance and exposing the first DRAM to the memory pool over the first back-end CXL link, the second back-end entity comprises a second compute system independently executing an operating system kernel instance and exposing the second DRAM to the memory pool over the second back-end CXL link, and the third back-end entity comprises a third compute system independently executing an operating system kernel instance and exposing the third DRAM to the memory pool over the third back-end CXL link. Each compute system of the first back-end entity, the second back-end entity, and the third back-end entity may run an operating system kernel instance, such as a Linux kernel, a Unix-like kernel, a hypervisor kernel, or another operating system kernel, independently of the other compute systems. The operating system kernel instance of each back-end entity may execute workloads consuming the back-end entity's own DRAM, and may also expose a portion of the back-end entity's DRAM to the memory pool over the corresponding back-end CXL link through a kernel module, a firmware extension, or a hardware path that does not require kernel involvement on a per-transaction basis. Because the back-end entities are independent compute systems executing their own operating system kernel instances, the architecture may aggregate DRAM contributed by multiple independently-operated compute systems rather than DRAM of memory-only devices, and back-end entities may simultaneously consume their own DRAM and contribute idle portions of their DRAM to the memory pool.

In some implementations of the system, the first DRAM and the second DRAM are exposed to the entity via the CXL link as byte-addressable memory of the entity accessible by load operations and store operations of the entity; and wherein at least one of the entity, the first back-end entity, or the second back-end entity comprises a host computer system, a Central Processing Unit (CPU), a Graphics Processing Unit (GPU), a Data Processing Unit (DPU), or an accelerator. The remote memory address region may be exposed to the entity as byte-addressable memory through the CXL.mem semantics of the CXL link, such that load operations and store operations of the entity may access bytes, words, or cachelines of the remote memory address region using physical addresses of the entity. The entity, the first back-end entity, and the second back-end entity may each include a host computer system (such as a server or workstation), a CPU, a GPU, a DPU, an accelerator, or other compute apparatus capable of issuing or accepting CXL.mem transactions. A first composition may include an entity that is a host computer system with first and second back-end entities that are also host computer systems; another composition may include an entity that is a GPU or accelerator with first and second back-end entities that are host computer systems. Because the remote memory address region is exposed as byte-addressable memory accessible via load and store operations, applications executing on the entity may access the remote memory address region with the same memory-access primitives used for memory directly attached to the entity, and because the entity and the back-end entities may each be any of the enumerated entity types, the architecture may apply to heterogeneous deployments combining hosts, accelerators, and other compute apparatus.

In various implementations, a method comprising: Exposing a remote memory address region, by a memory pool to an entity, via a Compute Express Link (CXL) link configured to support CXL.mem; mapping, by a resource composer, a first portion of the remote memory address region to a first dynamic random access memory (DRAM) of a first back-end entity, and a second portion of the remote memory address region to a second DRAM of a second back-end entity, wherein the first back-end entity is coupled to the memory pool via a first back-end CXL link and comprises the first DRAM accessible by one or more processing cores of the first back-end entity, and wherein the second back-end entity is coupled to the memory pool via a second back-end CXL link, and comprises the second DRAM accessible by one or more processing cores of the second back-end entity; providing, by a memory traffic analyzer to the resource composer, telemetry of memory accesses; and managing, by the resource composer using the telemetry, mapping of portions of the remote memory address region to the first DRAM and the second DRAM. The method may be performed by a memory pool, by a resource composer, by a memory traffic analyzer, or by a combination of the foregoing apparatuses, with operations distributed among hardware logic, firmware, or instructions executed on a processor of the memory pool. Exposing the remote memory address region to the entity may include presenting an address range to the entity via the CXL link configured to support CXL.mem, the address range being byte-addressable by the entity. Multiplexing the first DRAM and the second DRAM onto the CXL link may include: (1) maintaining a mapping data structure that associates portions of the remote memory address region with one of the first DRAM or the second DRAM; (2) receiving memory access transactions for the remote memory address region from the CXL link; (3) determining, using the mapping data structure, which back-end DRAM serves each portion; (4) forwarding each memory access transaction to the corresponding back-end CXL link; and (5) returning responses to the CXL link. Providing the telemetry may include observing memory access transactions associated with the remote memory address region, maintaining access-count state for memory address blocks of the remote memory address region, and reporting the access-count state to the resource composer. Managing mapping of portions of the remote memory address region may include determining whether to migrate memory address blocks between the first DRAM and the second DRAM based at least in part on the telemetry, and updating the mapping data structure to reflect new mappings. The method may be performed concurrently across many entities and many back-end entities, and the multiplexing operation may operate by per-portion mapping decisions that do not depend on the total number of back-end entities or the specific size of the remote memory address region, so the method may apply at any number of back-end entities and any size of remote memory address region within the claim scope. At the low end of the claim scope, the method may multiplex as few as two back-end DRAMs onto the CXL link; at the high end of the claim scope, the method may multiplex many back-end DRAMs with mapping updated periodically based on accumulated telemetry. The method may be embodied in instructions executed by a processor of the memory pool, in firmware of the memory pool, in hardware logic of the memory pool, or in a hybrid combination, with the processor coupled to a memory storing the instructions for execution. A limited DRAM capacity may be available to a single consuming entity in environments that use only single-source memory expansion exacerbates the inability of static composition arrangements to adapt to observed access patterns. Because the mapping is managed using the telemetry, hot portions of the remote memory address region may be mapped to lower-latency back-end DRAM and cold portions to higher-latency back-end DRAM, and overall access latency and utilization of the back-end DRAMs may be improved relative to static composition arrangements.

In some implementations of the method, the memory traffic analyzer comprises a spatio-temporal (ST) analyzer; the providing comprises characterizing, by the ST analyzer, the memory accesses by spatial locality across addresses of the remote memory address region and temporal access patterns over a time window and providing the characterization to the resource composer; and the managing comprises managing the mapping of portions of the remote memory address region based at least in part on the spatial locality and the temporal access patterns indicated by the characterization. The ST analyzer may be implemented as hardware sampling circuitry of the memory pool, as firmware running on a microcontroller of the memory pool, or as a hybrid. Characterizing the memory accesses by spatial locality may include grouping addresses into address-range bins and counting accesses per bin. Characterizing the memory accesses by temporal access patterns may include sampling access counts over fixed or sliding time windows and recording access timestamps. Because the mapping is managed based on both spatial locality and temporal access patterns, the method may adapt to workloads that exhibit different combinations of locality and recency in memory accesses.

In some implementations of the method, the providing comprises observing, by hardware analyzer circuitry placed at edges of CXL links of the memory pool, memory access transactions traversing the edges, maintaining access-count state per memory address block of the remote memory address region at a granularity not larger than a page frame of the remote memory address region, and deriving the telemetry from the access-count state. The hardware analyzer circuitry may be implemented as a counter array, a sampling circuit, or a finite state machine integrated within or adjacent to a CXL port of the memory pool. Observing the memory access transactions traversing the edges may include inspecting transaction-layer headers, tapping the data path between physical-layer and link-layer circuits of the port, or mirroring transactions to a sideband observation channel. The memory address blocks may include cachelines, sub-pages, or page frames of the remote memory address region, with the granularity not larger than a page frame (such as 4 KiB, 2 MiB, or 1 GiB). Because the telemetry is derived from hardware-observed access-count state at edges of CXL links, the method may collect mapping-relevant data on hardware paths of the memory pool without requiring instrumentation of the entity's operating system.

In some implementations of the method, the managing comprises migrating, by the resource composer, page frames of the remote memory address region between the first DRAM and the second DRAM by issuing memory access transactions over the first back-end CXL link and the second back-end CXL link configured according to CXL.mem, the migrating initiated by the resource composer independently of an operating system of the entity and based at least in part on telemetry accumulated by the memory traffic analyzer over a plurality of memory accesses preceding the migrating. Migrating page frames may include the resource composer issuing CXL.mem read transactions on one of the first back-end CXL link or the second back-end CXL link, the resource composer issuing CXL.mem write transactions on the other back-end CXL link with the read data, and the resource composer updating the mapping data structure to redirect subsequent accesses to the new mapping. The accumulated telemetry may include sampled access counts over a configurable time window, exponentially-weighted moving averages of access counts, or count differentials between observation intervals. Because the migrating is initiated by the resource composer independently of the entity's operating system, the migrating may occur transparently to applications executing on the entity and without consuming compute resources of the entity for migration orchestration.

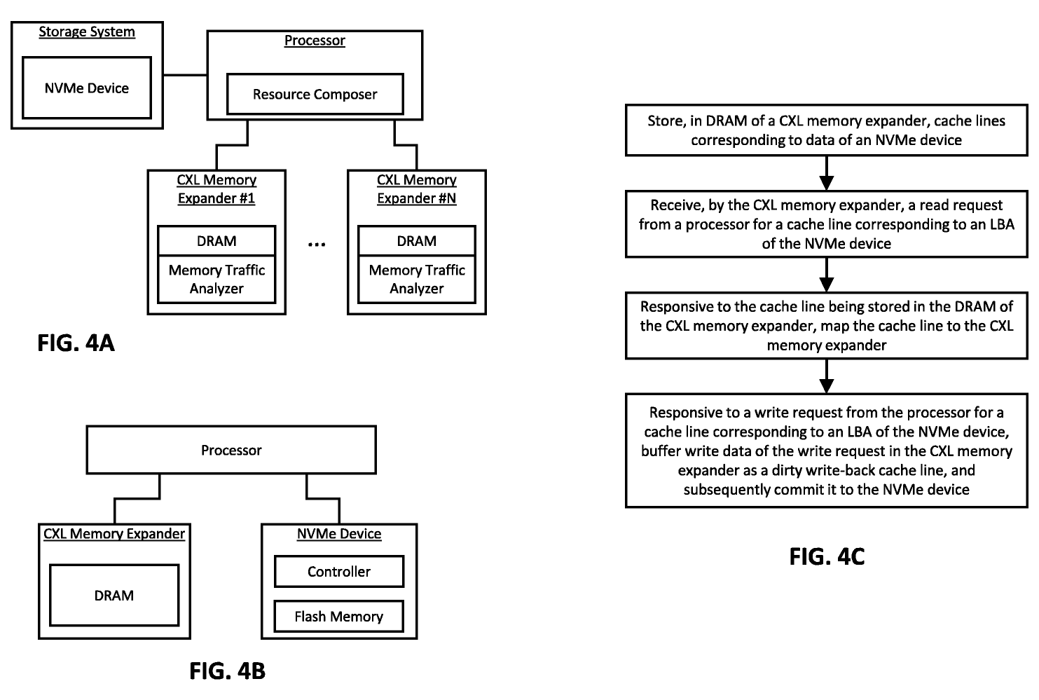

FIG. 4A illustrates an example of a system comprising a processor coupled to a storage system and to CXL memory expanders. Each CXL memory expander carries DRAM and a memory traffic analyzer, where the memory traffic analyzer produces per-expander telemetry of accesses to the DRAM of that CXL memory expander. The resource composer may be hosted at the processor. The resource composer aggregates the per-expander telemetry across the CXL memory expanders and determines mapping of NVMe cache elements for the NVMe device across the CXL memory expanders based at least in part on the aggregation. The DRAMs of the CXL memory expanders serve as cache for the NVMe device. The resource composer may instead be hosted at a CXL switch coupling the processor to the CXL memory expanders, or at an appliance coupled to the processor.

Some implementations relate to mapping of cache for an NVMe device across plural CXL memory expanders coupled to a processor. The CXL memory expanders may each carry a memory traffic analyzer that produces telemetry of memory accesses to the DRAM of that CXL memory expander. A resource composer may aggregate per-expander telemetry from across the CXL memory expanders and may determine, based on the aggregation, where NVMe cache elements may be mapped to the CXL memory expanders.

In various implementations, a system comprising: a storage system comprising a Non-Volatile Memory Express (NVMe) device; a processor coupled to the NVMe device; Compute Express Link (CXL) memory expanders coupled to the processor via CXL links, the CXL memory expanders comprising dynamic random-access memory (DRAM) and memory traffic analyzers, wherein the memory traffic analyzers are configured to produce per-expander telemetry of accesses to the DRAM; and a resource composer configured to aggregate the per-expander telemetry from the memory traffic analyzers, and to determine mapping of NVMe cache elements for the NVMe device across the CXL memory expanders based at least in part on the aggregation of the per-expander telemetry; wherein the DRAM is configured to serve as cache for the NVMe device. The system may be implemented with the CXL memory expanders coupled to the processor via respective CXL links, the CXL memory expanders comprising DRAMs exposed to the processor as HDM via the CXL links. The memory traffic analyzers may be implemented as hardware circuits on-die within CXL controllers of the CXL memory expanders, as finite state machines, or as firmware executing on embedded controllers of the CXL memory expanders, and may track accesses to the DRAMs by, for example: (1) observing memory access requests received by the CXL memory expanders; (2) updating, for ones of the observed memory access requests, one or more local counters, sketches, or histograms of the memory traffic analyzers; and (3) outputting, periodically or on request, per-expander telemetry derived from the local counters, sketches, or histograms. The resource composer may be implemented as instructions executing on the processor, as a finite state machine in a CXL switch, or as circuitry in an appliance coupled to the processor, and may perform: (1) receiving per-expander telemetry from the memory traffic analyzers of the CXL memory expanders; (2) aggregating the per-expander telemetry across the CXL memory expanders, for example by union of access frequency maps, by weighted combination of telemetry components, or by statistical merging of telemetry distributions; (3) determining, based on the aggregated per-expander telemetry, ones of the CXL memory expanders at which ones of the NVMe cache elements may be placed; and (4) issuing migration commands to ones of the CXL memory expanders directing the mapping. The memory traffic analyzers may operate per CXL memory expander independently of a total count of the CXL memory expanders, and the resource composer may operate across any count of CXL memory expanders by combining the per-expander telemetry into the aggregation, so that mapping decisions may be made across two CXL memory expanders, across many tens of CXL memory expanders, or any count therebetween. The system may comprise two CXL memory expanders aggregated by a single instance of the resource composer. At a high corner, the system may comprise many tens of CXL memory expanders aggregated by a single instance of the resource composer, or by plural distributed instances of the resource composer that coordinate on the aggregation. The DRAMs of the CXL memory expanders may serve as cache for the NVMe device in several arrangements: the DRAMs may supplement on-board DRAM cache of the NVMe device; the DRAMs may replace on-board DRAM cache of the NVMe device; or the DRAMs may operate as one tier of cache for the NVMe device alongside one or more other cache tiers (such as a host-DRAM tier accessible by the processor), where mapping decisions may distribute NVMe cache elements across the CXL memory expanders and the one or more other cache tiers. Variability in cache-access latency may be caused under workload skew, where a single cache substrate may be hot-spotted by skewed access patterns, and constrained cache capacity at an NVMe device. Because the memory traffic analyzers produce per-expander telemetry that may be aggregated by the resource composer, mapping of NVMe cache elements may be adjusted to reduce queue-depth imbalance across the CXL memory expanders, and tail latency of cache accesses may be reduced relative to a single-substrate cache configuration.

In some implementations of the system, the memory traffic analyzers comprise spatio-temporal (ST) analyzers configured to characterize access patterns to the DRAMs at sub-page granularity, the per-expander telemetry distinguishing cache hot-spots from streaming traffic. The ST analyzers may characterize access patterns at cache-line granularity, or in some implementations at a finer granularity such as a sub-cache-line range or at a coarser granularity such as a multi-cache-line region within a host page. The per-expander telemetry from the ST analyzers may distinguish hot-spot regions of the DRAMs, where access density may exceed access density of other regions, from streaming regions where accesses may pass through without re-reference. Because the ST analyzers characterize access patterns at sub-page granularity, the resource composer may direct mapping of NVMe cache elements at a finer granularity than page-level analyzers would provide.

In some implementations of the system, the ST analyzers are implemented on-die within CXL controllers of the CXL memory expanders, the ST analyzers comprising at least one of: (a) a Count-Min Sketch configured to estimate per-page access counts; (b) an inter-arrival-time histogram configured to maintain a logarithmically-bucketed distribution of access intervals to the DRAMs; or (c) a stride detector configured to classify access patterns as one of: sequential, stride, or random; and wherein the ST analyzers are further configured to output, as part of the per-expander telemetry, heat-maps indexed by address ranges of the DRAMs. The Count-Min Sketch may be a probabilistic counter array indexed by hashes of access addresses. The inter-arrival-time histogram may be implemented as a logarithmically-bucketed counter array. The stride detector may be a finite state machine tracking deltas between successive access addresses and may classify access patterns into sequential, stride, or random categories. The heat-map output may be a sparse list of address ranges with associated access scores. Because the ST analyzers are implemented on-die within the CXL controllers of the CXL memory expanders, the per-expander telemetry may be derived without consuming external CXL link bandwidth beyond what telemetry export itself consumes.

In some implementations of the system, the resource composer is located at one of: the processor, a CXL switch coupling the processor to the CXL memory expanders, or an appliance coupled to the processor; and wherein the resource composer is further configured to receive the per-expander telemetry from the memory traffic analyzers via in-band CXL messages or via an out-of-band telemetry channel, to maintain a mapping table mapping the NVMe cache elements to ones of the CXL memory expanders, and to issue, to the CXL memory expanders, migration commands directing migration of the NVMe cache elements between the CXL memory expanders according to the mapping table. The resource composer located at the processor may be implemented as software instructions executed by the processor, with the per-expander telemetry received via memory-mapped registers of the CXL memory expanders or via CXL DOE mailbox queries. The resource composer located at the CXL switch may be implemented as firmware in a fabric manager of the CXL switch, with the per-expander telemetry forwarded by the CXL switch from the CXL memory expanders. The resource composer located at the appliance may be implemented as instructions executing on a separate compute node coupled to the processor, with the per-expander telemetry received over a network channel or over a CXL fabric. The mapping table may be implemented as a list, a hash table, or a radix tree mapping NVMe cache element identifiers to CXL memory expander identifiers. The migration commands may be implemented as CXL.mem messages, CXL DOE messages, or vendor-specific mailbox commands directing the CXL memory expanders to copy or move NVMe cache elements among themselves. Because the resource composer may be located at the processor, at the CXL switch, or at the appliance, mapping-decision logic may be deployed at a locus appropriate to a given system architecture without changing per-expander telemetry production at the CXL memory expanders.

In some implementations of the system, the resource composer is further configured to determine the mapping of the NVMe cache elements at a sub-second cadence based on a fused telemetry vector aggregated from the per-expander telemetry, the fused telemetry vector comprising at least one of: per-page access counts derived from the per-expander telemetry, inter-arrival-time statistics derived from the per-expander telemetry, bandwidth utilization metrics for the CXL links of the CXL memory expanders, or queue depth metrics for memory access queues of the CXL memory expanders; and wherein the resource composer is further configured to issue, to the CXL memory expanders, background migration commands directing relocation of ones of the NVMe cache elements among the CXL memory expanders responsive to one or more components of the fused telemetry vector crossing a configured threshold. The sub-second cadence may be implemented by a timer or scheduler in the resource composer, with cadence values selected based on telemetry volume and migration cost. The fused telemetry vector may be assembled by concatenating, aggregating, or statistically merging components of the per-expander telemetry. The configured threshold may be applied per component of the fused telemetry vector or to a composite score derived from multiple components of the fused telemetry vector. The background migration commands may be implemented as CXL.mem messages or vendor-specific copy operations executed without blocking foreground accesses to the CXL memory expanders. Because the resource composer determines mapping at a sub-second cadence using the fused telemetry vector, mapping may be adjusted faster than workload phase changes that span seconds or minutes, while avoiding the overhead of per-request mapping decisions.

In some implementations of the system, the NVMe cache elements comprise at least one of: a read cache line, a write-back dirty cache line, a flash translation layer (FTL) logical-to-physical (L2P) entry, or garbage collection metadata, of the NVMe device; and wherein the resource composer is further configured to apply an element-type-specific mapping policy and an element-type-specific remapping policy to the NVMe cache elements, the element-type-specific mapping policy and the element-type-specific remapping policy being parameterized by the per-expander telemetry. The read cache line type may be associated with a least-recently-used remapping policy. The write-back dirty cache line type may be associated with a write-coalescing policy that delays write-back until a flush condition is met. The FTL L2P entry type may be associated with a pinning policy that keeps frequently-traversed L2P entries resident in the DRAMs. The garbage collection metadata type may be associated with a sequential mapping policy across the CXL memory expanders. The element-type-specific mapping policy and the element-type-specific remapping policy may be parameterized by per-expander telemetry components such as access frequency, recency, or queue depth. Because the resource composer applies an element-type-specific mapping policy and an element-type-specific remapping policy parameterized by the per-expander telemetry, NVMe cache elements with different access characteristics may receive mapping and remapping treatments matched to those characteristics rather than a uniform treatment.

In some implementations of the system, the resource composer is further configured to determine the mapping of the NVMe cache elements according to an objective function comprising at least one of: a tail-latency term derived from an inter-arrival-time distribution of the per-expander telemetry, or a bandwidth headroom term derived from the per-expander telemetry. The tail-latency term may be computed from a high-percentile statistic of inter-arrival times of the per-expander telemetry. The bandwidth headroom term may be computed as residual bandwidth capacity of the CXL links derived from the per-expander telemetry. The objective function may combine the terms by weighted sum, weighted product, or non-linear composition. Because the mapping is determined according to the objective function comprising at least the tail-latency term or the bandwidth headroom term, mapping decisions may balance latency stability against utilization of CXL link bandwidth across the CXL memory expanders.

In some implementations of the system, the resource composer is further configured to enforce a tail-latency service-level objective (SLO) on read-cache-hit responses of the storage system, the resource composer enforcing the tail-latency SLO by performing at least one of: (a) monitoring an inter-arrival-time variance derived from the per-expander telemetry; (b) distributing hot ones of the NVMe cache elements across two or more of the CXL memory expanders to balance queue depth among the CXL memory expanders; or (c) triggering reallocation of ones of the NVMe cache elements between the CXL memory expanders responsive to a metric of the per-expander telemetry exceeding a threshold during a distributed synchronized workload, the distributed synchronized workload comprising at least one of: a high-performance computing barrier, an all-reduce operation, or a distributed-database commit. The tail-latency SLO may be expressed as a percentile cap on read-cache-hit response latency, with the percentile and cap configured to a workload's latency objective. Monitoring the inter-arrival-time variance may comprise computing a running variance of inter-arrival times across the per-expander telemetry. Distributing hot NVMe cache elements may comprise copying or migrating ones of the NVMe cache elements that have high access frequency to additional ones of the CXL memory expanders. Triggering reallocation may comprise initiating background migration commands responsive to the metric exceeding the threshold. The HPC barrier, the all-reduce operation, and the distributed-database commit may each be characterized by synchronized accesses across nodes, where tail-latency outliers from any node may stall the synchronization. Because the resource composer enforces the tail-latency SLO by performing at least one of the recited actions, the storage system may bound tail latency of read-cache-hit responses for such distributed synchronized workloads.

In some implementations of the system, the CXL memory expanders comprise a multi-logical-device (MLD), the MLD presenting logical devices to the processor, the logical devices being separately-addressable by the processor; wherein the memory traffic analyzer of the MLD is further configured to produce the per-expander telemetry of the MLD on a per-logical-device basis with respective sub-telemetry per logical device; and wherein the resource composer is further configured to determine the mapping of the NVMe cache elements on a per-logical-device basis based on the respective sub-telemetry, providing isolation between workloads sharing the MLD. The MLD may be a CXL Type 3 multi-logical-device that presents plural logical devices to the processor, where logical devices may be addressed via different LD-IDs in CXL.mem transactions. The memory traffic analyzer of the MLD may maintain separate per-logical-device counters, sketches, or histograms, and may produce per-LD sub-telemetry derived from the separate counters, sketches, or histograms. The resource composer may apply per-LD mapping, for example by mapping a NVMe cache element to a specific logical device of the MLD based on the sub-telemetry of that logical device. Because the memory traffic analyzer produces per-LD sub-telemetry and the resource composer determines mapping per logical device, isolation between workloads sharing the MLD may be provided by independent mapping decisions per logical device.

In some implementations of the system, the resource composer is further configured to direct storing of multiple copies of an NVMe cache element across two or more of the CXL memory expanders, the CXL memory expanders being configured to maintain consistency between the multiple copies by issuing CXL.mem back-invalidations between the CXL memory expanders, the CXL.mem back-invalidations being triggered by writes to the NVMe cache element on CXL memory expanders that hold ones of the multiple copies; and wherein the resource composer is further configured to place the multiple copies of the NVMe cache element across the CXL memory expanders to enable load-balanced service of read requests for the NVMe cache element. The multiple copies of the NVMe cache element may be stored across two CXL memory expanders, across three CXL memory expanders, or more, with the number of copies selected based on access frequency, fault-tolerance objectives, or read-parallelism objectives. The CXL memory expanders may maintain consistency between the multiple copies by issuing CXL.mem back-invalidations to one or more other CXL memory expanders that hold copies of the NVMe cache element, the CXL.mem back-invalidations being issued responsive to a write of the NVMe cache element. The resource composer may place the multiple copies across the CXL memory expanders such that read requests for the NVMe cache element may be mapped to different ones of the CXL memory expanders, increasing aggregate read throughput. Because copies are maintained across multiple CXL memory expanders with cross-expander CXL.mem back-invalidations, the NVMe cache element may be mapped to any of the CXL memory expanders holding a copy while maintaining consistency across the copies.

FIG. 4B illustrates an example arrangement of the storage system comprising a processor, an NVMe device coupled to the processor, and a CXL memory expander (comprising DRAM) coupled to the processor via a CXL link. The CXL memory expander is a hardware device physically separate from the NVMe device, does not house the flash memory of the NVMe device, and is coupled to the processor in parallel to the NVMe device. The NVMe device comprises a controller and flash memory. The CXL memory expander comprises DRAM. The DRAM of the CXL memory expander is configured to serve as a DRAM cache for the NVMe device. The CXL memory expander may be implemented as a CXL-attached card, as a CXL-attached memory module, or as a chip mounted on a host motherboard separately from the NVMe device. The NVMe device may be implemented as a PCIe-attached solid-state drive or as another NAND-flash-based storage subsystem coupled to the processor.

In various implementations, a storage system comprising: a processor; a Non-Volatile Memory Express (NVMe) device coupled to the processor, the NVMe device comprising a controller and flash memory; and a Compute Express Link (CXL) memory expander coupled to the processor via a CXL link, the CXL memory expander comprising dynamic random-access memory (DRAM); wherein at least part of the DRAM of the CXL memory expander is managed by the controller and configured to serve as a cache for the NVMe device. The storage system may be implemented with the CXL memory expander as a CXL-attached card (such as an EDSFF card or an add-in card), as a CXL-attached memory module (such as a CXL-bridged DRAM DIMM), or as a chip mounted on a host motherboard separately from the NVMe device. The NVMe device may be implemented as a PCIe-attached solid-state drive in a form factor such as EDSFF, U.2, or M.2, or as a NAND-flash-based storage subsystem coupled to the processor over PCIe. The CXL memory expander and the NVMe device may be hardware devices physically separate from one another, with the flash memory of the NVMe device housed on the NVMe device and the DRAM of the CXL memory expander housed on the CXL memory expander. The CXL memory expander may be coupled to the processor in parallel to the NVMe device, so that the CXL memory expander and the NVMe device may be installed, removed, or replaced independently of each other. The DRAM cache may be operated by a CXL controller circuit or finite state machine of the CXL memory expander that may, for example: (1) receive, via the CXL link, cache lines comprising data being read from or written to the flash memory of the NVMe device; (2) store the cache lines in the DRAM under an address mapping between processor-visible CXL.mem addresses and DRAM-internal locations; (3) on a subsequent read request from the processor, serve the cache lines from the DRAM via the CXL link; and (4) on a write of cache lines to be committed to the flash memory, signal the NVMe device to retrieve the cache lines for commitment to the flash memory, or initiate a write of the cache lines from the DRAM to the NVMe device over a separate link such as a PCIe link between the processor and the NVMe device. The architecture may operate independently of the specific form factor of the CXL memory expander or the NVMe device, so that the DRAM cache for the NVMe device may be hosted on a card, on a module, on a chip, or on another physically-separable hardware unit. The storage system may comprise a single CXL memory expander hosting a DRAM cache for one NVMe device. The storage system may comprise a single CXL memory expander hosting a DRAM cache for multiple NVMe devices, or multiple CXL memory expanders together hosting a DRAM cache for one or more NVMe devices. Because the DRAM cache is hosted on the CXL memory expander as a hardware device physically separate from the NVMe device, the DRAM cache capacity may scale independently of physical constraints of the NVMe device, and the cost of integrating DRAM and flash memory on a single hardware device may be avoided.

In some implementations of the storage system, the NVMe device is coupled to the processor via a PCIe link, the CXL link and the PCIe link being separate physical links; and wherein the storage system is configured to perform at least one of: (a) serving, via the DRAM cache, read commands for cached data of the NVMe device from the DRAM of the CXL memory expander to the processor via the CXL link; or (b) absorbing write commands for the NVMe device into the DRAM cache by buffering write data in the DRAM of the CXL memory expander and subsequently committing the buffered write data to the flash memory of the NVMe device via the PCIe link. The NVMe device may be coupled to the processor via the PCIe link instantiated through a PCIe root port or a PCIe root complex of the processor. The CXL link and the PCIe link may be separate physical links, each having its own slot or connector at the processor. Serving read commands via the DRAM cache may comprise looking up requested data in the DRAM under an address-to-cache mapping, returning the data from the DRAM via the CXL link, and bypassing the PCIe link to the NVMe device for the duration of the read. Absorbing write commands may comprise storing write data in the DRAM as a dirty write-back cache line, signaling completion to the processor over the CXL link, and committing the write data to the flash memory at a later time over the PCIe link. Because the CXL link and the PCIe link may be separate physical links, read traffic mapped to the DRAM cache may avoid contending with write traffic mapped to the NVMe device for the same physical link bandwidth.

In some implementations of the storage system, the DRAM cache replaces or supplements an on-board DRAM cache otherwise adjacent to the controller of the NVMe device, and a flash translation layer (FTL) logical-to-physical (L2P) table of the NVMe device is maintained on the NVMe device; and wherein the CXL memory expander being a hardware device that is physically separate from the NVMe device, the CXL memory expander not housing the flash memory of the NVMe device, and the CXL memory expander being coupled to the processor in parallel to the NVMe device. The on-board DRAM cache otherwise adjacent to the controller of the NVMe device may be a DRAM chip on a printed circuit board of the NVMe device, with capacity bounded by board layout, power budget, and connector form factor. The DRAM cache on the CXL memory expander may be sized larger than the on-board DRAM cache, may be sized smaller, or may be sized comparably. The FTL L2P table of the NVMe device may be maintained on the NVMe device in the on-board DRAM cache, in the flash memory of the NVMe device, in SRAM of the NVMe device, or in a combination thereof. Because the DRAM cache on the CXL memory expander may replace or supplement the on-board DRAM cache while the FTL L2P table is maintained on the NVMe device, cache capacity available for cache lines may scale via the CXL memory expander while the FTL operates independently of the DRAM cache.

In some implementations of the storage system, the CXL memory expander is configured to perform at least one of: (a) maintaining consistency between a copy of a cache element in the DRAM of the CXL memory expander and a copy of the cache element in a cache of the processor by issuing a CXL.mem back-invalidation, the CXL.mem back-invalidation being responsive to a write of the cache element by the NVMe device or by the CXL memory expander, the CXL.mem back-invalidation causing the processor to invalidate the copy of the cache element in the cache of the processor; or (b) maintaining a snoop filter tracking cache elements stored in the DRAM of the CXL memory expander that are potentially held in the cache of the processor. The CXL.mem back-invalidation may be implemented using CXL.mem back-invalidation messages issued by the CXL memory expander to the processor over the CXL link. The CXL.mem back-invalidation may be triggered by a write of the cache element by the NVMe device (such as a write-through from the flash memory) or by the CXL memory expander itself (such as a cache line update). The snoop filter may be implemented as a directory structure (such as a sparse directory or a tagged directory) within the CXL controller of the CXL memory expander, tracking ones of the cache elements stored in the DRAM that may also be held in the cache of the processor. Because the CXL memory expander may issue CXL.mem back-invalidations or maintain the snoop filter, consistency may be maintained between the DRAM-resident copy of the cache element and the processor-cache-resident copy of the cache element.

In some implementations of the storage system, the CXL memory expander further comprises a power-loss-protection element, the CXL memory expander being configured to tag cache lines stored in the DRAM of the CXL memory expander with respective NVMe namespace identifiers and respective logical block addresses (LBAs) of the NVMe device to which the cache lines correspond; and wherein dirty write-back cache lines stored in the DRAM of the CXL memory expander are flushed to the flash memory of the NVMe device using power from the power-loss-protection element under a Global Persistent Flush (GPF) protocol upon a power loss event, the CXL memory expander routing the dirty write-back cache lines to respective destinations in the flash memory based on the respective NVMe namespace identifiers and the respective LBAs of the dirty write-back cache lines. The power-loss-protection element may be implemented as a capacitor bank, a supercapacitor array, or a battery on the CXL memory expander. Tagging the cache lines with the NVMe namespace identifiers and the LBAs may be performed by the CXL controller of the CXL memory expander on insertion of cache lines into the DRAM, with the tags maintained alongside the cache lines in the DRAM or in a separate tag memory of the CXL memory expander. On a power loss event, the GPF protocol may be initiated, and the CXL memory expander may walk the dirty write-back cache lines in the DRAM, retrieve their NVMe namespace identifier tags and LBA tags, and direct each dirty write-back cache line to the flash memory of the NVMe device at the LBA within the namespace indicated by its tags. Because the tags identify the destination namespace and LBA, the flush may route each dirty write-back cache line to its destination in the flash memory without re-traversing the FTL L2P table at flush time.

In some implementations of the storage system, the CXL memory expander is one of a plurality of CXL memory expanders coupled to the processor via respective CXL links, the plurality of CXL memory expanders comprising memory traffic analyzers configured to produce per-expander telemetry of accesses to DRAMs of the plurality of CXL memory expanders; and further comprising a resource composer configured to aggregate the per-expander telemetry from the memory traffic analyzers, and to determine mapping of NVMe cache elements for the NVMe device across the plurality of CXL memory expanders based at least in part on the aggregation of the per-expander telemetry. The plurality of CXL memory expanders may include the CXL memory expander and one or more additional CXL memory expanders, each coupled to the processor via a respective CXL link. The memory traffic analyzers may be implemented per CXL memory expander as discussed in the corresponding per-claim SPEC paragraphs of the first claim set. The resource composer may aggregate the per-expander telemetry from the memory traffic analyzers of the plurality of CXL memory expanders, and may determine mapping of the NVMe cache elements across the plurality of CXL memory expanders. Because the multi-expander aggregation may be combined with the physically-separate-DRAM-and-flash architecture of the storage system, the DRAM cache for the NVMe device may scale across multiple CXL memory expanders, and mapping decisions may be informed by aggregated per-expander telemetry across the plurality of CXL memory expanders providing the DRAM cache.

In various implementations, a method comprising: storing, in dynamic random-access memory (DRAM) of a Compute Express Link (CXL) memory expander, cache lines corresponding to data of a Non-Volatile Memory Express (NVMe) device, the CXL memory expander being coupled to a processor via a CXL link, the NVMe device being coupled to the processor; receiving, by the CXL memory expander via the CXL link, a read request from the processor for a cache line corresponding to a logical block address (LBA) of the NVMe device, the cache line corresponding to data of the NVMe device stored in the flash memory of the NVMe device; responsive to the cache line being stored in the DRAM of the CXL memory expander, serving the cache line to the processor from the DRAM of the CXL memory expander via the CXL link; and responsive to a write request from the processor for a cache line corresponding to an LBA of the NVMe device, buffering write data of the write request in the DRAM of the CXL memory expander as a dirty write-back cache line, and subsequently committing the dirty write-back cache line to the flash memory of the NVMe device. The method may be performed by hardware circuitry of a CXL controller of the CXL memory expander, by firmware executing on an embedded controller of the CXL memory expander, or by instructions stored on a non-transitory computer-readable medium and executed by the processor or by a processor of the CXL memory expander. Storing cache lines corresponding to data of the NVMe device in the DRAM of the CXL memory expander may, for example, comprise: (1) receiving, by the CXL memory expander via the CXL link, cache lines or data to be cached; (2) computing or looking up an address mapping between processor-visible CXL.mem addresses and locations in the DRAM; and (3) writing the cache lines to the DRAM at the locations under the address mapping. Receiving the read request may, for example, comprise: (1) decoding a CXL.mem read message received via the CXL link; (2) extracting an address from the CXL.mem read message; and (3) looking up the address in the address mapping. Serving the cache line responsive to the cache line being stored in the DRAM may, for example, comprise: (1) reading the cache line from the DRAM at a location under the address mapping; and (2) returning the cache line to the processor via the CXL link. Responsive to a write request, buffering write data may, for example, comprise: (1) decoding a CXL.mem write message received via the CXL link; (2) writing the write data to the DRAM at a location under the address mapping; and (3) marking the write data as dirty. Subsequently committing the dirty write-back cache line may, for example, comprise: (1) initiating a write of the dirty write-back cache line to the NVMe device over a separate link such as a PCIe link between the processor and the NVMe device; and (2) signaling commit completion. The method may operate across CXL memory expanders of varying form factor, varying DRAM capacity, and varying CXL link width, so that the method may be applied at any CXL memory expander providing DRAM and a CXL link. The method may operate on a CXL memory expander providing a few gigabytes of DRAM for an NVMe device. The method may operate on a CXL memory expander providing many tens or hundreds of gigabytes of DRAM for one or more NVMe devices. Because the CXL memory expander is physically separate from the NVMe device and the cache lines are stored in the DRAM of the CXL memory expander accessible via the CXL link, the method may provide cache access at CXL.mem latencies while keeping the flash memory of the NVMe device on a hardware device separate from the CXL memory expander.

In some implementations, the method further comprises tracking, by a spatio-temporal (ST) analyzer of the CXL memory expander, access patterns to the DRAM of the CXL memory expander at sub-page granularity using at least one of: a Count-Min Sketch, an inter-arrival-time histogram, or a stride detector of the ST analyzer; and producing, by the ST analyzer, per-expander telemetry comprising at least one of: an access count per page, an inter-arrival-time distribution, or a stride classification, the per-expander telemetry distinguishing cache hot-spots from streaming traffic. Tracking access patterns at sub-page granularity may be performed by, for example, incrementing per-cache-line counters or per-sub-page counters of the ST analyzer in response to access requests received at the CXL memory expander. The Count-Min Sketch, the inter-arrival-time histogram, and the stride detector may each be implemented as discussed in the per-claim SPEC paragraph for the corresponding system claim. Producing the per-expander telemetry comprising at least one of an access count per page, an inter-arrival-time distribution, or a stride classification may comprise reading contents of the Count-Min Sketch, the inter-arrival-time histogram, or the stride detector, and emitting the read contents to a consumer of the per-expander telemetry. Because the per-expander telemetry distinguishes cache hot-spots from streaming traffic, downstream mapping decisions may target the cache hot-spots while leaving streaming traffic outside the cache.

In some implementations, the method further comprises aggregating, by a resource composer, per-expander telemetry from a plurality of CXL memory expanders coupled to the processor via respective CXL links; and determining, by the resource composer based on the aggregated per-expander telemetry, mapping of NVMe cache elements for the NVMe device across the plurality of CXL memory expanders. Aggregating per-expander telemetry from the plurality of CXL memory expanders may, for example, comprise: (1) collecting per-expander telemetry from each of the plurality of CXL memory expanders; (2) combining the per-expander telemetry into a fused representation by union, weighted combination, statistical merging, or another aggregation method; and (3) storing the fused representation for use by the resource composer. Determining the mapping of the NVMe cache elements based on the aggregated per-expander telemetry may comprise computing, by the resource composer, a target CXL memory expander for each of the NVMe cache elements based on the aggregated per-expander telemetry. Because the mapping is determined based on the aggregation across the plurality of CXL memory expanders, the resource composer may balance distribution of the NVMe cache elements across the plurality of CXL memory expanders based on observed access behavior across the plurality of CXL memory expanders.

In some implementations, the method further comprises tagging cache lines stored in the DRAM of the CXL memory expander with respective NVMe namespace identifiers and respective LBAs of the NVMe device to which the cache lines correspond; and flushing, upon a power loss event, dirty write-back cache lines from the DRAM of the CXL memory expander to the flash memory of the NVMe device using power from a power-loss-protection element of the CXL memory expander in accordance with a Global Persistent Flush (GPF) protocol, including routing the dirty write-back cache lines to respective destinations in the flash memory based on the respective NVMe namespace identifiers and the respective LBAs of the dirty write-back cache lines. Tagging the cache lines with the NVMe namespace identifiers and the LBAs may be performed at cache line insertion time as discussed in the SPEC paragraph for the corresponding system claim. Flushing the dirty write-back cache lines on the power loss event may, for example, comprise: (1) detecting the power loss event by the CXL memory expander; (2) switching power supply of the CXL memory expander to the power-loss-protection element; (3) walking the dirty write-back cache lines in the DRAM; (4) for each of the dirty write-back cache lines, retrieving its NVMe namespace identifier tag and LBA tag; and (5) issuing a write of the dirty write-back cache line to the flash memory of the NVMe device, with the write directed to the namespace and LBA from the tag. Because the routing uses the tags, the dirty write-back cache lines may be flushed to the destinations in the flash memory without re-traversing the FTL L2P table during the flush.

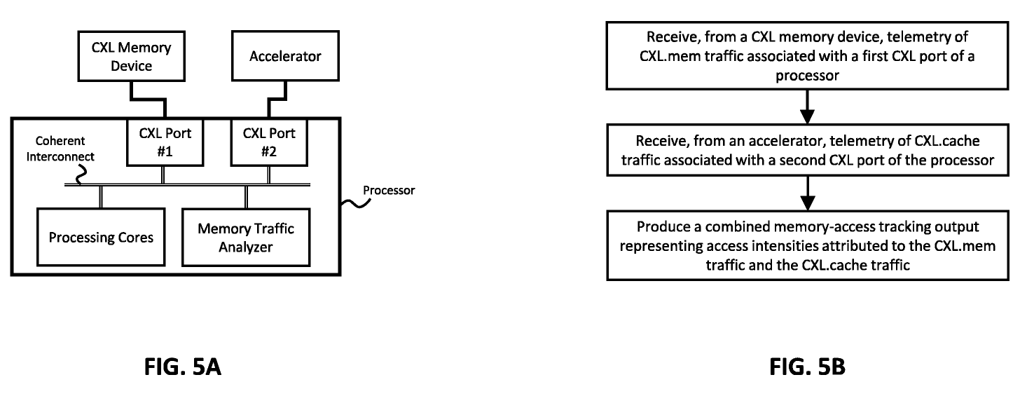

FIG. 5A illustrates an example of a processor that may include processing cores coupled via a coherent interconnect, a first CXL port coupling the coherent interconnect to a CXL memory device over CXL.mem, and a second CXL port coupling the coherent interconnect to an accelerator over CXL.cache. A memory traffic analyzer may be coupled to the coherent interconnect to receive telemetry of CXL.mem traffic associated with the first CXL port and telemetry of CXL.cache traffic associated with the second CXL port, and may produce a combined memory-access tracking output that represents, for memory regions, an access intensity attributed to the CXL.mem traffic and an access intensity attributed to the CXL.cache traffic. The memory traffic analyzer may be implemented as an agent of the coherent interconnect, may be coupled to a memory controller, may be coupled to a memory management unit, or may be integrated within an IC package together with the first CXL port and the second CXL port.

A processor may operate within a heterogeneous memory system in which the processor reaches a CXL memory device over CXL.mem and shares memory coherently with an accelerator over CXL.cache. The CXL memory device may be a Type 3 device that exposes host-managed device memory to the processor for load and store access, and the accelerator may be a Type 1 or Type 2 device that coherently caches data of memory shared with the processor, optionally using a bias mechanism that designates a region as host-biased or device-biased. Access to a memory region may arrive over CXL.mem, over CXL.cache, or over both. A memory traffic analyzer receives telemetry of the traffic associated with the first CXL port and telemetry of the traffic associated with the second CXL port and produces a combined memory-access tracking output that represents, for memory regions, an access intensity attributed to each sub-protocol's traffic. The combined memory-access tracking output may inform mapping of memory regions among memory of differing latency or bandwidth, and may be implemented in any of the forms described below.

In various implementations, a processor comprising: processing cores coupled via a coherent interconnect, the processing cores configured to utilize physical addresses to access memory; a first Compute Express Link (CXL) port coupled to the coherent interconnect and configured to communicate, according to CXL.mem, with a first external entity comprising a CXL memory device exposing memory to the processor; a second CXL port coupled to the coherent interconnect and configured to communicate, according to CXL.cache, with a second external entity comprising an accelerator configured to share memory with the processor; a memory traffic analyzer configured to receive telemetry of CXL.mem traffic associated with the first CXL port and to receive telemetry of CXL.cache traffic associated with the second CXL port; the memory traffic analyzer is further configured to produce a combined memory-access tracking output based on the telemetry of the CXL.mem traffic and the telemetry of the CXL.cache traffic; and wherein the combined memory-access tracking output represents, for memory regions, an access intensity attributed to the CXL.mem traffic and an access intensity attributed to the CXL.cache traffic. The processor may be implemented as a server CPU, as a system-on-chip, as a chiplet-based processor having one or more compute chiplets and one or more input/output chiplets, or as a multi-die processor package. The processing cores may be coupled via the coherent interconnect, which may include a ring, a mesh, or a crossbar carrying coherence transactions among the processing cores, the first CXL port, and the second CXL port. The memory traffic analyzer may be implemented as a hardwired circuit, as a finite state machine, as an embedded controller executing firmware, or as a combination of a circuit and firmware, and may be located as an agent of the coherent interconnect, within an integrated memory controller, or adjacent to the first CXL port and the second CXL port. The telemetry of the CXL.mem traffic and the telemetry of the CXL.cache traffic may include raw transactions observed on the coherent interconnect, counts or digests produced by port logic or by an upstream entity, or sampled records of transactions, such that the telemetry may be received in raw or partially processed form.

Producing the combined memory-access tracking output may be performed by the memory traffic analyzer, for example by: (1) receiving a unit of telemetry and determining whether the unit is associated with the CXL.mem traffic or the CXL.cache traffic; (2) determining, from an address associated with the unit, a memory region of the memory regions to which the unit pertains; (3) updating, for the memory region, the access intensity attributed to the CXL.mem traffic when the unit is associated with the CXL.mem traffic, or the access intensity attributed to the CXL.cache traffic when the unit is associated with the CXL.cache traffic; and (4) exposing, for the memory regions, the access intensity attributed to the CXL.mem traffic and the access intensity attributed to the CXL.cache traffic as the combined memory-access tracking output. The memory traffic analyzer may maintain, for a memory region, the access intensity attributed to the CXL.mem traffic separately from the access intensity attributed to the CXL.cache traffic, independently of the number of memory regions and independently of the relative volumes of the CXL.mem traffic and the CXL.cache traffic, so that the same operation may apply across any number of memory regions and across any mix of the CXL.mem traffic and the CXL.cache traffic. At a low end, a memory region may receive the CXL.mem traffic and receive little or no CXL.cache traffic, and the access intensity attributed to the CXL.cache traffic for the memory region may remain near an initial value. At a high end, many memory regions may concurrently receive both the CXL.mem traffic and the CXL.cache traffic, and the memory traffic analyzer may maintain a separate pair of attributed access intensities for a memory region of the many memory regions. In a processor that expands memory over CXL.mem and that shares memory coherently over CXL.cache, access to a memory region may arrive over either sub-protocol, and access information observed separately for each sub-protocol may be difficult to reconcile into a single per-region view, which may impair memory-mapping decisions. Because the memory traffic analyzer represents, for the memory regions, the access intensity attributed to the CXL.mem traffic and the access intensity attributed to the CXL.cache traffic within the combined memory-access tracking output, the processor may make memory- mapping decisions informed by access arriving over both sub-protocols.

In some implementations of the processor, the processor is configured to select, based on the access intensity attributed to the CXL.mem traffic and the access intensity attributed to the CXL.cache traffic, mapping of memory regions among the memory of the processor and the memory exposed by the first external entity; wherein, of the memory of the processor and the memory exposed by the first external entity, one is a lower-latency memory and the other is a higher-latency memory; and wherein the processor is configured to place a memory region of higher access intensity in the lower-latency memory and to place a memory region of lower access intensity in the higher-latency memory. Mapping selection may be performed by a memory-management circuit of the processor that promotes a memory region of higher access intensity to the lower-latency memory and demotes a memory region of lower access intensity to the higher-latency memory. Mapping may instead be performed by firmware of the processor that periodically reads the combined memory-access tracking output. Because mapping follows the access intensity attributed to the CXL.mem traffic and the access intensity attributed to the CXL.cache traffic, average memory-access latency may be reduced.

In some implementations of the processor, the access intensity attributed to the CXL.mem traffic comprises an access count attributed to the CXL.mem traffic; wherein the access intensity attributed to the CXL.cache traffic comprises an access count attributed to the CXL.cache traffic; and wherein the combined memory-access tracking output further comprises, for memory regions, a temperature classification, indicative of an access frequency of a memory region, derived from the access count attributed to the CXL.mem traffic and the access count attributed to the CXL.cache traffic. The unified representation may be stored as a table indexed by memory region, in which a row holds the access count attributed to the CXL.mem traffic, the access count attributed to the CXL.cache traffic, and the temperature classification. The temperature classification may instead be a multi-level rank or a single bit indicating frequently-accessed or rarely-accessed. Because both access counts contribute to the temperature classification, a memory region accessed over both sub-protocols may be classified as frequently-accessed even when neither access count alone is high.

In some implementations of the processor, the memory traffic analyzer comprises a spatio-temporal analyzer; wherein the spatio-temporal analyzer is configured to maintain, for memory regions, a respective count of the CXL.mem traffic and a respective count of the CXL.cache traffic, and to apply, across successive epochs, a temporal decay function to the count of the CXL.mem traffic and the count of the CXL.cache traffic; and wherein the access intensity attributed to the CXL.mem traffic and the access intensity attributed to the CXL.cache traffic are based on the count of the CXL.mem traffic and the count of the CXL.cache traffic, respectively, as decayed by the temporal decay function. The spatio-temporal analyzer may include, for a memory region, a read counter and a write counter for the CXL.mem traffic and a read counter and a write counter for the CXL.cache traffic, with an epoch timer driving the temporal decay function. The temporal decay function may be an exponential decay, or may instead be a periodic right-shift of the counters at an epoch boundary. Because the decayed counts weight recent access more heavily, the access intensity attributed to each sub-protocol may track changing access patterns of a memory region.

In some implementations of the processor, the memory traffic analyzer is further configured to: parse, from the CXL.mem traffic, an address, an opcode selected from MemRd, MemWr, or MemInv, and a metadata field; identify, based on the parsed opcode, the CXL.mem traffic as memory-semantic accesses; and attribute, based on the parsed address, the memory-semantic accesses to memory regions to determine the access intensity attributed to the CXL.mem traffic. Parsing may be performed by a decoder of the memory traffic analyzer that extracts the address, the opcode, and the metadata field from the CXL.mem traffic. The decoder may instead consume a digest in which the address, the opcode, and the metadata field are pre-extracted by port logic. Because the opcode identifies memory-semantic accesses, the parsed address may be used to attribute the memory-semantic accesses to memory regions, forming the access intensity attributed to the CXL.mem traffic.

In some implementations of the processor, the memory traffic analyzer is further configured to: parse, from the CXL.cache traffic, an address, a request opcode selected from RdShared, RdOwn, or RdAny, and a coherence state indicator; identify, based on the parsed request opcode, the CXL.cache traffic as coherent accesses; and attribute, based on the parsed address, the coherent accesses to memory regions to determine the access intensity attributed to the CXL.cache traffic. Parsing may be performed by a decoder of the memory traffic analyzer that extracts the address, the request opcode, and the coherence state indicator from the CXL.cache traffic. The decoder may instead consume a digest in which the fields are pre-extracted. Because the request opcode and the coherence state indicator identify coherent accesses, the parsed address may be used to attribute the coherent accesses to memory regions, forming the access intensity attributed to the CXL.cache traffic.

In some implementations of the processor, the memory traffic analyzer is integrated in a same integrated circuit package as the processing cores; wherein the memory traffic analyzer is coupled to the coherent interconnect as an agent of the coherent interconnect; and wherein the memory traffic analyzer is further configured to obtain the telemetry of the CXL.mem traffic and the telemetry of the CXL.cache traffic via taps on respective agents of the coherent interconnect associated with the first CXL port and the second CXL port. The taps may be passive monitors on the agents of the coherent interconnect associated with the first CXL port and the second CXL port, copying transaction headers to the memory traffic analyzer without affecting transaction timing. The taps may instead be counters embedded in the agents. Because the memory traffic analyzer is coupled to the coherent interconnect as an agent, it may obtain telemetry of both the CXL.mem traffic and the CXL.cache traffic that an entity outside the integrated circuit package may not jointly observe.

In some implementations of the processor, the memory traffic analyzer is coupled to a memory controller of the processor; and wherein the memory controller is configured to forward, to the memory traffic analyzer, address information and consumer-identifier information derived from the CXL.mem traffic and from the CXL.cache traffic, the consumer-identifier information identifying consumers of memory regions. The memory controller may forward the address information and the consumer-identifier information over a sideband path to the memory traffic analyzer. The memory traffic analyzer may instead be integrated within the memory controller. Because the memory controller forwards consumer-identifier information identifying consumers of memory regions, the memory traffic analyzer may attribute access intensity to a memory region on a per-consumer basis.

In some implementations of the processor, the memory traffic analyzer is coupled to a memory management unit (MMU) of the processor; wherein the MMU is configured to provide, to the memory traffic analyzer, page-level physical address information for the CXL.mem traffic on the first CXL port and the CXL.cache traffic on the second CXL port; and wherein the memory traffic analyzer is further configured to attribute, based on the page-level physical address information, the CXL.mem traffic and the CXL.cache traffic to memory regions at a page granularity. The page-level physical address information may be provided by the memory management unit as page-table-walk results or as cached page-table entries. The memory management unit may instead provide page-descriptor identifiers to the memory traffic analyzer. Because the memory traffic analyzer receives page-level physical address information, it may attribute the CXL.mem traffic and the CXL.cache traffic to memory regions at a page granularity, aligning the combined memory-access tracking output with page-based memory management.

In some implementations of the processor, the first CXL port, the second CXL port, and the memory traffic analyzer are integrated in a same integrated circuit package as the processing cores; and wherein the telemetry of the CXL.mem traffic and the telemetry of the CXL.cache traffic are conveyed to the memory traffic analyzer on an on-package interconnect of the processor. The on-package interconnect may be a dedicated telemetry ring, or may be a portion of the coherent interconnect reserved for telemetry. The telemetry may instead be conveyed over a shared on-package network of the processor. Because the first CXL port, the second CXL port, and the memory traffic analyzer share the integrated circuit package and the telemetry is conveyed on the on-package interconnect, external bandwidth of the processor may be preserved for the CXL.mem traffic and the CXL.cache traffic.

In some implementations of the processor, the processor further comprises a third port coupled to the coherent interconnect and configured to communicate, according to NVLink, with a third external entity comprising a graphics processing unit (GPU); and wherein the memory traffic analyzer is further configured to receive telemetry of NVLink traffic associated with the third port and to incorporate the telemetry of the NVLink traffic into the combined memory-access tracking output. The third port may couple to a GPU over NVLink, and the telemetry of the NVLink traffic may be obtained by taps or by counters at the third port. The memory traffic analyzer may incorporate the telemetry of the NVLink traffic as a further per-region access intensity attributed to the NVLink traffic. Because the combined memory-access tracking output then reflects access arriving over CXL.mem, CXL.cache, and NVLink, mapping of a memory region may account for access arriving over all three.

In some implementations of the processor, the accelerator is one of a plurality of accelerators interconnected to each other via at least one of Ultra Accelerator Link (UALink) or Ethernet Scale-Up Networking (ESUN) and forming a scale-up cluster; wherein the plurality of accelerators are configured to coherently share memory with the processor; and wherein the memory traffic analyzer is further configured to differentiate, based on consumer identifiers carried by the CXL.cache traffic, an access intensity attributable to an individual accelerator of the plurality of accelerators within the combined memory-access tracking output. The plurality of accelerators may form a scale-up cluster interconnected by UALink or by ESUN, and a consumer identifier carried by the CXL.cache traffic may distinguish an individual accelerator. The differentiation may instead use a mapping table from consumer identifier to accelerator. Because an access intensity is attributable to an individual accelerator, the combined memory-access tracking output may support mapping of a memory region according to which accelerator of the cluster accesses the memory region.

In some implementations of the processor, the accelerator comprises at least one of: a graphics processing unit, a neural processing unit, a tensor processing unit, an artificial-intelligence accelerator, a digital signal processor, a machine-learning inference engine, or a field-programmable gate array; wherein the accelerator operates as a CXL Type 1 device or a CXL Type 2 device; and wherein the memory traffic analyzer is further configured to attribute, to memory regions coherently shared with the accelerator, the access intensity attributed to the CXL.cache traffic. The accelerator may be a GPU operating as a CXL Type 2 device, or a neural processing unit operating as a CXL Type 1 device. Other accelerators, such as a tensor processing unit or a field-programmable gate array, may be used. Because the accelerator coherently shares memory with the processor, the access intensity attributed to the CXL.cache traffic may be attributed to memory regions coherently shared with the accelerator.

In some implementations of the processor, the first external entity is a CXL Type 3 device exposing, to the processor over CXL.mem, memory comprising at least one of: dynamic random-access memory, high-bandwidth memory, storage-class memory, or non-volatile memory; and wherein the memory traffic analyzer is further configured to attribute, to memory regions exposed by the first external entity, the access intensity attributed to the CXL.mem traffic. The first external entity may be a CXL Type 3 device populated with DRAM, with high-bandwidth memory for higher throughput, or with storage-class memory or non-volatile memory for larger capacity. Because the first external entity exposes the memory over CXL.mem, the access intensity attributed to the CXL.mem traffic may be attributed to memory regions exposed by the first external entity, distinguishing access to expansion memory from access shared with the accelerator.

The technique described above may be embodied in a system that includes the processor, the first external entity, and the second external entity, together with the memory traffic analyzer. The memory traffic analyzer may reside in the processor, in a switch on a path to the first external entity, or partly in the first external entity, with partial tracking data produced away from the processor and combined at the processor.

In various implementations, a system comprising: a processor comprising processing cores coupled via a coherent interconnect, the processing cores configured to utilize physical addresses to access memory; a first external entity comprising a Compute Express Link (CXL) memory device exposing memory to the processor; a second external entity comprising an accelerator configured to share memory with the processor; the processor further comprising a first CXL port coupled to the coherent interconnect and configured to communicate, according to CXL.mem, with the first external entity, and a second CXL port coupled to the coherent interconnect and configured to communicate, according to CXL.cache, with the second external entity; a memory traffic analyzer configured to: receive telemetry of CXL.mem traffic associated with the first CXL port, receive telemetry of CXL.cache traffic associated with the second CXL port, and produce a combined memory-access tracking output based on the telemetry of the CXL.mem traffic and the telemetry of the CXL.cache traffic; and wherein the combined memory-access tracking output represents, for memory regions, an access intensity attributed to the CXL.mem traffic and an access intensity attributed to the CXL.cache traffic. The system may be a server, a rack-scale appliance, or a disaggregated-memory platform in which the first external entity and the second external entity are separate devices coupled to the processor. The first external entity may be a memory-expansion module, and the second external entity may be an accelerator card. The memory traffic analyzer may reside in the processor, may reside in a switch coupled on a path to the first external entity, or may be distributed between the processor and the first external entity. Producing the combined memory-access tracking output may be performed, for example, by: (1) obtaining telemetry of the CXL.mem traffic and telemetry of the CXL.cache traffic; (2) attributing each unit of telemetry to a memory region and to the CXL.mem traffic or the CXL.cache traffic; and (3) maintaining, for the memory region, the access intensity attributed to the CXL.mem traffic and the access intensity attributed to the CXL.cache traffic. The combination operation may be performed at the processor independently of where the telemetry is first observed, so that the same combined memory-access tracking output may be produced whether the memory traffic analyzer resides in the processor, in the switch, or partly in the first external entity. Because the memory traffic analyzer produces, for the memory regions, the access intensity attributed to the CXL.mem traffic and the access intensity attributed to the CXL.cache traffic, the system may place a memory region in a memory of the system selected according to access arriving over both sub-protocols.

In some implementations of the system, a switch coupled on a path between the first CXL port of the processor and the first external entity comprises a portion of the memory traffic analyzer; wherein the portion of the memory traffic analyzer is configured to produce, from the telemetry of the CXL.mem traffic, partial tracking data and to forward the partial tracking data to the processor; and wherein the processor is configured to produce the combined memory-access tracking output by combining the partial tracking data with tracking data derived from the telemetry of the CXL.cache traffic. The switch may include a circuit that produces the partial tracking data from the telemetry of the CXL.mem traffic and forwards the partial tracking data to the processor over a management channel. The processor may include a circuit that merges the partial tracking data with tracking data derived from the telemetry of the CXL.cache traffic. Because tracking of the CXL.mem traffic may be offloaded to the switch, processing load on the processor may be reduced while the combined memory-access tracking output is still produced at the processor.

In some implementations of the system, the first external entity is a Dynamic Capacity Device (DCD) exposing the memory to the processor over CXL.mem as one or more dynamically-configured extents; wherein the first external entity comprises a portion of the memory traffic analyzer configured to produce, from the telemetry of the CXL.mem traffic, partial tracking data on a per-extent basis and to forward the partial tracking data to the processor over CXL.mem; and wherein the processor is configured to produce the combined memory-access tracking output by combining the partial tracking data with tracking data derived from the telemetry of the CXL.cache traffic. The first external entity may be a DCD that maintains per-extent partial tracking data and forwards the per-extent partial tracking data to the processor over CXL.mem. The processor may merge the per-extent partial tracking data with tracking data derived from the telemetry of the CXL.cache traffic. Because partial tracking is maintained per extent at the first external entity, the combined memory-access tracking output may align with dynamic capacity allocation as extents are added or removed.

In various implementations, a method comprising: receiving, by a processor comprising processing cores coupled via a coherent interconnect, telemetry of CXL.mem traffic associated with a first Compute Express Link (CXL) port of the processor, the first CXL port configured to communicate, according to CXL.mem, with a first external entity comprising a CXL memory device exposing memory to the processor; receiving, by the processor, telemetry of CXL.cache traffic associated with a second CXL port of the processor, the second CXL port configured to communicate, according to CXL.cache, with a second external entity comprising an accelerator sharing memory with the processor; and producing, by a memory traffic analyzer of the processor and based on the telemetry of the CXL.mem traffic and the telemetry of the CXL.cache traffic, a combined memory-access tracking output that represents, for memory regions, an access intensity attributed to the CXL.mem traffic and an access intensity attributed to the CXL.cache traffic. The method may be performed by a processor that includes a memory storing instructions that, when executed by the processor, cause the processor to perform the receiving of the telemetry of the CXL.mem traffic, the receiving of the telemetry of the CXL.cache traffic, and the producing of the combined memory-access tracking output; the method may instead be performed by a hardwired circuit or a finite state machine of the processor. Producing the combined memory-access tracking output may include, for example: (1) obtaining a unit of telemetry and determining whether the unit is associated with the CXL.mem traffic or the CXL.cache traffic; (2) determining, from an address associated with the unit, a memory region to which the unit pertains; and (3) updating, for the memory region, the access intensity attributed to the CXL.mem traffic or the access intensity attributed to the CXL.cache traffic. The updating may be performed per memory region independently of the number of memory regions and the relative volumes of the CXL.mem traffic and the CXL.cache traffic, so that the method may apply across any number of memory regions and any mix of the two. In a processor that expands memory over CXL.mem and shares memory coherently over CXL.cache, access to a memory region may arrive over either sub-protocol, and access information observed separately for each sub-protocol may be difficult to reconcile into a single per-region view. Because the producing represents, for the memory regions, the access intensity attributed to the CXL.mem traffic and the access intensity attributed to the CXL.cache traffic, the processor may inform memory-mapping decisions using access arriving over both sub-protocols.

In some implementations, the method further comprises selecting, based on the access intensity attributed to the CXL.mem traffic and the access intensity attributed to the CXL.cache traffic, mapping of memory regions among the memory of the processor and the memory exposed by the first external entity; and migrating a memory region between the memory of the processor and the memory exposed by the first external entity in response to a change in the access intensity attributed to the CXL.mem traffic, the access intensity attributed to the CXL.cache traffic, or a combination thereof. Selecting mapping may be performed by firmware of the processor, and migrating a memory region may include copying the memory region between the memory of the processor and the memory exposed by the first external entity and updating a page mapping. Migration may instead be performed on a next access to the memory region. Because migration responds to a change in the access intensity attributed to the CXL.mem traffic and the access intensity attributed to the CXL.cache traffic, mapping of the memory region may adapt to an evolving access pattern.

In some implementations of the method, producing the combined memory-access tracking output comprises: parsing, from the CXL.mem traffic, a memory-access opcode and an address, and parsing, from the CXL.cache traffic, a coherent-access opcode and an address; attributing accesses to the CXL.mem traffic and to the CXL.cache traffic based on the parsed memory-access opcode and the parsed coherent-access opcode; and accumulating, for memory regions, a count attributed to the CXL.mem traffic and a count attributed to the CXL.cache traffic, the access intensity attributed to the CXL.mem traffic and the access intensity attributed to the CXL.cache traffic being based on the respective counts. Parsing may be performed by a decoder, attributing may use the parsed memory-access opcode and the parsed coherent-access opcode to assign an access to the CXL.mem traffic or the CXL.cache traffic, and accumulating may increment a per-region count attributed to the CXL.mem traffic or a per-region count attributed to the CXL.cache traffic. Accumulating may instead use saturating counters that stop at a maximum value. Because separate per-region counts are accumulated, the access intensity attributed to each sub-protocol may be derived from a respective count of the memory region.

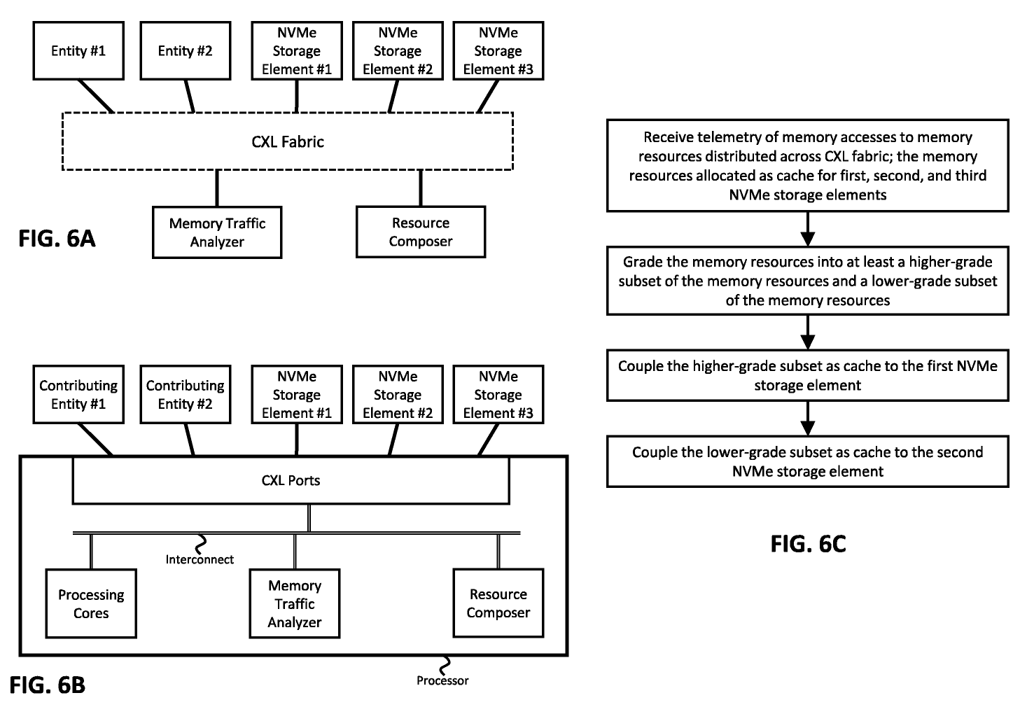

FIG. 6A illustrates an example of a system comprising NVMe storage elements that include at least a first NVMe storage element, a second NVMe storage element, and a third NVMe storage element, each coupled to a CXL fabric. Memory resources may be distributed across the CXL fabric and may be contributed via the CXL fabric by a first entity coupled via a first CXL link and by a second entity coupled via a second CXL link, the memory resources being configured to be allocated as cache for the NVMe storage elements. A memory traffic analyzer may receive telemetry of memory accesses to the memory resources and may grade the memory resources, based on the telemetry, into a higher-grade subset and a lower-grade subset. A resource composer coupled to the memory traffic analyzer may receive grade labels from the memory traffic analyzer and may issue coupling commands that couple the higher-grade subset as cache to the first NVMe storage element and the lower-grade subset as cache to the second NVMe storage element. The first NVMe storage element and the second NVMe storage element may access the higher-grade subset and the lower-grade subset, respectively, as cache via CXL.mem load and store operations, for example through a Controller Memory Buffer or HDM exposed to the NVMe storage element, while the memory resources remain resident on the CXL fabric. The first entity and the second entity may each include a host contributing DRAM, a CXL memory expander, a memory pool device, or an accelerator contributing memory, and may continue to carry out a function independent of providing cache while contributing the memory resources. The third NVMe storage element may receive a graded subset of the memory resources as cache when the resource composer maps one, so that the differentiated coupling may extend across three or more NVMe storage elements drawn from the same heterogeneous cache substrate.

A system may serve performance-differentiated NVMe storage elements, for example a first NVMe storage element associated with a latency-sensitive workload and a second NVMe storage element associated with a throughput-oriented workload, from a single cache substrate drawn from memory resources distributed across a CXL fabric. The memory resources may be contributed by entities of heterogeneous types and at different points in the CXL fabric, so the memory resources may exhibit a range of measured properties such as latency, bandwidth, jitter, tail latency, and error rate. A memory traffic analyzer may receive telemetry of memory accesses to the memory resources and grade the memory resources based on the telemetry, and a resource composer may differentially couple graded subsets of the memory resources as cache to different NVMe storage elements. The result may be that higher-grade memory resources serve NVMe storage elements with higher performance needs while lower-grade memory resources serve NVMe storage elements with lower performance needs, without requiring uniform on-device DRAM at each NVMe storage element.

In various implementations, a system comprising: Non-Volatile Memory Express (NVMe) storage elements comprising at least a first NVMe storage element, a second NVMe storage element, and a third NVMe storage element; memory resources distributed across a Compute Express Link (CXL) fabric, the memory resources contributed via the CXL fabric by entities comprising at least a first entity coupled to the CXL fabric via a first CXL link and a second entity coupled to the CXL fabric via a second CXL link, the memory resources configured to be allocated as cache for the NVMe storage elements; a memory traffic analyzer configured to receive telemetry of memory accesses to the memory resources, and to grade the memory resources, based at least in part on the telemetry, into at least a higher-grade subset of the memory resources and a lower-grade subset of the memory resources; and a resource composer coupled to the memory traffic analyzer and configured to couple the higher-grade subset as cache to the first NVMe storage element, and to couple the lower-grade subset as cache to the second NVMe storage element. The system may be a server, a multi-host chassis, a disaggregated rack, or a composable infrastructure deployment. The NVMe storage elements may comprise physical NVMe SSDs, NVMe namespaces presented by a physical SSD, NVMe Sets, NVMe Endurance Groups, logical block address (LBA) ranges within an NVMe namespace, Zoned Namespace zones, Flexible Data Placement Reclaim Units, or other logical or physical NVMe-defined storage constructs. The first entity and the second entity may comprise hosts contributing DRAM, CXL memory expanders, memory pool devices reachable via at least one CXL switch, accelerators contributing on-package DRAM, or other CXL-coupled entities that contribute memory resources via their respective CXL links. The memory resources may comprise DRAM regions, persistent memory regions, or a combination of memory regions of two or more memory technologies. The memory traffic analyzer may be implemented as a controller comprising a finite state machine, a register file storing per-resource access counts and latency samples, and instructions stored in a memory and executed by a processor of the controller. The memory traffic analyzer may be configured to perform the grading by an algorithm comprising: (1) receiving the telemetry of memory accesses, the telemetry comprising per-resource access counts and per-resource access latency samples; (2) deriving, for each of the memory resources, a measured property of the memory resource from the telemetry, the measured property comprising a derived metric such as a mean access latency, a mean access bandwidth, a jitter of access latency, a tail latency at a configurable percentile, or a measured error indicator; (3) applying a grading rule that assigns to each of the memory resources a grade label, the grading rule comprising one or more of a threshold-based assignment, a peer-ranking assignment, or a clustering assignment; and (4) outputting the per-resource grade labels as inputs to the resource composer.

The resource composer may be implemented as a controller comprising a finite state machine and instructions executed by a processor, and may be configured to perform the differentiated coupling by an algorithm comprising: (a) receiving the per-resource grade labels from the memory traffic analyzer; (b) partitioning the memory resources into the higher-grade subset and the lower-grade subset; (c) selecting, based on a mapping policy, which of the NVMe storage elements receives the higher-grade subset as cache and which of the NVMe storage elements receives the lower-grade subset as cache, the mapping policy comprising one or more of a static configuration, a service-class indicator associated with the NVMe storage element, a workload signal received from an external orchestrator, or a learned mapping; and (d) issuing coupling commands that map the selected subset as cache to the selected NVMe storage element. The memory traffic analyzer may operate on a per-resource basis on the received telemetry. The resource composer may issue per-NVMe-storage-element coupling commands derived from the per-resource grade labels, so that the differentiated coupling may apply at essentially any number of NVMe storage elements. At a low-end corner, the system may comprise three NVMe storage elements and two contributing entities. At a high-end corner, the system may comprise tens to hundreds of NVMe storage elements and tens to hundreds of contributing entities, with the memory traffic analyzer aggregating telemetry across the contributing entities and the resource composer issuing coupling commands across the NVMe storage elements. When the cache substrate for multiple NVMe storage elements is drawn from CXL-fabric memory resources of heterogeneous measured performance, uniform allocation of the cache substrate to the NVMe storage elements may waste the heterogeneity and may fail to match the performance needs of differentiated NVMe storage elements. Because the memory traffic analyzer grades the memory resources based on the telemetry, and because the resource composer differentially couples graded subsets as cache to different NVMe storage elements, the heterogeneous cache substrate may be allocated to the NVMe storage elements in proportion to the measured grades, and the performance differentiation among the NVMe storage elements may be supported by corresponding grade differentiation in the cache substrate.

In some implementations of the system, the memory traffic analyzer comprises a spatio-temporal (ST) analyzer; wherein the telemetry of memory accesses is collected from memory access requests targeting the memory resources during operation of the system, and is updated based on subsequent memory access requests targeting the memory resources; and wherein the memory traffic analyzer is further configured to grade the memory resources by at least one of measured latency or measured bandwidth determined from the telemetry, the measured latency or the measured bandwidth being a property of the memory resources observed during the memory accesses. The spatio-temporal analyzer may collect timestamped access samples and maintain per-resource histograms in a register file, with histogram bins updated on receipt of each access record. The spatio-temporal analyzer may instead maintain exponentially-weighted moving averages of latency and bandwidth per resource, updated on a sample basis. The collected telemetry may be combined with the grade-label outputs and supplied to the resource composer such that the higher-grade subset is composed of memory resources whose measured latency or measured bandwidth meets a higher threshold. Because the grading reflects measured properties of the memory resources observed during memory accesses, the grading may track changes in measured performance over operation of the system.

In some implementations of the system, the first entity has a first main function and the second entity has a second main function, the first main function and the second main function each being at least one of: compute, artificial intelligence acceleration, network processing, graphics processing, database execution, or storage-of-data backing for an NVMe storage element of the NVMe storage elements; and wherein the first entity comprises at least one of: a host comprising dynamic random-access memory (DRAM) that contributes a first portion of the memory resources, a CXL memory expander comprising DRAM that contributes a second portion of the memory resources, or a memory pool device reachable via at least one CXL switch and comprising DRAM that contributes a third portion of the memory resources. The first entity may be a compute host whose DRAM is partially underutilized at a given time, and the second entity may be a graphics processing accelerator whose on-package DRAM is partially underutilized at a given time. The contributing entities may instead comprise an artificial intelligence training accelerator and a network processing device. The main function of each entity may be carried out by the entity in parallel with the contribution of the memory resources, such that the entity continues to perform its main function while contributing its memory resources via its CXL link. Because the main functions are independent of providing cache for the NVMe storage elements, the system may aggregate underutilized memory from heterogeneous entities rather than relying on dedicated cache hardware.

In some implementations of the system, the first NVMe storage element comprises at least one of: a first NVMe namespace, a first NVMe Set, a first NVMe Endurance Group, a first logical block address (LBA) range within an NVMe namespace, or a first Zoned Namespace zone; wherein the second NVMe storage element comprises at least one of: a second NVMe namespace, a second NVMe Set, a second NVMe Endurance Group, a second LBA range within an NVMe namespace, or a second Zoned Namespace zone; and wherein the memory traffic analyzer is further configured to grade the memory resources in coordination with at least one of: a flash translation layer (FTL) state of the first NVMe storage element or the second NVMe storage element, a Predictable Latency Mode (PLM) state of the first NVMe storage element or the second NVMe storage element, or a Flexible Data Placement (FDP) state of the first NVMe storage element or the second NVMe storage element. The first NVMe namespace and the second NVMe namespace may be presented by a single physical NVMe SSD, by separate physical NVMe SSDs, or by a combination thereof. The FTL state may comprise garbage-collection pressure indicators or write-amplification indicators reported by the NVMe storage element; the PLM state may comprise the deterministic or non-deterministic window in which the NVMe storage element is operating; and the FDP state may comprise placement-handle telemetry. The memory traffic analyzer may receive the FTL, PLM, or FDP indicators and weight the grading such that the higher-grade subset is preferentially coupled to an NVMe storage element whose state indicates need for low-latency cache. Because the grading is coordinated with NVMe-element-internal state, the differentiated coupling may compensate for measured behavior of each NVMe storage element.

In some implementations of the system, the memory traffic analyzer is further configured to grade the memory resources, based at least in part on the telemetry, by at least one of: a measured jitter of memory access latency to the memory resources, a measured tail latency of memory accesses to the memory resources, a measured bandwidth utilization of the memory resources relative to a nominal bandwidth of the memory resources, a measured error rate or reliability indicator of the memory resources, or a composite grade derived from a combination of two or more of measured latency, measured bandwidth, measured jitter, measured tail latency, measured bandwidth utilization, or measured error rate. The measured jitter may be derived as a standard deviation or interquartile range of access latency samples. The measured tail latency may be derived as a configurable percentile of the access latency distribution, for example a percentile selected from the upper tail. The composite grade may be derived as a weighted sum of normalized scores for each contributing dimension. The composite grade may instead be derived as a multi-attribute decision using a learned classifier. Because the grading may reflect dimensions beyond mean latency, the higher-grade subset may include memory resources well-suited to tail-latency-bounded or error-sensitive NVMe storage elements.

In some implementations of the system, the telemetry of memory accesses comprises telemetry from at least one of: a CXL Performance Monitoring Unit (CPMU) of an entity contributing at least a portion of the memory resources, a CXL Hotness Monitoring Unit (CHMU) of an entity contributing at least a portion of the memory resources, a memory controller counter of an entity contributing at least a portion of the memory resources, a switch port counter of a switch coupling at least one of the entities to the CXL fabric, or a counter of an NVMe storage element of the NVMe storage elements; and wherein the memory traffic analyzer is further configured to aggregate telemetry from at least two of the foregoing sources to assemble, for at least a portion of the memory resources, a per-resource access profile reflecting access patterns to the portion of the memory resources over a time window, the per-resource access profile being used as input to the grading. The per-resource access profile may comprise a histogram of access latencies, a count of accesses per unit time, a hotlist of accessed addresses within the resource, or a combination of such measures. The time window may be a sliding window updated as new telemetry arrives, or a tumbling window reset at a configurable cadence. The memory traffic analyzer may combine CPMU and CHMU telemetry such that CPMU provides access counts while CHMU provides hot-region identification. Because the grading consumes a multi-source per-resource access profile, the grading may be robust to gaps or limitations in any single telemetry source.

In some implementations of the system, the resource composer is further configured to maintain the higher-grade subset coupled as cache to the first NVMe storage element concurrently with the lower-grade subset coupled as cache to the second NVMe storage element; and wherein the higher-grade subset and the lower-grade subset are configured to serve memory accesses for the first NVMe storage element and the second NVMe storage element, respectively, while concurrently coupled. The concurrent coupling may be maintained such that both the higher-grade subset and the lower-grade subset accept and serve cache traffic from their respective NVMe storage elements during overlapping intervals of operation. The concurrent coupling may instead be maintained such that the higher-grade subset and the lower-grade subset each maintain independent state including independent cache directories and independent eviction policies. The grading from the memory traffic analyzer may be combined with the concurrent coupling such that the higher-grade subset and the lower-grade subset are coupled in parallel rather than serialized. Because the coupling is concurrent, the cache benefits of both subsets may accrue to their respective NVMe storage elements during the same operational interval.

In some implementations of the system, the memory traffic analyzer is further configured to repeatedly re-grade the memory resources, based at least in part on the telemetry, on at least one of an expiration of a re-grading interval or a determination that a measured characteristic of at least a portion of the memory resources has drifted beyond a threshold relative to a previously-graded characteristic of the portion of the memory resources; and wherein, responsive to the re-grading producing a changed grading of at least a portion of the memory resources, the resource composer is further configured to re-couple the portion of the memory resources as cache from one of the NVMe storage elements to a different one of the NVMe storage elements. The re-grading interval may be a fixed cadence or a cadence that adapts to measured rate of change in the telemetry. The drift threshold may be expressed as a percentage change in a measured property, as an absolute change in latency or bandwidth, or as a statistical-distance metric between successive access profiles. The re-coupling of a portion of the memory resources may comprise an atomic handover at a quiesce point of the source NVMe storage element, or a continuous transfer during which cache state is gradually migrated. The grading inputs may be combined with the re-coupling such that a memory resource whose grade has degraded is rebound to a lower-priority NVMe storage element while a memory resource whose grade has improved is rebound to a higher-priority NVMe storage element. Because the system may remap memory resources on grade drift, the system may track measured changes in CXL-fabric memory performance during operation.

In some implementations of the system, the resource composer is further configured to expose at least one of the higher-grade subset or the lower-grade subset of the memory resources to a corresponding NVMe storage element via at least one of: a Controller Memory Buffer (CMB) of the corresponding NVMe storage element, or Host-Managed Device Memory (HDM) of the corresponding NVMe storage element accessible via CXL.mem load and store operations; wherein the resource composer is further configured to associate the first NVMe storage element with a first class of service and the second NVMe storage element with a second class of service different from the first class of service, the first class of service comprising at least one of a latency-sensitive class or a tail-latency-bounded class, and the second class of service comprising at least one of a throughput-oriented class or a capacity-oriented class; and wherein the resource composer is located at one of an NVMe storage element of the NVMe storage elements, a memory pool device coupled to the CXL fabric, a switch coupling at least one of the entities to the CXL fabric, a fabric manager managing the CXL fabric, or a host coupled to the CXL fabric. The CMB-based exposure may comprise mapping the higher-grade subset into a CMB region of the corresponding NVMe storage element so that the NVMe storage element may stage data in the higher-grade subset prior to programming the underlying media. The HDM-based exposure may instead comprise advertising the higher-grade subset as a CXL.mem range that the NVMe storage element accesses with load and store operations. When the resource composer is located at a switch, the resource composer may issue coupling commands through ports of the switch and may collect telemetry from port counters of the switch. When the resource composer is located at a fabric manager, the resource composer may invoke a CXL Fabric Manager API to map memory resources to NVMe storage elements. The class-of-service associations may be combined with the multi-entity contributions such that latency-sensitive classes are preferentially mapped to memory resources closer to the consuming NVMe storage element. Because the resource composer may reside at multiple placements within the system, the differentiated coupling may be deployed across in-NVMe, switch-resident, fabric-manager, host-resident, or memory-pool-resident architectures.

In some implementations of the system, at least one of the first entity or the second entity comprises a host comprising DRAM underutilized by the host at a given time during operation of the system, the DRAM underutilized by the host contributing at least a portion of the memory resources; wherein the first NVMe storage element comprises a first controller and first NAND flash media managed by the first controller; wherein the second NVMe storage element comprises a second controller and second NAND flash media managed by the second controller; and wherein the higher-grade subset serves as cache for the first controller and the lower-grade subset serves as cache for the second controller. The DRAM underutilized by the host may comprise DRAM regions not actively allocated to a workload of the host at a given time, with the host registering the DRAM regions to a CXL fabric manager that exposes them to the system. The contributing host may instead comprise an accelerator host whose on-package DRAM has spare capacity. The controller of each NVMe storage element may treat the coupled subset as an extended cache, staging data prior to writing to or after reading from the NAND flash media. Because the cache substrate for the controllers is drawn from underutilized DRAM across hosts rather than from on-device DRAM at each NVMe storage element, the system may operate the NVMe storage elements with reduced on-device DRAM.

In some implementations of the system, the system further comprises accelerators forming a scale-up cluster, the accelerators interconnected to each other via NVLink; and wherein at least one of (a) at least one accelerator of the accelerators is one of the entities contributing at least a portion of the memory resources via the CXL fabric, or (b) at least one accelerator of the accelerators is configured to access at least one of the NVMe storage elements, such that memory accesses on behalf of the at least one accelerator are reflected in the telemetry received by the memory traffic analyzer. The scale-up cluster may comprise artificial intelligence training accelerators interconnected via NVLink and operating on shared model state, with at least one of the accelerators contributing on-package DRAM as a portion of the memory resources via its CXL link. The scale-up cluster may instead comprise inference accelerators that read input batches from the NVMe storage elements. The memory traffic analyzer may consume telemetry reflecting accelerator-originated accesses such that the higher-grade subset is allocated to an NVMe storage element receiving high accelerator-originated load. Because the system may coordinate cache differentiation with scale-up cluster traffic, the cache substrate may track accelerator-driven access patterns.

In some implementations of the system, the system further comprises accelerators forming a scale-up cluster, the accelerators interconnected to each other via UALink; and wherein at least one of (a) at least one accelerator of the accelerators is one of the entities contributing at least a portion of the memory resources via the CXL fabric, or (b) at least one accelerator of the accelerators is configured to access at least one of the NVMe storage elements such that memory accesses on behalf of the at least one accelerator are reflected in the telemetry received by the memory traffic analyzer. The UALink scale-up cluster may comprise UALink-interconnected accelerators from a mix of accelerator vendors, with at least one accelerator contributing memory resources via a CXL link to a UALink-coupled switch. The cluster may instead comprise UALink-interconnected accelerators consuming the NVMe storage elements as a shared input store. The grading may be combined with cluster-source telemetry such that the higher-grade subset is allocated to an NVMe storage element whose UALink-originated access load justifies higher-grade cache. Because UALink scale-up traffic may be reflected in the telemetry, the differentiated coupling may track UALink-cluster behavior.

In some implementations of the system, the system further comprises accelerators forming a scale-up cluster, the accelerators interconnected to each other via Ethernet Scale-Up Networking (ESUN); and wherein at least one of (a) at least one accelerator of the accelerators is one of the entities contributing at least a portion of the memory resources via the CXL fabric, or (b) at least one accelerator of the accelerators is configured to access at least one of the NVMe storage elements such that memory accesses on behalf of the at least one accelerator are reflected in the telemetry received by the memory traffic analyzer. The ESUN scale-up cluster may comprise accelerators interconnected over Ethernet links carrying scale-up protocol semantics, with at least one accelerator contributing memory resources via a CXL link. The cluster may instead comprise accelerators consuming the NVMe storage elements over the ESUN fabric. The grading may be combined with ESUN-cluster telemetry such that the higher-grade subset is allocated to an NVMe storage element whose ESUN-originated access load justifies higher-grade cache. Because Ethernet-based scale-up traffic may be reflected in the telemetry, the differentiated coupling may track ESUN-cluster behavior.

FIG. 6B illustrates an example system comprising NVMe storage elements that include at least a first NVMe storage element, a second NVMe storage element, and a third NVMe storage element, a first contributing entity coupled via a first CXL link, and a second contributing entity coupled via a second CXL link. The first contributing entity and the second contributing entity contributing memory resources are to be allocated as cache for the NVMe storage elements. The processor may include processing cores, CXL ports configured to communicate, according to a protocol based on CXL, with the NVMe storage elements, the first contributing entity, and the second contributing entity, a memory traffic analyzer, and a resource composer coupled to the memory traffic analyzer. The memory traffic analyzer may receive telemetry of memory accesses to the memory resources, conveyed to the memory traffic analyzer through the CXL ports, and may grade the memory resources, based on the telemetry, into a higher-grade subset and a lower-grade subset. The resource composer may receive grade labels from the memory traffic analyzer and may issue coupling commands through the CXL ports that couple the higher-grade subset as cache to the first NVMe storage element and the lower-grade subset as cache to the second NVMe storage element. The CXL ports may include a first CXL port, a second CXL port, through an Nth CXL port, so that the processor may couple to three or more NVMe storage elements and two or more contributing entities.

In various implementations, a system comprising: Non-Volatile Memory Express (NVMe) storage elements comprising at least a first NVMe storage element, a second NVMe storage element, and a third NVMe storage element; contributing entities comprising at least a first contributing entity coupled via a first Compute Express Link (CXL) link to a processor, and a second contributing entity coupled via a second CXL link to the processor, the contributing entities are configured to contribute memory resources to be allocated as cache for the NVMe storage elements; and wherein the processor comprises: processing cores; CXL ports configured to communicate, according to a protocol based on CXL, with the NVMe storage elements, the first contributing entity, and the second contributing entity; a memory traffic analyzer configured to receive telemetry of memory accesses to the memory resources, and to grade the memory resources, based at least in part on the telemetry, into at least a higher-grade subset of the memory resources and a lower-grade subset of the memory resources; and a resource composer coupled to the memory traffic analyzer and configured to couple the higher-grade subset as cache to the first NVMe storage element through the CXL ports, and to couple the lower-grade subset as cache to the second NVMe storage element through the CXL ports. The processor may be a server-class CPU, a SoC, an AI accelerator, a GPU, a data processing unit, or a composable-infrastructure processor. The processor may be implemented as a monolithic integrated circuit, as a multi-die package comprising a compute die and an input-output die interconnected by an on-package interconnect, or as a chiplet-based product with one or more compute chiplets and one or more input-output chiplets. The memory traffic analyzer may be implemented as a controller integrated within the processor, the controller comprising a finite state machine, a register file storing per-resource counters, and instructions executed by an embedded processor of the controller. The resource composer may be implemented as a controller integrated within the processor, the controller comprising a finite state machine and instructions executed by an embedded processor. The CXL ports may be implemented as physical-layer and link-layer logic integrated within the processor, configured to terminate CXL links from external entities.

The memory traffic analyzer integrated within the processor may be configured to perform the grading by an algorithm comprising: (1) receiving the telemetry of memory accesses from one or more of the CXL ports, from a coherent interconnect of the processor, from a memory management unit of the processor, or from a memory controller of the processor; (2) deriving, for each of the memory resources, a measured property of the memory resource from the telemetry; (3) applying a grading rule that assigns to each of the memory resources a grade label; and (4) outputting the per-resource grade labels to the resource composer integrated within the processor. The resource composer integrated within the processor may be configured to perform the differentiated coupling by an algorithm comprising: (a) receiving the per-resource grade labels from the memory traffic analyzer; (b) partitioning the memory resources into the higher-grade subset and the lower-grade subset; (c) selecting which of the NVMe storage elements receives the higher-grade subset and which of the NVMe storage elements receives the lower-grade subset; and (d) issuing coupling commands through the CXL ports. The memory traffic analyzer and the resource composer integrated within the processor may operate on a per-resource basis on the telemetry conveyed to them through internal paths of the processor, so that the grading and the differentiated coupling may apply at any number of contributing entities and any number of NVMe storage elements coupled to the processor through the CXL ports. At a low-end corner, the processor may have CXL ports coupling to three NVMe storage elements and two contributing entities. At a high-end corner, the processor may have CXL ports coupling to a larger number of NVMe storage elements and a larger number of contributing entities, with the memory traffic analyzer aggregating telemetry across the CXL ports and the resource composer issuing coupling commands across the CXL ports. Chip vendors integrating CXL functions into a processor may need to expose performance-differentiated NVMe storage to consumers of the processor without requiring uniform on-device DRAM at each NVMe storage element. Because the processor integrates the memory traffic analyzer and the resource composer and exposes the differentiated coupling through the CXL ports, performance differentiation among NVMe storage elements may be supported by the processor itself.

In some implementations of the system, the memory traffic analyzer and the resource composer are integrated within a same integrated circuit package as the processing cores; wherein the processor further comprises an on-package interconnect coupling the processing cores, the memory traffic analyzer, the resource composer, and the CXL ports; wherein the telemetry of memory accesses is conveyed to the memory traffic analyzer via the on-package interconnect; and wherein the memory traffic analyzer is further configured to observe, via the on-package interconnect, memory accesses comprising both memory accesses to memory local to the processor and memory accesses to the memory resources contributed by the first contributing entity and the second contributing entity. The on-package interconnect may comprise a mesh, ring, or crossbar carrying transaction packets among the processing cores, the memory traffic analyzer, the resource composer, and the CXL ports. The on-package interconnect may instead comprise a die-to-die interconnect coupling a compute die to an input-output die. The memory traffic analyzer integrated on package may receive transaction packets including accesses to memory local to the processor and accesses through the CXL ports to the contributing entities, such that the grading reflects access patterns visible on package. Because the analyzer and composer are on-package, the data path between observation, grading, and coupling may avoid traversing external links during the grading cycle.

In some implementations of the system, the processor further comprises a coherent interconnect coupling the processing cores, and a memory management unit (MMU) coupled to the coherent interconnect; wherein the memory traffic analyzer is coupled to the coherent interconnect and is further configured to receive at least a portion of the telemetry from the coherent interconnect; and wherein the resource composer is further configured to provide, based at least in part on the grading by the memory traffic analyzer, hints to at least one of the coherent interconnect, a last-level cache coupled to the coherent interconnect, or the MMU, the hints biasing cache placement or address translation residency in favor of the higher-grade subset. The coherent interconnect may be a mesh fabric carrying snoop and data transactions among the processing cores, the last-level cache, and the memory controllers. The hints from the resource composer may comprise tag-extension fields that indicate higher-grade resources should be retained in the last-level cache longer than lower-grade resources, or address-translation hints that bias translation lookaside buffer residency. The grading from the memory traffic analyzer may be combined with the hint generation such that the resource composer issues hints in concert with the coupling commands. Because the hints bias internal processor structures, the differentiated coupling may extend beyond the CXL ports into the processor's coherence and translation paths.

In some implementations of the system, the processor further comprises an on-package interconnect coupling the memory traffic analyzer, the resource composer, and the CXL ports, the on-package interconnect operating according to an internal protocol, the internal protocol being selected from at least one of a Universal Chiplet Interconnect Express (UCIe) protocol, an Intel UltraPath Interconnect (UPI) protocol, an AMD Infinity Fabric protocol, an ARM Coherent Hub Interface (CHI) chip-to-chip protocol, an NVLink-C2C protocol, or a proprietary protocol of a manufacturer of the processor. The internal protocol may comprise a standard chip-to-chip protocol such as UCIe carrying transaction-layer packets between the analyzer, the composer, and the CXL ports. The internal protocol may instead comprise a proprietary protocol of the processor's manufacturer, the proprietary protocol being internal to the processor and not exposed externally. The grading and coupling functions integrated within the processor may be combined with the internal protocol such that grading inputs and coupling commands traverse the internal protocol on package. Because the internal protocol may be proprietary, the differentiated-coupling architecture may be preserved across chip vendors that choose non-standard internal protocols.

In some implementations of the system, the memory traffic analyzer is further configured to grade the memory resources by at least one of measured latency or measured bandwidth determined from the telemetry, the measured latency or the measured bandwidth being a property of the memory resources observed during memory accesses to the memory resources; and wherein the resource composer is further configured to maintain the higher-grade subset coupled as cache to the first NVMe storage element concurrently with the lower-grade subset coupled as cache to the second NVMe storage element. The measured latency may be derived from arrival-to-completion timing of CXL.mem load and store transactions traversing the CXL ports, sampled per resource. The measured bandwidth may be derived from cumulative transferred-byte counters per resource. The grading may be combined with the concurrent coupling such that both subsets are coupled in parallel during operation of the processor. Because the analyzer measures properties of the resources and the composer couples both subsets concurrently, the processor may serve differentiated cache to multiple NVMe storage elements simultaneously.

In some implementations of the system, the processor further comprises at least one port configured to communicate, with accelerators of a scale-up cluster, according to at least one of: NVLink, UALink, or Ethernet Scale-Up Networking (ESUN); and wherein at least one of (a) at least one accelerator of the scale-up cluster is one of the contributing entities contributing at least a portion of the memory resources, or (b) at least one accelerator of the scale-up cluster is configured to access at least one of the NVMe storage elements such that memory accesses on behalf of the at least one accelerator are reflected in the telemetry received by the memory traffic analyzer. The processor may include an NVLink-capable port that couples to an NVLink scale-up cluster of accelerators, such that one of the accelerators contributes on-package DRAM via a CXL link as a portion of the memory resources. The processor may instead include a UALink-capable or ESUN-capable port. The grading may be combined with scale-up cluster telemetry such that the higher-grade subset is allocated to an NVMe storage element whose accelerator-originated load justifies higher-grade cache. Because the processor exposes the scale-up port alongside the CXL ports, the differentiated coupling may be coordinated with scale-up-cluster access patterns.

In some implementations of the system, the first NVMe storage element comprises at least one of a first NVMe namespace, a first NVMe Set, a first NVMe Endurance Group, a first logical block address (LBA) range within an NVMe namespace, or a first Zoned Namespace zone; wherein the second NVMe storage element comprises at least one of a second NVMe namespace, a second NVMe Set, a second NVMe Endurance Group, a second LBA range within an NVMe namespace, or a second Zoned Namespace zone; and wherein the resource composer is further configured to expose at least one of the higher-grade subset or the lower-grade subset as cache to a corresponding NVMe storage element via at least one of a Controller Memory Buffer (CMB) of the corresponding NVMe storage element or Host-Managed Device Memory (HDM) of the corresponding NVMe storage element accessible via CXL.mem load and store operations. The CMB exposure may comprise the resource composer issuing CMB-write commands to the corresponding NVMe storage element through the CXL ports of the processor. The HDM exposure may instead comprise advertising the higher-grade subset as a CXL.mem range that the NVMe storage element accesses via CXL.mem load and store operations. The NVMe namespace or NVMe Set granularity may be combined with the CMB or HDM exposure such that each namespace or Set receives an independently coupled cache subset. Because the processor may expose differentiated cache at namespace or LBA-range granularity through standard NVMe interfaces, the differentiated coupling may be deployed without modification to consuming hosts.

In various implementations, a method comprising: receiving, by a computer, telemetry of memory accesses to memory resources distributed across a Compute Express Link (CXL) fabric, the memory resources contributed via the CXL fabric by entities comprising at least a first entity coupled to the CXL fabric via a first CXL link and a second entity coupled to the CXL fabric via a second CXL link, the memory resources configured to be allocated as cache for Non-Volatile Memory Express (NVMe) storage elements comprising at least a first NVMe storage element, a second NVMe storage element, and a third NVMe storage element; grading, by the computer, based at least in part on the telemetry, the memory resources into at least a higher-grade subset of the memory resources and a lower-grade subset of the memory resources; coupling, by the computer, the higher-grade subset as cache to the first NVMe storage element; and coupling, by the computer, the lower-grade subset as cache to the second NVMe storage element. The computer may comprise a processor coupled to a memory storing instructions that, when executed by the processor, cause the processor to perform the method. The computer may be implemented as a CXL fabric manager, a hypervisor of a host coupled to the CXL fabric, an operating system of such a host, a driver, a firmware of a switch, a firmware of a memory pool device, a firmware of an NVMe storage element, a controller of a smart network interface card, or a combination thereof. The method may be performed by a single computer or by a coordinated set of computers each executing a portion of the method. The receiving of the telemetry may comprise pulling counters from one or more CXL Performance Monitoring Units, CXL Hotness Monitoring Units, memory controller counters, switch port counters, or NVMe storage element counters, or receiving pushed telemetry from such sources. The grading by the computer may be performed by an algorithm comprising: (1) maintaining per-resource counters and latency samples derived from the telemetry; (2) deriving for each of the memory resources a measured property such as a mean latency, a mean bandwidth, a jitter, a tail latency, or a composite metric; (3) applying a grading rule that assigns a grade label per memory resource; and (4) outputting the per-resource grade labels. The coupling steps may be performed by the computer by an algorithm comprising: (a) partitioning the memory resources into the higher-grade subset and the lower-grade subset based on the grade labels; (b) selecting which of the NVMe storage elements receives the higher-grade subset and which of the NVMe storage elements receives the lower-grade subset; and (c) issuing coupling commands that map the selected subsets as caches to the selected NVMe storage elements, the coupling commands being CXL fabric management commands, NVMe administrative commands, or vendor-defined commands. At a low-end corner, the method may operate with three NVMe storage elements and two contributing entities. At a high-end corner, the method may operate with tens to hundreds of NVMe storage elements and tens to hundreds of contributing entities. Software actors orchestrating heterogeneous CXL-fabric memory as cache for multiple NVMe storage elements may need a procedure that grades resources by measured properties and map the graded subsets to differentiated NVMe storage elements. Because the method grades the memory resources from the telemetry and couples graded subsets to different NVMe storage elements, software orchestration may achieve the differentiated coupling without modification to the hardware data path.

In some implementations of the method, the grading is performed repeatedly during operation of a system comprising the NVMe storage elements, based at least in part on at least one of measured latency or measured bandwidth of accesses to the memory resources determined from the telemetry; wherein the coupling of the higher-grade subset and the coupling of the lower-grade subset are maintained concurrently; and wherein the method further comprises, responsive to at least one of an expiration of a re-grading interval or a determination that a measured characteristic of at least a portion of the memory resources has drifted beyond a threshold, re-grading the memory resources by the computer and re-coupling at least a portion of the memory resources from one of the NVMe storage elements to a different one of the NVMe storage elements. The repeated grading may be triggered by a timer expiry, by a counter overflow indicating that a measurement window has filled, or by an external event from a fabric manager. The repeated grading may instead be event-driven, triggered when the telemetry reports a property change for at least one memory resource. The re-coupling may be combined with the concurrent coupling such that the resource composer holds both prior and new couplings briefly during a transition. Because the method re-grades and re-couples on interval or drift, the system may adapt cache differentiation to changes observed during operation.

In some implementations of the method, the grading is further based at least in part on at least one of: a measured jitter of memory access latency to the memory resources, a measured tail latency of memory accesses to the memory resources, a measured bandwidth utilization of the memory resources relative to a nominal bandwidth of the memory resources, a measured error rate or reliability indicator of the memory resources, or a composite grade derived from a combination of two or more of measured latency, measured bandwidth, measured jitter, measured tail latency, measured bandwidth utilization, or measured error rate; and wherein the telemetry of memory accesses comprises telemetry from at least one of a CXL Performance Monitoring Unit (CPMU) of one of the entities, a CXL Hotness Monitoring Unit (CHMU) of one of the entities, a memory controller counter of one of the entities, a switch port counter of a switch coupling at least one of the entities to the CXL fabric, or a counter of one of the NVMe storage elements. The measured jitter or measured tail latency may be derived by the computer from latency samples reported in CPMU records. The measured error rate may be derived from CXL Common Event Record entries reported by the contributing entity. The composite grade may be derived by the computer as a weighted sum of normalized dimension scores, with the weights configurable per deployment. The multi-source telemetry may be combined with the runtime repeated grading such that each grading cycle incorporates the most recent telemetry from each source. Because the method aggregates multiple telemetry sources and multiple grading dimensions, the grading may reflect a broad set of measured properties of the memory resources.

In some implementations of the method, the first NVMe storage element comprises at least one of a first NVMe namespace, a first NVMe Set, a first NVMe Endurance Group, a first logical block address (LBA) range within an NVMe namespace, or a first Zoned Namespace zone; wherein the second NVMe storage element comprises at least one of a second NVMe namespace, a second NVMe Set, a second NVMe Endurance Group, a second LBA range within an NVMe namespace, or a second Zoned Namespace zone; wherein the first entity comprises at least one of a host comprising dynamic random-access memory (DRAM), a CXL memory expander comprising DRAM, or a memory pool device reachable via at least one CXL switch and comprising DRAM; wherein the second entity comprises at least one of a host comprising DRAM, a CXL memory expander comprising DRAM, or a memory pool device reachable via at least one CXL switch and comprising DRAM, the second entity having a function distinct from a function of the first entity; and wherein the method further comprises receiving the telemetry from accelerators of a scale-up cluster interconnected via at least one of NVLink, UALink, or Ethernet Scale-Up Networking (ESUN), the accelerators accessing at least one of the NVMe storage elements. The first NVMe storage element and the second NVMe storage element may be NVMe namespaces presented by a single physical NVMe SSD or by separate physical NVMe SSDs. The first entity may be a host with underutilized DRAM, and the second entity may be a CXL memory expander, providing heterogeneous contributing classes. The telemetry from the scale-up cluster may comprise per-accelerator access histograms for the NVMe storage elements, combined by the computer with the resource-level telemetry. Because the method receives multi-class entity telemetry and accelerator-cluster telemetry, the grading may reflect access patterns spanning compute hosts, memory expanders, and scale-up-cluster accelerators.

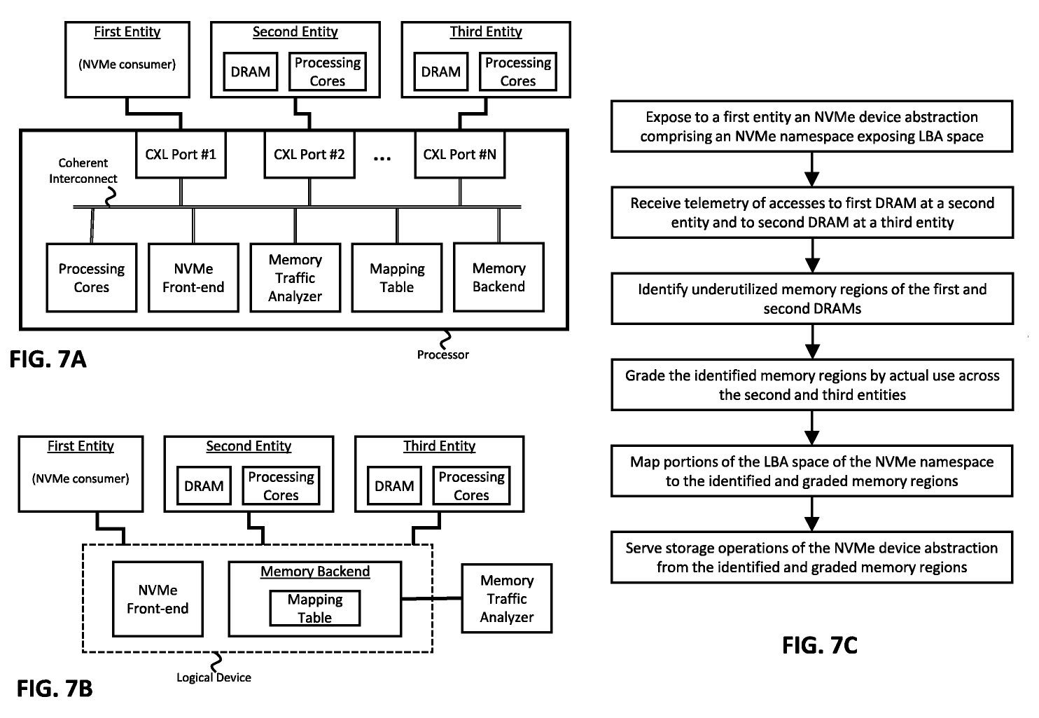

FIG. 7A illustrates one example of a processor that includes a plurality of processing cores coupled via a coherent interconnect. The coherent interconnect may couple also one or more CXL ports, an NVMe front-end, a memory traffic analyzer, a mapping table, and/or a memory back-end, which may reside within the processor. A first entity external to the processor may operate as an NVMe consumer and may be coupled to the processor via a CXL link. A second entity external to the processor may include a first DRAM and a plurality of processing cores, and may be coupled to the processor via a CXL link. A third entity external to the processor may include a second DRAM and a plurality of processing cores, and may be coupled to the processor via a CXL link. The NVMe front-end may expose, to the first entity via the one or more CXL ports, an NVMe device including an NVMe namespace that exposes an LBA space to the first entity. The memory traffic analyzer may receive, via the one or more CXL ports, telemetry of accesses to the first DRAM and to the second DRAM, may identify memory regions of the first DRAM and of the second DRAM that are underutilized, and may grade the identified memory regions by actual use across the second entity and the third entity. The mapping table may store mappings between portions of the LBA space and the identified and graded memory regions. The memory back-end may map portions of the LBA space to the identified and graded memory regions based at least in part on the grading by the memory traffic analyzer, and may serve storage operations of the NVMe device at least in part from the identified and graded memory regions, the identified and graded memory regions serving as at least one of a cache for the NVMe device or a portion of a storage place for the NVMe device.

Modern computing systems may include compute entities such as hosts, virtual machines, containers, function-as-a-service instances, bare-metal instances, accelerators, processing compute elements, and other compute elements. Compute entities may include DRAM accessible by processing cores of the compute entity. At various points in time, portions of the DRAM at a compute entity may be allocated to a workload but not actively accessed by the workload, may not be allocated to any workload, or may be accessed at a rate below a threshold. The aggregate amount of such underutilized DRAM across compute entities in a multi-entity environment may be substantial. Some implementations may include a logical device that exposes an NVMe device to a compute entity, where the storage substrate underlying the NVMe device is mapped at least in part to underutilized DRAM harvested from DRAM at one or more other compute entities, coupled to the logical device via CXL. A memory traffic analyzer may identify underutilized memory regions across the contributing entities and grade those regions by actual use, and the logical device may map portions of the NVMe namespace's LBA space to the identified and graded memory regions. Storage operations of the NVMe device may thereby be mapped at least in part to underutilized DRAM harvested across compute entities, which may reduce the amount of dedicated storage media required to serve those storage operations.

In various implementations, a processor comprising: processing cores coupled via a coherent interconnect; one or more Compute Express Link (CXL) ports coupled to the coherent interconnect; and wherein the processor is configured to: expose, to a first entity via the one or more CXL ports, a Non-Volatile Memory Express (NVMe) device comprising an NVMe namespace that comprises a Logical Block Address (LBA) space; receive telemetry of accesses to first dynamic random-access memory (DRAM) at a second entity external to the processor and to second DRAM at a third entity external to the processor; identify, based at least in part on the telemetry, memory regions of the first DRAM and of the second DRAM that are underutilized; grade the identified memory regions by actual use across the second entity and the third entity; map portions of the LBA space to the identified and graded memory regions based at least in part on the grading; and serve storage operations of the NVMe device at least in part from the identified and graded memory regions, the identified and graded memory regions serving as at least one of: a cache for the NVMe device, or a portion of a storage place for the NVMe device.

The processor may be implemented as a monolithic silicon die or as a multi-die or chiplet package having a compute die and an I/O die or chiplet, with the one or more CXL ports residing on the compute die, on the I/O die, or on a separate die coupled by an on-package interconnect. The functional operations of the processor recited in the wherein-clause may be performed by a combination of structural elements of the processor, including a controller, a finite state machine, a translation table, a mapping table, an access-tracking circuit, and instructions executed by the processing cores; these structural elements may reside on the same die or be distributed across dies, and may be implemented as fixed-function logic, microcoded firmware executing on an embedded microcontroller of the processor, instructions executed by the processing cores, or a combination thereof. Exposing the NVMe device may include presenting the NVMe namespace to the first entity via a CXL.io endpoint of the one or more CXL ports, the NVMe namespace exposing the LBA space to the first entity. Receiving the telemetry of accesses may include sampling, counting, or aggregating access events corresponding to the first DRAM and the second DRAM, the access events including read or write transactions issued at the second entity or at the third entity. The telemetry may be transported over the one or more CXL ports as in-band metadata accompanying memory transactions, as out-of-band messages on CXL.io, or as a combination thereof. Identifying memory regions that are underutilized may be performed by applying one or more underutilization criteria, examples of which include, without limitation, that a memory region has been allocated to a workload at the second or third entity but has not been accessed within a time window, that a memory region is not allocated to a workload at the second or third entity, or that a memory region has a measured access frequency below a threshold. Grading the identified memory regions may include computing a per-region score that reflects access intensity, recency, or another measure of actual use, and ranking or partitioning the identified memory regions by the score. Mapping portions of the LBA space to the identified and graded memory regions may include updating entries of the mapping table that map LBA ranges to physical address ranges of the identified and graded memory regions. Serving storage operations of the NVMe device may include translating incoming NVMe commands from the first entity into accesses to the bound memory regions, the accesses being performed over the one or more CXL ports. The identification, the grading, and the mapping may operate independently of the number of contributing entities and the size of the memory regions in the DRAM, so that the same operations may apply across the full range of contributing entities and region sizes recited by the claim. Corner cases may include a configuration with two contributing entities each providing a single memory region, and a configuration with many contributing entities each providing memory regions of widely varying size.

In some implementations of the processor, the processing cores are configured to execute instructions compatible with at least one of: an x86 instruction set architecture (ISA), an ARM ISA, a RISC-V ISA, or an instruction set compatible with NVIDIA's Compute Unified Device Architecture (CUDA). The processing cores may include a mix of general-purpose cores executing an x86 ISA, an ARM ISA, or a RISC-V ISA, and may also comprise streaming multiprocessors executing instructions compatible with a parallel computing architecture. The functional operations of the wherein-clause of the parent claim may be partitioned across cores executing different ISAs.

In some implementations of the processor, the processor is implemented as at least one of: a monolithic silicon die, a multi-die package comprising a compute die and an I/O die, or a chiplet package comprising at least one compute chiplet and at least one I/O chiplet. In a multi-die package, the one or more CXL ports may reside on the I/O die, and the processing cores may reside on the compute die. In a chiplet package, the one or more CXL ports may reside on an I/O chiplet that may be implemented in a process node distinct from a process node of the compute chiplet. Distributing the CXL ports onto a separate I/O die or chiplet may reduce the area of the compute die or chiplet.

In some implementations, the processor further comprises an on-package interconnect operating according to a chip-to-chip protocol, the on-package interconnect coupling the one or more CXL ports to the coherent interconnect. The on-package interconnect may be implemented as a die-to-die SerDes interface, as a die-to-die parallel interface, or as a silicon-interposer-based interconnect. The on-package interconnect may carry transactions originating from the one or more CXL ports toward the coherent interconnect and vice versa. Decoupling the CXL ports from the coherent interconnect through an on-package interconnect may support placement of the CXL ports on a die distinct from the die hosting the processing cores.

In some implementations of the processor, the chip-to-chip protocol is at least one of: Universal Chiplet Interconnect Express (UCIe), Intel Ultra Path Interconnect (UPI), AMD Infinity Fabric, NVIDIA NVLink Chip-to-Chip (NVLink-C2C), ARM Coherent Hub Interface Chip-to-Chip (CHI-C2C), or a proprietary protocol utilized by the processor. The chip-to-chip protocol may be a standardized inter-die interconnect protocol. The chip-to-chip protocol may also be a proprietary protocol utilized by the processor that is not publicly documented and that may be modified by the manufacturer without external coordination. The choice between a standardized chip-to-chip protocol and a proprietary chip-to-chip protocol may be made independently of the externally exposed CXL interface, such that the external interface may remain a CXL interface while the internal chip-to-chip protocol varies.

In some implementations of the processor, the NVMe device further comprises an administrative queue pair and an input/output (I/O) queue pair through which the first entity submits commands to and receives completions from the NVMe device. The administrative queue pair may be used by the first entity to discover the NVMe namespace, configure the LBA space size, and manage the NVMe device. The I/O queue pair may be used by the first entity to submit read commands and write commands to the LBA space. The processor may support multiple I/O queue pairs for the NVMe device, with command-completion ordering maintained per queue pair.

In some implementations, the processor further comprises at least one of: an NVLink port, an Ultra Accelerator Link (UALink) port, or an Ethernet Scale-Up Networking (ESUN) port, the at least one port coupled to the coherent interconnect, and wherein the processor is further configured to receive at least a portion of the telemetry via the at least one port. The processor may include a non-CXL port operating according to an accelerator-fabric protocol or an Ethernet-based scale-up protocol, in addition to the one or more CXL ports. The telemetry of accesses to the DRAM at the second entity or at the third entity may be partitioned such that telemetry from a contributing entity coupled by the non-CXL port arrives via the non-CXL port, while telemetry from a contributing entity coupled by CXL arrives via the one or more CXL ports.

In some implementations of the processor, identifying the memory regions that are underutilized comprises identifying memory regions of the first DRAM or the second DRAM whose measured access frequency is below a threshold, and wherein the threshold is adaptive based on workload pressure at the second entity or at the third entity. The threshold may be expressed in accesses per unit time or as a relative percentile of access frequencies across memory regions of a contributing entity. The threshold may be adapted by increasing or decreasing as workload pressure at the contributing entity rises or falls, with the workload pressure inferred from the rate or volume of memory accesses by the contributing entity. The adaptive threshold may reduce the rate at which memory regions are identified as underutilized when contributing entities are under high pressure, and may increase that rate when contributing entities are under low pressure.

A memory region may be identified as underutilized in response to determining that the memory region is not allocated to any workload at the second entity or at the third entity. Allocation state may be reported to the memory traffic analyzer by an allocator of the contributing entity, by an operating system of the contributing entity, by a memory manager of a hypervisor of the contributing entity, or by direct inspection of allocation metadata. The unallocated mode may be combined with the allocated-but-cold mode such that memory regions identified by either mode become candidates for harvest. The unallocated mode may also be combined with capability-token issuance such that tokens minted for an unallocated region are revoked when the region is reallocated to a workload at the contributing entity.

A time window for an allocated-but-cold mode may be configurable. Configuration may be performed by an administrator via an out-of-band management interface, by a fabric manager controlling the multi-host CXL environment, by an automated controller adapting the window based on observed workload patterns, or by the workload itself signaling expected access periodicity. The time window may differ among contributing entities, may differ among workloads at a single contributing entity, and may differ among memory regions allocated to a single workload. Allowing the time window to be selectable may support tuning the identification rate for different workload classes.

In some implementations of the processor, each of the first entity, the second entity, and the third entity comprises a host, each host comprising respective processing cores, the first DRAM being part of memory of the second entity accessible by the respective processing cores of the second entity, the second DRAM being part of memory of the third entity accessible by the respective processing cores of the third entity, and wherein the one or more CXL ports of the processor are coupled to the second entity and to the third entity via at least one of: a CXL root port, a CXL switch, or a CXL fabric. The hosts may be bare-metal servers, virtualization-enabled servers, or accelerator-bearing platforms, each having local memory accessible by its respective processing cores for the host's own workloads. The first and second DRAM may be portions of that local memory exposed to the processor over CXL. Coupling via a CXL fabric may support port-based routing of transactions among hosts and devices, while coupling via a CXL switch may support a hierarchical topology.

In some implementations, the processor further comprises a memory traffic analyzer configured to perform the identifying of the memory regions and the grading of the identified memory regions, wherein the memory traffic analyzer comprises a transactional spatio-temporal (ST) analyzer. The memory traffic analyzer may be implemented as a hardware block on the I/O die or compute die of the processor, as firmware executing on an embedded microcontroller, or as instructions executed by one of the processing cores. The transactional spatio-temporal analyzer may operate on access events grouped by transactional epochs and may produce per-region grading outputs reflecting spatial locality and temporal access patterns. The transactional spatio-temporal analyzer may be combined with adaptive-threshold operation for identifying underutilized memory regions.

FIG. 7B illustrates a system according to one or more example implementations. The system may include a logical device. The logical device may include an NVMe front-end and a memory back-end, and the memory back-end may include a mapping table. The system may further include a memory traffic analyzer separate from the logical device and coupled to the memory back-end. A first entity may operate as an NVMe consumer and may be coupled to the NVMe front-end of the logical device via a CXL link. A second entity may include a first DRAM and a plurality of processing cores, and the first DRAM may be coupled to the memory back-end of the logical device via a CXL link. A third entity may include a second DRAM and a plurality of processing cores, and the second DRAM may be coupled to the memory back-end of the logical device via a CXL link. The NVMe front-end may expose, to the first entity, an NVMe device comprising an NVMe namespace that exposes an LBA space to the first entity. The memory traffic analyzer may receive telemetry of accesses to the first DRAM and to the second DRAM, may identify memory regions of the first DRAM and of the second DRAM that are underutilized, and may grade the identified memory regions by actual use across the second entity and the third entity. The mapping table may store mappings between portions of the LBA space and the identified and graded memory regions. The memory back-end may map portions of the LBA space to the identified and graded memory regions based at least in part on the grading by the memory traffic analyzer, and may serve storage operations of the NVMe device at least in part from the identified and graded memory regions, the identified and graded memory regions serving as at least one of a cache for the NVMe device or a portion of a storage place for the NVMe device.

In various implementations, a system comprising: a logical device comprising a Non-Volatile Memory Express (NVMe) front-end and a memory back-end, the NVMe front-end configured to expose to a first entity an NVMe device comprising an NVMe namespace exposing a Logical Block Address (LBA) space to the first entity; a second entity comprising first dynamic random-access memory (DRAM), the first DRAM coupled to the memory back-end via Compute Express Link (CXL); a third entity comprising second DRAM, the second DRAM coupled to the memory back-end via CXL; a memory traffic analyzer configured to receive telemetry of accesses to the first DRAM and to the second DRAM, the memory traffic analyzer configured to identify memory regions of the first DRAM and of the second DRAM that are underutilized, and to grade the identified memory regions by actual use across the second entity and the third entity; and wherein the memory back-end is configured to map portions of the LBA space to the identified and graded memory regions based at least in part on the grading by the memory traffic analyzer, such that storage operations of the NVMe device are mapped at least in part to the identified and graded memory regions, the identified and graded memory regions serving as at least one of: a cache for the NVMe device, or a portion of a storage place for the NVMe device.

The logical device may be implemented as a dedicated appliance coupled to the second entity and the third entity via CXL, as circuitry integrated into a CXL switch, as circuitry integrated into a CXL fabric manager, as circuitry integrated into a resource composer, or as a combination thereof; in some implementations, the logical device may be integrated into a processor of the first entity such that the first entity hosts the NVMe device it consumes. The NVMe front-end may include an NVMe device configuration space, command and completion queue structures, a resource mapper, and a caching agent. The memory back-end may include a mapping table mapping LBA ranges of the NVMe namespace to physical address ranges of identified and graded memory regions, and may include direct memory access (DMA) engines configured to perform reads from and writes to the identified and graded memory regions over CXL. The memory traffic analyzer may be implemented as a hardware block, as firmware on an embedded microcontroller, or as instructions executed by a processor; the memory traffic analyzer may be co-located with the logical device, may be distributed across the second entity and the third entity, or may be co-located with the NVMe front-end. The telemetry of accesses may be collected by per-region access counters at the second entity and at the third entity, by sampling agents that capture a fraction of access events, or by an access-tracking circuit integrated into a CXL endpoint at the contributing entity. Identifying memory regions that are underutilized may apply one or more underutilization criteria, examples of which include, without limitation, that a memory region has been allocated to a workload at the second or third entity but has not been accessed within a time window, that a memory region is not allocated to a workload at the second or third entity, or that a memory region has a measured access frequency below a threshold. Grading the identified memory regions may include assigning a per-region score reflecting access intensity, recency, or another measure of actual use, and partitioning the identified memory regions by the score. Mapping portions of the LBA space to the identified and graded memory regions may include updating entries of the mapping table on a per-LBA-range basis or on a per-namespace-portion basis. Serving storage operations may include the NVMe front-end accepting NVMe commands from the first entity, the memory back-end translating the commands into CXL transactions targeting the bound memory regions, and the memory back-end returning data or completions to the NVMe front-end for delivery to the first entity. The memory traffic analyzer's identification and grading, and the memory back-end's mapping, may operate independently of the number of contributing entities and the size of identified memory regions, so that the same operations may apply across the full range. Corner cases may include a configuration in which the second entity and the third entity each provide a single memory region, and a configuration in which the second entity and the third entity provide many memory regions of widely varying size, with additional contributing entities present beyond the second and third entities. Because the memory back-end maps portions of the NVMe namespace's LBA space to identified and graded memory regions, the storage capacity available to the first entity through the NVMe device may be drawn from underutilized DRAM at contributing entities, and the amount of dedicated storage media used to serve storage operations of the NVMe device may be reduced.

In some implementations of the system, the memory traffic analyzer comprises a transactional spatio-temporal (ST) analyzer. The transactional spatio-temporal analyzer may operate on access events grouped by transactional epochs and may produce per-region grading outputs reflecting spatial locality and temporal access patterns. The transactional spatio-temporal analyzer may be combined with capability-token issuance such that tokens are minted at transactional-epoch boundaries.

In some implementations of the system, the first DRAM or the second DRAM is further coupled to the memory back-end via at least one of: an NVLink-based interconnect, an Ultra Accelerator Link (UALink)-based interconnect, or an Ethernet Scale-Up Networking (ESUN)-based interconnect. The contributing entity coupled by the accelerator-fabric protocol or the Ethernet-based scale-up protocol may also be coupled by CXL such that the memory back-end may select among interconnect paths based on access type, payload size, or congestion. The telemetry collected through the non-CXL path may be merged with telemetry collected through the CXL path for grading purposes.

In some implementations of the system, the memory traffic analyzer is configured to identify a memory region as underutilized in response to determining that the memory region has been allocated to a workload at the second entity or at the third entity and has not been accessed within a predetermined time window. The predetermined time window may be configurable by an administrator, by a fabric manager, or by the workload itself. The memory traffic analyzer may distinguish among inactive workloads that may resume access from inactive workloads that may not, and may bias identification toward the latter. Combining the allocated-but-cold mode with adaptive-threshold-based identification may broaden the set of memory regions identified as underutilized.

In some implementations of the system, the memory traffic analyzer is configured to identify a memory region as underutilized in response to determining that the memory region has measured access frequency below a threshold, and wherein the threshold is adaptive based on workload pressure at the second entity or at the third entity. The threshold may be expressed in accesses per unit time or as a relative percentile of access frequencies across memory regions. The threshold may be adapted by feedback from the second entity or the third entity reporting workload pressure. The adaptive threshold combined with grading may rank identified memory regions for mapping priority.

In some implementations of the system, the memory traffic analyzer is further configured to issue capability tokens corresponding to the identified and graded memory regions, the capability tokens bound at least in part to portions of the LBA space, and wherein the memory back-end is further configured to check a capability token corresponding to a memory region prior to serving a storage operation of the NVMe device from the memory region. The capability token may be a cryptographically signed value, a hash-based message authentication code, or an opaque handle backed by a token-validation circuit of the memory back-end. The capability token may carry a region identifier, an LBA-range mapping, and a validity interval. The memory back-end may reject a storage operation when the capability token is absent, invalid, or expired, which may protect against access to a memory region whose harvest grant has been revoked.

A key manager coupled to the memory back-end may hold per-entity encryption keys corresponding to the second entity and the third entity. The memory back-end may apply per-region encryption-at-rest such that data written to an identified and graded memory region is encrypted under a key associated with the contributing entity, and data read from the identified and graded memory region is decrypted under the same key. The key manager may rotate keys in response to grading transitions or in response to harvest grants and revocations. Encryption-at-rest under per-entity keys may protect data of the NVMe device against unauthorized access by a workload of the contributing entity after the memory region has been harvested. The per-entity encryption keys architecture may be combined with capability-token issuance such that capability tokens are bound to the entity-specific key.

The memory back-end may include a translation table that translates entity-side physical addresses of the contributing entity into back-end-side physical addresses used to access the identified and graded memory regions. Entries of the translation table may enforce region-level access control such that a workload of the contributing entity may not access an identified and graded memory region while the region is bound to the LBA space. The translation table may invalidate entries upon reclamation by the contributing entity and may re-establish entries upon grant of new harvest. Address-translation-based isolation may be combined with hardware-enforced memory isolation at the contributing entity for layered protection.

The CXL link coupling the memory back-end to the contributing entity may operate with CXL Integrity and Data Encryption (IDE) enabled, such that transactions between the memory back-end and the contributing entity over the CXL link are encrypted and integrity-protected. CXL IDE may protect harvested data in transit but may not protect data at rest at the contributing entity; CXL IDE may be combined with per-entity encryption keys at-rest for full-path protection.

The contributing entity may include a memory firewall configured to enforce region-level lockable address ranges, such that a memory region granted as harvested may be locked against access by workloads at the contributing entity for the duration of the grant. The memory firewall may be implemented as a hardware unit coupled to the contributing entity's memory controller. Hardware-enforced memory isolation at the contributing entity may be combined with address-translation-based isolation at the memory back-end such that isolation is enforced at both endpoints.

In some implementations of the system, the memory back-end is further configured to re-map a portion of the LBA space from a first identified and graded memory region to a second identified and graded memory region, the re-mapping performed in response to at least one of: a grading transition by the memory traffic analyzer corresponding to the portion, or a reclamation signal from the second entity or the third entity corresponding to the first identified and graded memory region; and wherein the re-mapping is performed without exposing a discontinuity to storage operations of the NVMe device issued by the first entity. The re-mapping may be performed by copying contents of the first identified and graded memory region to the second identified and graded memory region and updating an entry of the mapping table atomically with respect to NVMe command completion. The re-mapping may instead be performed by maintaining a shadow mapping during a copy phase and swapping the active mapping upon copy completion. Re-mapping combined with capability-token reissuance may map new tokens to the second identified and graded memory region.

In some implementations of the system, each of the first entity, the second entity, and the third entity comprises a host, each host comprising respective processing cores, the first DRAM being part of memory of the second entity accessible by the respective processing cores of the second entity, the second DRAM being part of memory of the third entity accessible by the respective processing cores of the third entity, and wherein the memory back-end is coupled to the second entity and to the third entity via at least one of: a CXL root port, a CXL switch, or a CXL fabric. The hosts may be bare-metal servers, virtualization-enabled servers, or accelerator-bearing platforms. The first and second DRAM may be portions of host-local memory that are made available to the memory back-end while remaining accessible to the host's own processing cores. The CXL switch may support multi-host pooling, and the CXL fabric may support port-based routing among hosts and the memory back-end.

In various implementations, a method comprising: exposing, to a first entity by a logical device, a Non-Volatile Memory Express (NVMe) device comprising an NVMe namespace exposing a Logical Block Address (LBA) space to the first entity, wherein the logical device comprises an NVMe front-end exposing the NVMe device and a memory back-end; receiving telemetry of accesses to first dynamic random-access memory (DRAM) at a second entity and to second DRAM at a third entity, wherein the first DRAM and the second DRAM are coupled to the memory back-end via Compute Express Link (CXL); identifying, based at least in part on the telemetry, memory regions of the first DRAM and of the second DRAM that are underutilized; grading the identified memory regions by actual use across the second entity and the third entity; mapping portions of the LBA space to the identified and graded memory regions based at least in part on the grading; and serving storage operations of the NVMe device at least in part from the identified and graded memory regions, the identified and graded memory regions serving as at least one of: a cache for the NVMe device, or a portion of a storage place for the NVMe device. The method may be performed by a processor coupled to a memory storing instructions that, when executed by the processor, cause the processor to perform the steps. The processor may be a processor of the logical device, a processor of the first entity, or a processor of a fabric controller coupled to the logical device. Exposing the NVMe device may include presenting the NVMe namespace to the first entity via a CXL.io endpoint of the logical device. Receiving the telemetry of accesses may include sampling, counting, or aggregating access events corresponding to the first DRAM and the second DRAM, the access events including read or write transactions issued at the second entity or at the third entity. The receiving step and the identifying step may be repeated periodically, in response to a trigger from the second entity or the third entity, or in response to a mapping-table-utilization condition. Identifying memory regions that are underutilized may apply one or more underutilization criteria, examples of which include, without limitation, that a memory region has been allocated to a workload at the second or third entity but has not been accessed within a time window, that a memory region is not allocated to a workload at the second or third entity, or that a memory region has a measured access frequency below a threshold. Grading the identified memory regions may include computing a per-region score and partitioning the identified memory regions by the score. Mapping portions of the LBA space to the identified and graded memory regions may include updating entries of a mapping table that maps LBA ranges of the NVMe namespace to physical address ranges of the identified and graded memory regions. Serving storage operations may include translating incoming NVMe commands from the first entity into CXL transactions targeting the bound memory regions. The method may operate independently of the number of contributing entities and the size of the memory regions, so that the same method may apply across the full range. Corner cases may include a method instance with two contributing entities and a single memory region per entity, and a method instance with many contributing entities and many memory regions per entity of varying size. Because the method maps portions of the NVMe namespace's LBA space to identified and graded memory regions, the amount of dedicated storage media used to serve storage operations of the NVMe device may be reduced.

In some implementations of the method, identifying the memory regions that are underutilized comprises identifying memory regions whose measured access frequency is below a threshold, the threshold being adaptive based on workload pressure at the second entity or at the third entity. Adaptation of the threshold may be performed by an adaptation circuit, by firmware on an embedded microcontroller, or by instructions executed by a processor performing the method. The adaptation may track workload pressure at the second entity or at the third entity by observing the rate or volume of memory accesses from the respective workload.

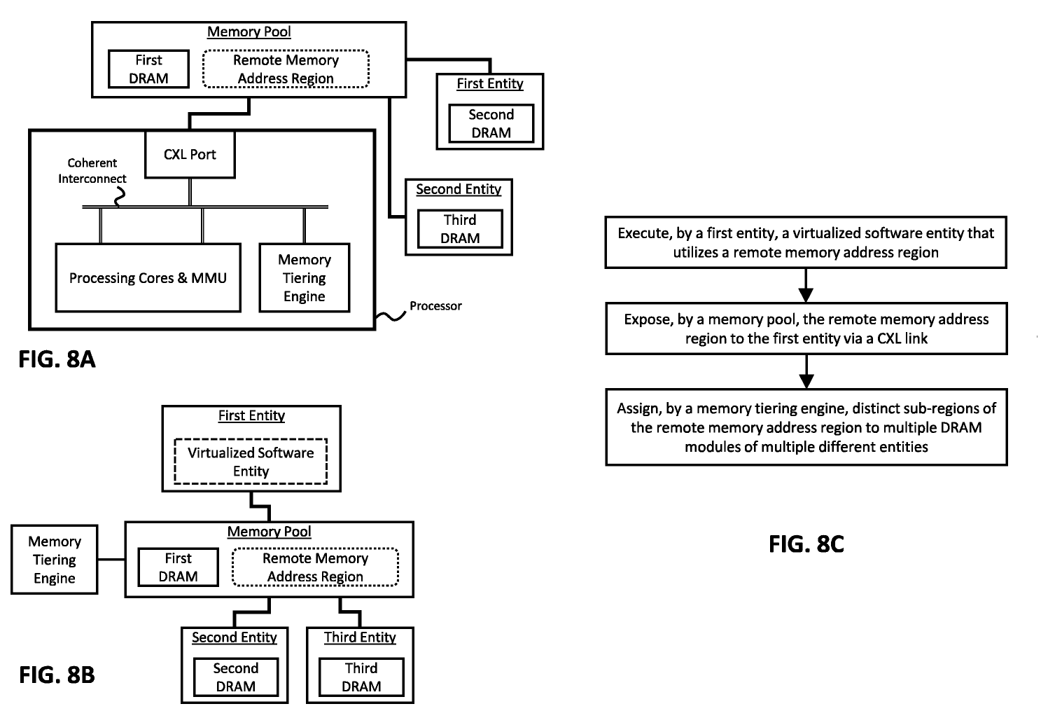

FIG. 8A illustrates an example of a processor, such as a CPU, comprising a CXL port, a coherent interconnect, processing cores, a memory management unit, and a memory tiering engine, all integrated within the processor’s IC package. The CXL port may be coupled by a CXL link to a memory pool that includes first DRAM and exposes a remote memory address region to the processor. The memory pool may be coupled by CXL to a first entity that includes second DRAM and to a second entity that includes third DRAM, with the first entity and the second entity external to the processor’s IC package. The processing cores may execute a virtualized software entity that utilizes the remote memory address region. The memory management unit may map virtual addresses wherein a virtual address space utilized by the virtualized software entity to physical addresses. The memory tiering engine may map distinct sub-regions of the remote memory address region to distinct ones of the first DRAM, the second DRAM, and the third DRAM based on a memory utilization characteristic of the virtualized software entity, such that at a given time during execution of the virtualized software entity at least three sub-regions of the remote memory address region are mapped concurrently to at least the first DRAM, the second DRAM, and the third DRAM. The memory tiering engine may be located on a compute die comprising the processing cores, on an input/output die different from the compute die and within the IC package, or on a chiplet within the IC package; the memory tiering engine may be coupled to the coherent interconnect via an on-package interconnect. The memory pool may be implemented as a switch application-specific IC with embedded memory controllers, as a memory expander appliance with a CXL fabric-facing port, or as switching circuitry integrated with first DRAM in a single device. The first entity and the second entity may each be a host, a device, a GPU, or an accelerator.

A memory pool may aggregate DRAM from multiple distinct entities and expose a remote memory address region of a virtualized software entity executed at a first entity over CXL. A memory tiering engine may map distinct sub-regions of the remote memory address region to distinct DRAM sources at different entities, based on a memory utilization characteristic of the virtualized software entity, such that the virtualized software entity is mapped concurrently to multiple distinct DRAM sources during its execution. The memory tiering engine may be integrated together with processing cores of a processor in an integrated circuit package, may be located on the memory pool, may be located on a fabric manager, or may be located on a switch coupling the first entity to the memory pool, with the operational consequence determined by the placement.

In various implementations, a processor comprising: processing cores coupled via a coherent interconnect, the processing cores configured to execute a virtualized software entity selected from a virtual machine, a container, or a function-as-a-service instance, wherein the virtualized software entity is configured to utilize a remote memory address region; a memory management unit (MMU) configured to map virtual addresses within a virtual address space utilized by the virtualized software entity to physical addresses; a Compute Express Link (CXL) port configured to communicate with a memory pool, wherein the memory pool comprises first dynamic random-access memory (DRAM), the memory pool is configured to expose the remote memory address region to the processor, the memory pool is coupled to a first CXL entity comprising second DRAM and to a second CXL entity comprising third DRAM; and a memory tiering engine integrated in a same integrated circuit package as the processing cores, the memory tiering engine configured to map first, second, and third sub-regions of the remote memory address region to the first DRAM, the second DRAM, and the third DRAM, respectively, based at least in part on a memory utilization characteristic of the virtualized software entity, such that, at a given time during execution of the virtualized software entity, the first sub-region of the remote memory address region is mapped to the first DRAM, the second sub-region of the remote memory address region is mapped to the second DRAM, and the third sub-region of the remote memory address region is mapped to the third DRAM.

The processor may be implemented as a monolithic system-on-chip, as a multi-die package combining a compute die and an input/output die over an on-package interconnect, or as a chiplet-based package combining multiple compute chiplets and one or more input/output chiplets. The processing cores may be CPU cores executing instructions compatible with an x86 ISA, an ARM ISA, or a RISC-V ISA, or may be streaming multiprocessor cores executing instructions compatible with a CUDA parallel computing platform. The memory tiering engine may be implemented as a finite state machine in a die of the processor, as firmware executing on an embedded microcontroller of the processor, or as instructions executed by one or more of the processing cores. Operation of the memory tiering engine may proceed by: (1) collecting telemetry of memory accesses to the remote memory address region during execution of the virtualized software entity; (2) partitioning the remote memory address region into a plurality of sub-regions; (3) for each of the plurality of sub-regions, computing a mapping to one of the first DRAM, the second DRAM, or the third DRAM based at least in part on the memory utilization characteristic of the virtualized software entity; (4) causing service of each of the plurality of sub-regions from the mapped one of the first DRAM, the second DRAM, or the third DRAM, by issuing one or more update operations against the MMU, by communicating one or more hints to the memory pool, or both; and (5) repeating (1) through (4) during execution of the virtualized software entity. The memory tiering engine may map sub-regions to the first DRAM, the second DRAM, or the third DRAM on a per-sub-region basis using observations of memory accesses to each sub-region, so that the memory tiering engine may operate at any number of sub-regions and across the recited classes of memory utilization characteristic without modification to the mapping logic. At a low corner of the range, the remote memory address region may include three sub-regions, one mapped to each of the first DRAM, the second DRAM, and the third DRAM; the remote memory address region may include a much larger plurality of sub-regions mapped across the first DRAM, the second DRAM, and the third DRAM in a non-uniform distribution that varies during execution. The memory pool may further be coupled via CXL to one or more additional entities each comprising additional DRAM, and the memory tiering engine may further map sub-regions of the remote memory address region to the additional DRAM at the one or more additional entities. The virtualized software entity may be a virtual machine instantiated by a hypervisor running on the processor, may be a container instantiated by a container runtime running on the processor, or may be a function-as-a-service instance instantiated by a serverless platform running on the processor. A virtualized software entity backed by a single DRAM source may be constrained to a capacity and a latency profile determined by that single source, which limits the workloads the virtualized software entity may run efficiently. Because the memory tiering engine maps distinct sub-regions to distinct DRAM sources concurrently, capacity beyond the largest single source may be made available to the virtualized software entity, and sub-regions exhibiting different access characteristics may be mapped to DRAM sources whose latency or bandwidth characteristics match the access behavior of those sub-regions.

In some implementations of the processor, the memory tiering engine comprises an autonomous tiering algorithm engine, the processor further comprising a memory traffic analyzer integrated in the same integrated circuit package as the processing cores, the memory traffic analyzer coupled to the coherent interconnect and configured to collect telemetry of memory access transactions of the processing cores, the telemetry comprising memory access transactions to the remote memory address region and memory access transactions to a local memory address region accessed by the processing cores via the coherent interconnect, and the memory traffic analyzer further configured to provide the telemetry to the autonomous tiering algorithm engine. The memory traffic analyzer may be implemented as a spatio-temporal sampling circuit that snoops the coherent interconnect, or alternatively as firmware that samples performance-monitoring counters of the processing cores. The memory traffic analyzer may provide the telemetry to the autonomous tiering algorithm engine as access frequency histograms, residency dwell times, or both. Because the memory traffic analyzer sees memory access transactions to both the remote memory address region and the local memory address region, the autonomous tiering algorithm engine may compare local and remote access characteristics in deciding sub-region placement.

In some implementations of the processor, the memory tiering engine is located on at least one of: a compute die comprising the processing cores, an input/output die different from the compute die and within the same integrated circuit package as the compute die, or a chiplet within the same integrated circuit package as the compute die, and wherein the memory tiering engine is coupled to the coherent interconnect via an on-package interconnect such that the memory tiering engine receives information about memory access transactions traversing the coherent interconnect. The on-package interconnect coupling the memory tiering engine to the coherent interconnect may be a Universal Chiplet Interconnect Express (UCIe) link, a proprietary on-package fabric of the processor, or a coherent extension of the coherent interconnect itself. When the memory tiering engine is located on an input/output die, the input/output die may also host the CXL port and a memory controller, with the memory tiering engine coupled to both. Because the memory tiering engine is on the same integrated circuit package as the processing cores and is coupled to the coherent interconnect via the on-package interconnect, latency for transferring telemetry to the memory tiering engine may be reduced relative to off-package placements.

In some implementations of the processor, the memory utilization characteristic of the virtualized software entity comprises at least one of: an allocated memory size of the virtualized software entity, a utilized memory size of the virtualized software entity, a memory access pattern of the virtualized software entity, a working-set size of the virtualized software entity, or a memory access heat-map of the virtualized software entity, and wherein the memory tiering engine is further configured to identify, based at least in part on the memory utilization characteristic, one or more first sub-regions of the remote memory address region exhibiting a higher access frequency than one or more second sub-regions of the remote memory address region, and to map the one or more first sub-regions and the one or more second sub-regions to different ones of the first DRAM, the second DRAM, and the third DRAM. The memory utilization characteristic may be computed by sampling memory access transactions of the virtualized software entity during a sliding time window and aggregating per-sub-region counts. Alternatively, the memory utilization characteristic may be derived from page-table accessed-bit scans, from CXL.mem traffic statistics reported by the memory pool, or from a combination thereof. The first DRAM, the second DRAM, and the third DRAM may differ in memory access latency, bandwidth, or both, and the memory tiering engine may map first sub-regions exhibiting higher access frequency to one having lower memory access latency, so that workload latency observed by the virtualized software entity may be reduced.

In some implementations of the processor, the CXL port is configured to communicate according to CXL.mem with the memory pool, and the first DRAM, the second DRAM, and the third DRAM are exposed to the processor as byte-addressable memory accessible via load and store operations issued by the processing cores during execution of the virtualized software entity. The CXL port may be configured as a CXL root port or as a CXL downstream switch port operating according to CXL.mem. Memory access transactions of the virtualized software entity may be issued by the processing cores as ordinary load and store instructions targeting addresses within the remote memory address region; the addresses may resolve through the MMU to physical addresses that reach the first DRAM, the second DRAM, or the third DRAM via the CXL port. Alternatively, transactions may be issued via uncacheable load and store paths for portions of the remote memory address region designated as such by the memory tiering engine.

In some implementations of the processor, the memory tiering engine is further configured to update the mapping of one or more of the distinct sub-regions during execution of the virtualized software entity based at least in part on memory accesses to the remote memory address region observed during execution of the virtualized software entity, and to cause migration of data of the one or more of the distinct sub-regions from a current one of the first DRAM, the second DRAM, or the third DRAM to a different one of the first DRAM, the second DRAM, or the third DRAM in accordance with the updated mapping, without interrupting execution of the virtualized software entity. The update may be triggered by an access-frequency threshold crossing, by a periodic timer, or by an external instruction from a fabric manager. Migration of data of a sub-region may be performed by a direct-memory-access circuit copying contents between the current DRAM and the different DRAM, followed by an atomic switch of the MMU mapping for the sub-region. During migration, accesses to the sub-region may be paused briefly or redirected via a shadow mapping so that the virtualized software entity is not interrupted.

In some implementations of the processor, the memory tiering engine is further configured to observe, by virtue of being integrated in the same integrated circuit package as the processing cores, both memory access transactions of the processing cores to a local memory address region accessed via the coherent interconnect and memory access transactions of the processing cores to the remote memory address region, and to base the mapping of distinct sub-regions of the remote memory address region on a comparison of access characteristics of the local memory address region with access characteristics of the remote memory address region. The comparison may identify sub-regions of the remote memory address region whose access frequency rivals that of the local memory address region; such sub-regions may be candidates for placement on one of the three DRAM sources having lowest access latency. The memory tiering engine may alternatively identify a balance ratio between local and remote access counts and use the ratio to gate placement decisions. Because the memory tiering engine sees both local and remote transactions on the same integrated circuit package, an off-package equivalent restricted to only one of the two transaction sets may produce inferior placements.

In some implementations of the processor, the memory tiering engine is coupled to the MMU and is further configured to cause the MMU to update one or more mappings of the virtual addresses utilized by the virtualized software entity, the one or more updated mappings redirecting memory access requests corresponding to a sub-region of the remote memory address region from a first one of the first DRAM, the second DRAM, or the third DRAM to a second one of the first DRAM, the second DRAM, or the third DRAM. The memory tiering engine may issue MMU update operations as page-table entry rewrites, as TLB shootdown messages, or both, depending on the granularity of the sub-region. Alternatively, the memory tiering engine may write a steering table consumed by the MMU during address translation, with the steering table selecting the destination DRAM for each sub-region. Because the memory tiering engine is coupled to the MMU on the same integrated circuit package, the MMU update may complete with low latency and without round-trips to an off-package decision element.

In some implementations of the processor, the memory tiering engine is further configured to grade the first DRAM, the second DRAM, and the third DRAM by a topological distance along a CXL link coupling between the processor and the first DRAM, between the processor and the second DRAM, and between the processor and the third DRAM, respectively, and to map sub-regions of the remote memory address region exhibiting higher access frequencies to one of the first DRAM, the second DRAM, or the third DRAM having a lower topological distance to the processor than to another one of the first DRAM, the second DRAM, or the third DRAM having a higher topological distance to the processor. The topological distance may be measured as a number of CXL switch hops along the CXL coupling, as a calibrated round-trip access latency, or as a vendor-supplied grading label communicated to the memory tiering engine over a management channel. The memory tiering engine may store the gradings in a register file and update them when the CXL fabric topology changes. Because higher-access-frequency sub-regions are placed on lower-topological-distance DRAM, average memory access latency observed by the virtualized software entity may be reduced.

FIG. 8B illustrates an example of a system that includes at least a first entity, a memory pool, a second entity, a third entity, and a memory tiering engine. The first entity may execute a virtualized software entity that utilizes a remote memory address region. The memory pool may include first DRAM and may expose the remote memory address region to the first entity over a CXL link. The second entity may include second DRAM coupled to the memory pool via CXL. And the third entity may include third DRAM coupled to the memory pool via CXL. The memory tiering engine may map distinct sub-regions of the remote memory address region to distinct ones of the first DRAM, the second DRAM, and the third DRAM based on a memory utilization characteristic of the virtualized software entity, such that at a given time during execution of the virtualized software entity three sub-regions of the remote memory address region are mapped concurrently to the first DRAM, the second DRAM, and the third DRAM. The memory tiering engine may be coupled to the memory pool over a management channel as shown, may instead be located within the memory pool, may be located on the first entity, may be located on a fabric manager communicatively coupled to the memory pool, may be located on a CXL switch coupling the first entity to the memory pool, or may be distributed across multiple of these locations with results aggregated. The memory pool may include a CXL switch, a switch application-specific IC, a switch appliance, or switching circuitry integrated with the first DRAM in a single device. The memory pool may further include a resource composer that aggregates the first DRAM, the second DRAM, and the third DRAM into the remote memory address region exposed to the first entity, receives the mapping of distinct sub-regions from the memory tiering engine, and routes memory access requests of the virtualized software entity to the mapped one of the first DRAM, the second DRAM, or the third DRAM. The first entity may be a host running a hypervisor that instantiates the virtualized software entity, a container runtime, or a serverless platform; the second entity and the third entity may each be a host, a device, a GPU, or an accelerator, and may be of different entity types from each other.

In various implementations, a system comprising: a first entity configured to execute a virtualized software entity selected from a virtual machine, a container, or a function-as-a-service instance, wherein the virtualized software entity is configured to utilize a remote memory address region; a memory pool coupled to the first entity via a first Compute Express Link (CXL) link, the memory pool comprising first dynamic random-access memory (DRAM), the memory pool configured to expose the remote memory address region to the first entity via the first CXL link; a second entity comprising second DRAM coupled to the memory pool via a second CXL link; a third entity comprising third DRAM coupled to the memory pool via a third CXL link; and a memory tiering engine configured to map first, second, and third sub-regions of the remote memory address region to the first DRAM, the second DRAM, and the third DRAM, respectively, based at least in part on a memory utilization characteristic of the virtualized software entity, such that, at a given time during execution of the virtualized software entity, the first sub-region of the remote memory address region is mapped to the first DRAM, the second sub-region of the remote memory address region is mapped to the second DRAM, and the third sub-region of the remote memory address region is mapped to the third DRAM. The system may be implemented as a single rack with the first entity, the memory pool, the second entity, and the third entity coupled by a CXL switch, as multiple racks each housing a subset of the entities and the memory pool with cross-rack CXL fabric extending between the racks, or as a converged appliance combining the first entity and the memory pool in a single chassis with the second and third entities reached over external CXL ports. The first entity may be a host, a GPU, an accelerator, or a bare-metal compute instance. The memory pool may be implemented as a switch ASIC with embedded memory controllers, as a memory expander appliance with a CXL fabric-facing port, or as a converged switch-plus-memory-pool device. The memory tiering engine may be implemented as a finite state machine within a controller of the memory pool, as firmware running on a fabric manager processor, as code executed by a hypervisor at the first entity, or as a combination of cooperating instances at multiple locations. Operation of the memory tiering engine may proceed by: (1) collecting telemetry of memory access transactions of the virtualized software entity to the remote memory address region; (2) partitioning the remote memory address region into a plurality of sub-regions; (3) for each of the plurality of sub-regions, computing a mapping to one of the first DRAM, the second DRAM, or the third DRAM based at least in part on the memory utilization characteristic of the virtualized software entity; (4) communicating the mapping to a routing element of the memory pool, to the first entity, or to both, so that memory access transactions of the virtualized software entity corresponding to a sub-region are directed to the mapped one of the first DRAM, the second DRAM, or the third DRAM; and (5) repeating (1) through (4) during execution of the virtualized software entity. The memory tiering engine may map sub-regions on a per-sub-region basis using observations of memory accesses, so that the mapping may operate at any number of sub-regions and any number of DRAM sources without modification to the mapping logic. At a low corner of the range, the remote memory address region may include three sub-regions, one mapped to each of the first DRAM, the second DRAM, and the third DRAM; the remote memory address region may include a much larger plurality of sub-regions mapped across the three DRAM sources in a non-uniform and time-varying distribution. The memory pool may further be coupled via CXL to one or more additional entities each comprising additional DRAM, and the memory tiering engine may further map sub-regions of the remote memory address region to the additional DRAM at the one or more additional entities, so that the system may support concurrent multi-source provisioning beyond three sources. A virtualized software entity backed by a single DRAM source may be capacity-constrained and unable to place portions of its address space on DRAM whose access characteristics match the access behavior of those portions. Because the memory tiering engine maps distinct sub-regions to distinct DRAM sources concurrently, aggregate capacity beyond the largest single source may be made available, and sub-regions may be mapped to DRAM sources whose latency or bandwidth characteristics suit the access behavior of those sub-regions, so that workload performance of the virtualized software entity may be improved.

In some implementations of the system, the memory tiering engine comprises an autonomous tiering algorithm engine, the system further comprising a memory traffic analyzer configured to collect telemetry of memory access transactions of the virtualized software entity to the remote memory address region and to provide an access characterization based on the telemetry to the autonomous tiering algorithm engine, and the autonomous tiering algorithm engine is configured to base the mapping of distinct sub-regions at least in part on the access characterization. The memory traffic analyzer may be located on the memory pool, on a CXL switch coupling the first entity to the memory pool, on the first entity itself, or distributed across multiple of these locations with results aggregated. The access characterization may include per-sub-region access frequencies, per-sub-region access latencies, or both. Because the autonomous tiering algorithm engine bases the mapping on the access characterization, the mapping may track access behavior of the virtualized software entity as it evolves.

In some implementations of the system, the memory utilization characteristic comprises a utilized memory size of the virtualized software entity, the utilized memory size being smaller than an allocated memory size of the virtualized software entity, and the memory tiering engine is further configured to map the distinct sub-regions to the distinct ones of the first DRAM, the second DRAM, and the third DRAM for portions of the remote memory address region utilized by the virtualized software entity, and to forgo mapping physical memory for portions of the remote memory address region not utilized by the virtualized software entity. The utilized memory size may be derived from page-table accessed bits, from accessed-page sampling by a hypervisor, or from page-fault telemetry over a sliding time window. Sub-regions corresponding to unutilized portions of the remote memory address region may remain unmapped to physical memory until first access. Because unutilized portions are not backed by physical memory, capacity of the first, second, and third DRAM may be allocated to virtualized software entities with active access demand.

In some implementations of the system, the memory utilization characteristic comprises a memory access pattern of the virtualized software entity, the memory access pattern comprising at least one of a temporal access locality or a spatial access locality of the virtualized software entity, and the memory tiering engine is further configured to map sub-regions exhibiting a first temporal or spatial access locality to a different one of the first DRAM, the second DRAM, or the third DRAM than sub-regions exhibiting a second temporal or spatial access locality. Temporal access locality may be measured as inter-access dwell times between successive accesses to the same sub-region; spatial access locality may be measured as a cluster radius across nearby sub-regions accessed within a time window. Sub-regions with high temporal locality may be placed on lower-latency DRAM to maximize hit-time benefit, while sub-regions with high spatial locality may be placed on higher-bandwidth DRAM to favor burst transfers.

In some implementations of the system, the memory utilization characteristic comprises a working-set size of the virtualized software entity, the working-set representing a subset of the remote memory address region accessed by the virtualized software entity during a time window, and the memory tiering engine is further configured to map sub-regions corresponding to the working-set to one of the first DRAM, the second DRAM, or the third DRAM having lower memory access latency than another one of the first DRAM, the second DRAM, or the third DRAM to which sub-regions outside the working-set are mapped. The working-set may be determined from accessed-bit scans aggregated over the time window, from sampled page touches, or from access-frequency histograms that is threshold at a working-set boundary. The time window may be configured by a fabric manager or by the hypervisor at the first entity. Because the working-set is placed on lower-latency DRAM, the access latency observed by the virtualized software entity for the bulk of its active accesses may be lower than if the working-set were distributed across higher-latency sources.

In some implementations of the system, the memory utilization characteristic comprises a memory access heat-map of the virtualized software entity, the memory access heat-map comprising a plurality of heat values, each heat value corresponding to one or more sub-regions of the remote memory address region and indicating an access frequency of the one or more sub-regions during a time window, and wherein the heat-map comprises at least three distinct heat values resolving access frequencies at a granularity finer than a two-level hot-cold distinction, and the memory tiering engine is further configured to map each of the distinct sub-regions to one of the first DRAM, the second DRAM, or the third DRAM based at least in part on the heat value corresponding to the sub-region. The heat-map may be stored as a per-sub-region array of multi-bit counters, as a logarithmic exponential-moving-average register file, or as a Bloom-filter-backed histogram. Heat values may be updated by sampling memory access transactions; the sampling rate may be programmable. Because the heat-map resolves access frequencies at a granularity finer than a two-level hot-cold distinction, sub-regions whose access frequencies fall between extremes may be placed on a middle-grade DRAM source.

In some implementations of the system, the memory tiering engine is located on at least one of: the memory pool, the first entity, a fabric manager communicatively coupled to the memory pool, or a CXL switch coupling the first entity to the memory pool, and the memory tiering engine is coupled to a data path within the at least one of the memory pool, the first entity, the fabric manager, or the CXL switch such that the memory tiering engine receives information about memory access transactions of the virtualized software entity to the remote memory address region traversing the data path. The memory tiering engine located on the memory pool may snoop a switch fabric of the memory pool; the memory tiering engine located on a CXL switch may snoop the switch's CXL.mem traffic flow; the memory tiering engine located on the first entity may snoop the coherent interconnect of the first entity; the memory tiering engine located on a fabric manager may receive aggregated telemetry from one or more of the foregoing. Multiple instances of the memory tiering engine may cooperate, with one acting as a primary and others reporting upward.

In some implementations of the system, the second entity and the third entity are of different entity types, each entity type selected from a host, a device, a graphics processing unit (GPU), or an accelerator, the second DRAM has memory access characteristics different from memory access characteristics of the third DRAM, and the memory tiering engine is further configured to map sub-regions of the remote memory address region exhibiting first access patterns matching the memory access characteristics of the second DRAM to the second DRAM, and to map sub-regions of the remote memory address region exhibiting second access patterns matching the memory access characteristics of the third DRAM to the third DRAM. Memory access characteristics of a DRAM source may include access latency, sustained bandwidth, burst-length efficiency, and queueing behavior under contention. Sub-regions of the virtualized software entity dominated by random small-block accesses may match low-latency DRAM at a host-type peer, while sub-regions dominated by long-burst sequential accesses may match high-bandwidth DRAM at a GPU or accelerator peer. The memory tiering engine may maintain per-source characterization profiles and a matching table.

In some implementations of the system, the CXL link is configured to support CXL.mem, the first DRAM, the second DRAM, and the third DRAM are exposed to the first entity as byte-addressable memory accessible via load and store operations issued during execution of the virtualized software entity, and at least one of the second DRAM or the third DRAM is accessible to the first entity via the memory pool as a single byte-addressable address space spanning the first DRAM, the second DRAM, and the third DRAM. The memory pool may present the single byte-addressable address space to the first entity as a host physical address range mapped contiguously over the three DRAM sources, with internal routing of access transactions to the correct DRAM performed by the memory pool. Alternatively, the single byte-addressable address space may be presented as a non-contiguous union of disjoint ranges, each backed by one of the DRAM sources. Because the three DRAM sources appear as a single byte-addressable address space, the virtualized software entity may issue load and store operations to the remote memory address region without protocol-specific accommodations per source.

In some implementations of the system, the memory tiering engine is further configured to update the mapping of one or more of the distinct sub-regions during execution of the virtualized software entity based at least in part on memory accesses to the remote memory address region observed during execution of the virtualized software entity, and to cause migration of data of the one or more of the distinct sub-regions between the first DRAM, the second DRAM, and the third DRAM in accordance with the updated mapping, without interrupting execution of the virtualized software entity. Migration of data between the three DRAM sources may be performed by a direct-memory-access circuit within the memory pool, by a copy circuit at the source or destination entity, or by a software copy routine executed by a fabric manager. During migration, access transactions to the sub-region being migrated may be redirected via shadow mappings so that the virtualized software entity is not interrupted. The update frequency may be configured by a fabric manager.

In some implementations of the system, the memory pool comprises at least one of: a CXL switch, a switch application-specific integrated circuit (ASIC), a switch appliance, or switching circuitry integrated within the memory pool, and at least one of the second DRAM at the second entity or the third DRAM at the third entity is coupled to the first DRAM at the memory pool via the at least one of the CXL switch, the switch ASIC, the switch appliance, or the switching circuitry, such that memory access requests of the virtualized software entity to the remote memory address region are routed through the at least one of the CXL switch, the switch ASIC, the switch appliance, or the switching circuitry to the second DRAM or the third DRAM. The switching circuitry of the memory pool may also expose a logical NVMe device frontend to the first entity, with the logical NVMe device backed by capacity from the first, second, or third DRAM; the first entity may then access the remote memory address region either via direct CXL.mem load and store operations or via NVMe commands translated by the memory pool. Alternatively, the switching circuitry may be a dedicated CXL switch ASIC located on a printed circuit board of the memory pool.

In some implementations of the system, the memory pool further comprises a resource composer configured to aggregate the first DRAM, the second DRAM, and the third DRAM into the remote memory address region exposed to the first entity, the resource composer further configured to receive the mapping of distinct sub-regions from the memory tiering engine, and to route memory access requests of the virtualized software entity to the mapped one of the first DRAM, the second DRAM, or the third DRAM in accordance with the mapping. The resource composer may be implemented as control firmware running on a microcontroller of the memory pool, as a hardware finite state machine within the switching circuitry of the memory pool, or as a combination thereof. The resource composer may receive the mapping from the memory tiering engine over a management channel of the memory pool, may store the mapping in a register file used by routing circuitry, and may update the register file atomically when the memory tiering engine issues an updated mapping.

In various implementations, a method comprising: executing, by a first entity, a virtualized software entity selected from a virtual machine, a container, or a function-as-a-service instance, wherein the virtualized software entity utilizes a remote memory address region; exposing the remote memory address region to the first entity, by a memory pool coupled to the first entity via a first Compute Express Link (CXL) link, wherein the memory pool comprises first dynamic random-access memory (DRAM), the memory pool further coupled via a second CXL link to a second entity comprising second DRAM, and the memory pool further coupled via a third CXL link to a third entity comprising third DRAM; and mapping, by a memory tiering engine, first, second, and third sub-regions of the remote memory address region to the first DRAM, the second DRAM, and the third DRAM, respectively, based at least in part on a memory utilization characteristic of the virtualized software entity, such that, at a given time during execution of the virtualized software entity, a first sub-region of the remote memory address region is mapped to the first DRAM, a second sub-region of the remote memory address region is mapped to the second DRAM, and a third sub-region of the remote memory address region is mapped to the third DRAM. The method may be performed by a fabric manager comprising a processor coupled to a memory storing instructions that, when executed by the processor, cause the fabric manager to perform the executing, exposing, and mapping steps; by a hypervisor running on the first entity, comprising a processor and a memory; by control firmware of the memory pool running on a microcontroller coupled to a memory storing the firmware; or by a combination of cooperating entities each comprising a processor and a memory. The mapping step may be performed by: (1) collecting telemetry of memory access transactions of the virtualized software entity to the remote memory address region during execution of the virtualized software entity; (2) partitioning the remote memory address region into a plurality of sub-regions; (3) for each of the plurality of sub-regions, computing an mapping to one of the first DRAM, the second DRAM, or the third DRAM based at least in part on the memory utilization characteristic of the virtualized software entity; and (4) causing service of each of the plurality of sub-regions from the mapped one of the first DRAM, the second DRAM, or the third DRAM. The method may further include repeating (1) through (4) during execution of the virtualized software entity. The mapping may operate on a per-sub-region basis using observations of memory accesses, so that the method may apply at any number of sub-regions, any classes of memory utilization characteristic recited, and any number of DRAM sources reachable via the memory pool without modification to the mapping logic. At a low corner of the range, three sub-regions may be mapped one each to the three DRAM sources; a much larger plurality of sub-regions may be mapped non-uniformly and time-varyingly. The method may further include coupling the memory pool via CXL to one or more additional entities each comprising additional DRAM, and mapping sub-regions of the remote memory address region to the additional DRAM. A virtualized software entity backed by a single DRAM source may be capacity-constrained and unable to place portions of its address space on DRAM whose access characteristics match the access behavior of those portions. Because the mapping places distinct sub-regions on distinct DRAM sources concurrently, aggregate capacity beyond the largest single source may be made available, and sub-regions may be mapped to DRAM sources whose characteristics suit those sub-regions, so that workload performance of the virtualized software entity may be improved.

In some implementations of the method, the memory utilization characteristic comprises a memory access heat-map of the virtualized software entity, the memory access heat-map comprising a plurality of heat values each corresponding to one or more sub-regions of the remote memory address region, the heat-map comprising at least three distinct heat values resolving access frequencies at a granularity finer than a two-level hot-cold distinction, and the mapping comprises mapping each of the distinct sub-regions to one of the first DRAM, the second DRAM, or the third DRAM based at least in part on the heat value corresponding to the sub-region. The heat values may be updated by sampling memory access transactions at a programmable sampling rate, with heat values stored in a register file or in a region of one of the DRAM sources reserved for heat-map storage. Alternatively, heat values may be derived from page-table accessed-bit scans performed by the first entity. Because the heat-map resolves access frequencies at a granularity finer than two levels, sub-regions of intermediate access frequency may be placed on a middle-grade source.

In some implementations, the method further comprises updating, by the memory tiering engine during execution of the virtualized software entity, the mapping of one or more of the distinct sub-regions based at least in part on memory accesses to the remote memory address region observed during execution of the virtualized software entity, and migrating data of the one or more of the distinct sub-regions between the first DRAM, the second DRAM, and the third DRAM in accordance with the updated mapping, without interrupting the execution of the virtualized software entity. The migrating may be performed by a direct-memory-access circuit issuing read transactions against a source DRAM and write transactions against a destination DRAM, with the source and destination selected from the first, second, and third DRAM. The migrating may be paced to limit interference with foreground memory access transactions of the virtualized software entity. During migration, accesses to the sub-region being migrated may be redirected via a shadow mapping.

In some implementations of the method, the memory tiering engine comprises an autonomous tiering algorithm engine, the method further comprising collecting, by a memory traffic analyzer, telemetry of memory access transactions of the virtualized software entity to the remote memory address region, and providing the telemetry to the autonomous tiering algorithm engine, wherein the mapping by the memory tiering engine is further based at least in part on the telemetry. The memory traffic analyzer may be located on the memory pool, on the first entity, on a CXL switch coupling the first entity to the memory pool, on a fabric manager communicatively coupled to the memory pool, or distributed across multiple of these locations. The telemetry may include per-sub-region access frequencies, per-sub-region access latencies, or both, summarized over a sliding time window before being provided to the autonomous tiering algorithm engine.

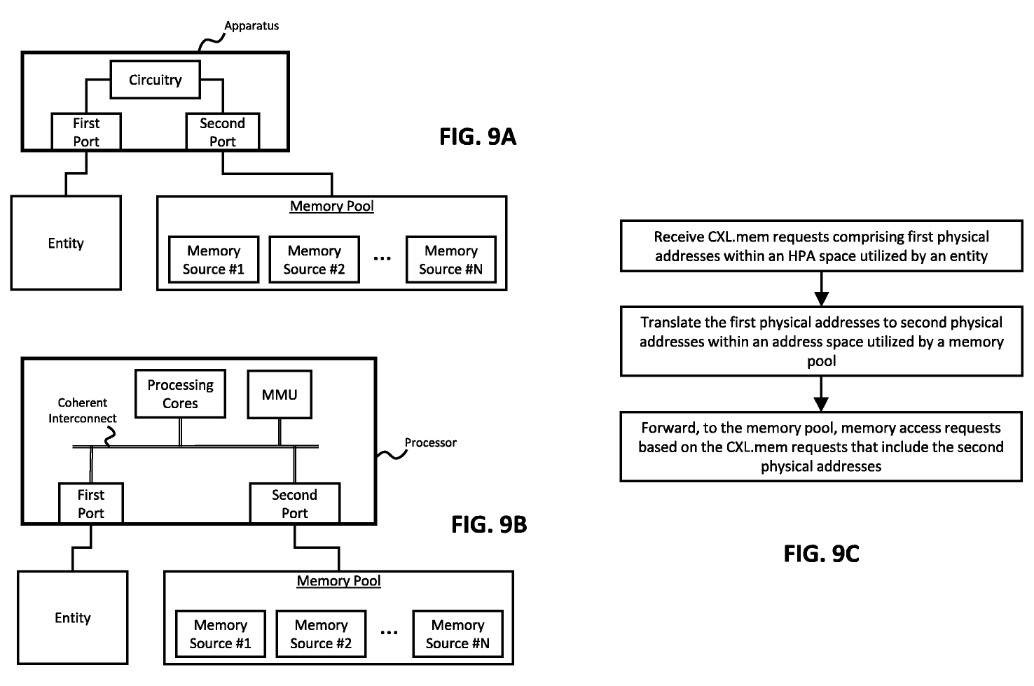

FIG. 9A illustrates an example of an entity, an apparatus, and a memory pool. The apparatus includes a first port, circuitry, and a second port, with the circuitry coupled to the first port and to the second port. The entity utilizes an HPA space and issues CXL.mem requests carrying first physical addresses within the HPA space, and the first port receives the CXL.mem requests from the entity. The memory pool comprises memory contributed by at least two memory sources, shown as a first memory source, a second memory source, and an Nth memory source, with the memory locations of the memory pool referenced by physical addresses within an address space utilized by the memory pool. The circuitry translates the first physical addresses to second physical addresses within the address space utilized by the memory pool, and forwards, via the second port coupled to the memory pool, memory access requests that are based on the CXL.mem requests and that carry the second physical addresses, and the second port communicates with the memory pool over the resulting path.

Memory may be disaggregated across a rack, with memory capacity provisioned independently of compute, and an entity demanding additional memory may draw on capacity contributed by other sources in the rack rather than on memory local to that entity. Some implementations relate to an apparatus positioned between an entity and such pooled memory, where the entity issues memory-protocol requests carrying addresses within the address space the entity uses, and the pooled memory is referenced by addresses within a different address space. The apparatus may translate the addresses carried by the requests into addresses within the pooled-memory address space, and forward the requests toward the pool. A technical problem that may arise where memory is pooled from two or more sources is reconciling addresses used by an entity with addresses used by the pool; some implementations may help address this and/or other technical problems, among other things.

In various implementations, an apparatus comprising: a first port configured to receive CXL.mem requests from an entity, the CXL.mem requests comprising first physical addresses within a host physical address (HPA) space utilized by the entity, wherein CXL denotes Compute Express Link; a second port configured to communicate with a memory pool, the memory pool comprising memory contributed by at least two memory sources, and memory locations within the memory pool referenced by second physical addresses within an address space utilized by the memory pool; and circuitry coupled to the first port and to the second port, the circuitry configured to translate the first physical addresses of the CXL.mem requests to the second physical addresses within the address space utilized by the memory pool. The apparatus may be a switch device, a gateway device at a rack boundary, or circuitry within a larger device. The circuitry may be implemented as a finite state machine in a switch device, as firmware executing on an embedded processor of a gateway device, or as a combination of fixed-function datapath circuitry and firmware. The translation of the first physical addresses to the second physical addresses may be performed by the circuitry, for example by: (1) extracting a first physical address from a received CXL.mem request; (2) selecting, based on the first physical address, an entry of a translation structure maintained by the circuitry, the entry indicating a second physical address within the address space utilized by the memory pool; and (3) producing a memory access request that carries the second physical address. The circuitry may forward the produced memory access request by emitting it on the second port coupled to the memory pool. The circuitry may translate using a per-source offset, a lookup table indexed by a portion of a first physical address, or a base-and-bound calculation, so that the same translation operation may apply regardless of how many sources contribute to the memory pool and regardless of the size of either address space; at one corner the memory pool may aggregate two sources, and at another the memory pool may aggregate a larger number of sources without change to the translation operation. Potential advantages of some implementations may include, without limitation, making memory capacity contributed by two or more sources available to an entity, and allowing the entity to reach that capacity using addresses within the HPA space utilized by the entity. A given implementation need not provide any particular advantage.

In some implementations of the apparatus, the circuitry is further configured to forward memory access requests that are based on the CXL.mem requests and that comprise the second physical addresses toward the memory pool via the second port, such that the apparatus performs the address translation between addresses within the HPA space utilized by the entity and addresses within the address space utilized by the memory pool; and the circuitry is further configured to write the second physical addresses into address fields of the CXL.mem requests, and to forward the CXL.mem requests carrying the second physical addresses in the address fields toward the memory pool via the second port. Writing the second physical addresses into the address fields may include overwriting an address field of a received CXL.mem request in place, and the request, with its address field modified, may then be forwarded on the second port. The circuitry may instead construct a request that copies non-address fields from the received CXL.mem request and inserts a second physical address. A memory pool receiving such a request may process it as an ordinary CXL.mem request, without performing address translation of its own.

In some implementations of the apparatus, the CXL.mem requests comprise Master-to-Subordinate (M2S) requests; and wherein the circuitry is further configured to: receive, via the second port, Subordinate-to-Master (S2M) responses from the memory pool corresponding to the M2S requests; and forward the S2M responses via the first port to the entity. The circuitry may retain a correlation between a forwarded request and the entity that originated it, such as a tag table keyed by a request identifier, and a Subordinate-to-Master response may be matched to the Master-to-Subordinate request it corresponds to and directed toward the first port. The correlation may instead be carried in a transaction identifier of the request. Read data and completions returned by the memory pool may reach the entity that issued the corresponding request, completing the access across the address-space boundary.

In some implementations of the apparatus, the circuitry is further configured to: maintain an association between the entity and a portion of the address space utilized by the memory pool, translate the first physical addresses to the second physical addresses within the portion based on an identity of the entity, permit the entity to access the portion, and block the entity from accessing another portion of the address space utilized by the memory pool that is associated with a different entity. The association between the entity and the portion may be maintained as an entry of a table indexed by an identity of the entity, such as a port identifier, a link identifier, or a requester identifier carried by or inferred from the CXL.mem requests, the entry indicating a base and a bound that delimit the portion within the address space utilized by the memory pool. The circuitry may translate by adding the base of the indicated portion to a value derived from a first physical address, and may compare a result against the bound to confirm the result falls within the portion. Permitting access may include forwarding a request whose translated address falls within the portion, and blocking access may include declining to forward, or returning an error for, a request whose translated address would fall in a portion associated with a different entity. The identity may instead be established at connection setup and bound to the first port. Distinct entities may share the memory pool while each is restricted to its own portion, supporting multi-tenant use of the memory pool.

In some implementations of the apparatus, the at least two memory sources comprise a first memory source and a second memory source; and wherein the circuitry is further configured to translate the first physical addresses to second physical addresses interleaved across the first memory source and the second memory source. Interleaving across the first memory source and the second memory source may include mapping consecutive ranges of first physical addresses alternately to the first memory source and to the second memory source, such as by using a portion of a first physical address as a source selector and a remaining portion as an offset within a selected source. An interleave granularity may be a cache line, a page, or a larger region. Distributing consecutive ranges across the two sources may spread access directed at the memory pool across the first memory source and the second memory source.

In some implementations of the apparatus, the apparatus operates as a rack-level gateway to the memory pool; and wherein the memory pool comprises at least one of: a Central Processing Unit (CPU) configured to aggregate the memory contributed by the at least two memory sources and to expose the aggregated memory to the apparatus via the second port, or a memory appliance configured to aggregate the memory contributed by the at least two memory sources and to expose the aggregated memory to the apparatus via the second port. As a rack-level gateway, the apparatus may sit at a boundary of a rack and present the memory pool to the entity over the first port. The CPU forming the memory pool may aggregate the contributed memory by mapping it into a single address space exposed on the second port, while the memory appliance may be a dedicated chassis housing memory devices together with circuitry that performs the aggregation. The entity may address the memory pool as a single target through the apparatus, independent of how the memory pool aggregates memory internally.

In some implementations of the apparatus, the at least two memory sources comprise a first host and a second host; wherein the first host comprises first processing cores configured to access a first dynamic random-access memory (DRAM) attached to the first host; wherein the second host comprises second processing cores configured to access a second DRAM attached to the second host; and wherein the memory pool aggregates the first DRAM and the second DRAM. The first host and the second host may each be a server in which the first processing cores or the second processing cores use a portion of the attached first DRAM or second DRAM locally while a remaining portion is contributed to the memory pool, such as a portion that a host workload is not using. Memory that a host is not using locally may be made available to other entities through the memory pool, putting otherwise idle capacity to use.

In some implementations of the apparatus, the memory contributed by the at least two memory sources is exposed to the entity, via the apparatus, as byte-addressable memory accessible by load operations and store operations of the entity. Exposing the memory as byte-addressable may include presenting the memory pool to the entity for access of individual locations by load operations and store operations carried in the CXL.mem requests. A load operation may read a location addressed within the HPA space, and a store operation may write such a location.

In some implementations, the apparatus further comprises a third port configured to receive CXL.mem requests from a second entity, the CXL.mem requests from the second entity comprising third physical addresses within a second HPA space utilized by the second entity; wherein the circuitry is further configured to translate the third physical addresses to fourth physical addresses within the address space utilized by the memory pool, and to forward memory access requests that are based on the CXL.mem requests from the second entity and that comprise the fourth physical addresses toward the memory pool via the second port. The third port may be a separate physical port, or a logical port multiplexed with the first port over a shared link. The circuitry may maintain a separate translation context for the second entity, and the third physical addresses within the second HPA space may be translated to fourth physical addresses within the address space utilized by the memory pool independently of the translation performed for the entity. A single apparatus may serve the entity and the second entity, consolidating access to the memory pool at one gateway.

In some implementations of the apparatus, at least one of the at least two memory sources comprises an accelerator; and wherein the second port is configured to communicate with the memory pool over a link operating according to at least one of: NVLink, Ultra Accelerator Link (UALink), or Ethernet Scale-Up Networking (ESUN). The accelerator contributing to the memory pool may be a graphics accelerator or a tensor accelerator that exposes a portion of its attached memory to the memory pool. The second port may communicate over a link operating according to NVLink, Ultra Accelerator Link, or Ethernet Scale-Up Networking, and the circuitry may convey the forwarded memory access requests over that link toward the accelerator. The memory pool may include memory attached to an accelerator and reached over a scale-up fabric distinct from the link facing the entity.

FIG. 9B illustrates an example of an entity, a processor, and a memory pool. The processor includes processing cores coupled via a coherent interconnect, an MMU, a first port, and a second port. The processing cores utilize physical addresses within a physical address space of the processor to access memory, and the MMU translates virtual addresses utilized by the processing cores to physical addresses within the physical address space of the processor. The entity utilizes an HPA space and issues CXL.mem requests carrying first physical addresses within the HPA space, and the first port receives the CXL.mem requests from the entity. The memory pool comprises memory contributed by at least two memory sources, shown as a first memory source, a second memory source, and an Nth memory source, with the memory locations of the memory pool referenced by physical addresses within an address space utilized by the memory pool. The processor translates the first physical addresses to second physical addresses within the address space utilized by the memory pool, and forwards, via the second port coupled to the memory pool, memory access requests that are based on the CXL.mem requests and that carry the second physical addresses, the translation that produces the second physical addresses being distinct from the translation of virtual addresses to physical addresses performed by the MMU.

The address translation and forwarding may also be performed by a processor that carries out general processing of its own. Some implementations relate to a processor that, in addition to running a workload, operates as a gateway to a memory pool, performing the translation from within the processor using its internal data paths and coherence machinery.

In various implementations, a processor comprising: processing cores coupled via a coherent interconnect, the processing cores configured to utilize physical addresses within a physical address space of the processor to access memory; a memory management unit (MMU) configured to translate virtual addresses, utilized by the processing cores, to physical addresses within the physical address space of the processor; a first port configured to receive CXL.mem requests from an entity, the CXL.mem requests comprising first physical addresses within a host physical address (HPA) space utilized by the entity, wherein CXL denotes Compute Express Link; a second port configured to communicate with a memory pool, the memory pool comprising memory contributed by at least two memory sources, and memory locations within the memory pool referenced by second physical addresses within an address space utilized by the memory pool; and wherein the processor is configured to translate the first physical addresses of the CXL.mem requests to the second physical addresses within the address space utilized by the memory pool. The processor may be implemented as a server processor on a single die, as a multi-die package, or as a system-on-chip; the processing cores may be general-purpose cores coupled by the coherent interconnect, and the MMU may be integrated within a core or shared among the processing cores. The processor may perform the translation of the first physical addresses to the second physical addresses in the manner described above, using a translation structure of the processor, and may forward the resulting memory access request by routing it through the coherent interconnect to the second port. The translation that maps the first physical addresses to the second physical addresses is distinct from the translation of virtual addresses to physical addresses performed by the MMU for the processing cores, and the two may use separate structures.

In some implementations, the processor further comprises a memory controller coupled to the coherent interconnect; wherein the processor is further configured to convey the second physical addresses over the coherent interconnect toward the second port; and wherein the translation of the first physical addresses to the second physical addresses is performed by circuitry integrated with the memory controller. The memory controller may be a controller that also services memory channels local to the processor, with the translation performed by circuitry placed in a data path of the controller. Conveying the second physical addresses over the coherent interconnect may include placing a transaction carrying a second physical address onto the coherent interconnect, which routes the transaction toward the second port. The translation circuitry may instead be placed at the second port while remaining coupled to the coherent interconnect. The forwarded requests may travel over the coherent interconnect that also carries the processing cores' memory traffic, with the translation performed within the processor's memory-controller data path.

In some implementations of the processor, the processor is further configured to update, atomically with respect to memory access transactions of the processing cores, a mapping utilized to translate the first physical addresses to the second physical addresses; and wherein the mapping is maintained in association with the MMU; and wherein the processor is further configured to forward memory access requests that are based on the CXL.mem requests and that comprise the second physical addresses toward the memory pool via the second port, such that the processor performs the address translation between addresses within the HPA space utilized by the entity and addresses within the address space utilized by the memory pool. The mapping may be held in a structure associated with the MMU, such as entries held alongside the page structures the MMU walks. Updating the mapping atomically with respect to memory access transactions of the processing cores may include fencing affected transactions while an entry is replaced, or swapping a pointer to a new mapping in a single operation. The mapping may instead be versioned, and an in-flight transaction may use a consistent version. The mapping may be updated while the processing cores and the entity continue to access memory; reconfiguration of the pool mapping need not halt ongoing access.

In some implementations of the processor, the coherent interconnect comprises at least one of: an Ultra Path Interconnect (UPI) fabric, a Caching/Home Agent (CHA) mesh fabric, an Infinity Fabric, or a Coherent Hub Interface (CHI) fabric; and wherein the processor is further configured to convey the second physical addresses over the coherent interconnect toward the second port. The coherent interconnect may be an UPI fabric, a Caching/Home Agent mesh fabric, an Infinity Fabric, or a CHI fabric. A transaction carrying a second physical address may be issued onto the coherent interconnect and routed toward the second port by routing logic or home-agent logic of the coherent interconnect; for a mesh or hub fabric, a home agent or a home node may order the transaction.

In some implementations of the processor, the processor is coupled to an NVLink chip-to-chip (NVLink-C2C) link; and wherein the processor is further configured to convey at least a portion of the memory access requests comprising the second physical addresses over the NVLink-C2C link toward the second port. The NVLink chip-to-chip link may couple the processor to an adjacent device, such as an accelerator or a companion die. The processor may convey a portion of the memory access requests carrying second physical addresses over the NVLink chip-to-chip link toward the second port while conveying another portion over a different path.

In some implementations of the processor, the first port is configured to receive the CXL.mem requests according to CXL; and wherein the second port is configured to communicate with the memory pool according to a second protocol, the second protocol selected from: a standard interconnect protocol, or a proprietary protocol of a manufacturer of the processor. The first port may receive the CXL.mem requests according to CXL while the second port carries the forwarded memory access requests according to a second protocol. The second protocol may be a standard interconnect protocol, or a protocol proprietary to a manufacturer of the processor, in which case the processor may encapsulate or re-encode the forwarded requests for the second protocol. The interface presented to the entity may remain CXL while the transport toward the memory pool uses a different or vendor-proprietary protocol.

In some implementations of the processor, the processor is configured to translate the first physical addresses to the second physical addresses by at least one of: program instructions executed by the processing cores, or circuitry distinct from the processing cores and configured to perform the translation independently of the processing cores. In a software path, the processing cores may execute program instructions, stored in a memory coupled to the processor, that when executed cause the processor to translate the first physical addresses to the second physical addresses. In a hardware path, circuitry distinct from the processing cores, such as a fixed-function translation block in a data path of the processor, may perform the translation while the processing cores perform other work. The two paths may coexist, with the processing cores configuring the circuitry.

The translation and forwarding may also be expressed as a method, in which an entity's addresses carried by received requests are translated to addresses within the address space of a memory pool aggregating two or more sources and requests carrying the translated addresses are forwarded toward the pool.

In various implementations, a method comprising: receiving, by a first port, CXL.mem requests from an entity, the CXL.mem requests comprising first physical addresses within a host physical address (HPA) space utilized by the entity, wherein CXL denotes Compute Express Link; translating the first physical addresses of the CXL.mem requests to second physical addresses within an address space utilized by a memory pool, the memory pool comprising memory contributed by at least two memory sources; and forwarding, via a second port coupled to the memory pool, memory access requests that are based on the CXL.mem requests, and that comprise the second physical addresses, thereby performing address translation between the first physical addresses within the HPA space utilized by the entity and the second physical addresses within the address space utilized by the memory pool. The receiving, translating, and forwarding may be performed by a processor coupled to a memory storing instructions that, when executed by the processor, cause the receiving, translating, and forwarding to be performed, by firmware on an embedded processor of a switch device or a gateway device, or by fixed-function circuitry. The translating and forwarding may be carried out in the manner described above.

In some implementations of the method, the translating comprises translating the first physical addresses to the second physical addresses within a portion of the address space associated with the entity based on an identity of the entity; and wherein the method further comprises permitting the entity to access the portion, and blocking the entity from accessing another portion of the address space associated with a different entity. The portion may be delimited by a base and a bound recorded for an identity of the entity, such as a requester identifier or a link identifier. Translating within the portion may include adding the base to a value derived from a first physical address; permitting access may include forwarding a request whose translated address falls within the portion; and blocking access may include declining to forward a request whose translated address would fall in a portion of a different entity.

In some implementations of the method, the forwarding comprises writing the second physical addresses into address fields of the CXL.mem requests; and wherein the memory pool is exposed to the entity as byte-addressable memory accessible by load operations and store operations of the entity. Writing the second physical addresses into the address fields may include overwriting an address field of a received CXL.mem request in place before the request is emitted on the second port. Exposing the memory pool as byte-addressable may include presenting locations of the memory pool to the entity for access by load operations and store operations carried in the CXL.mem requests.

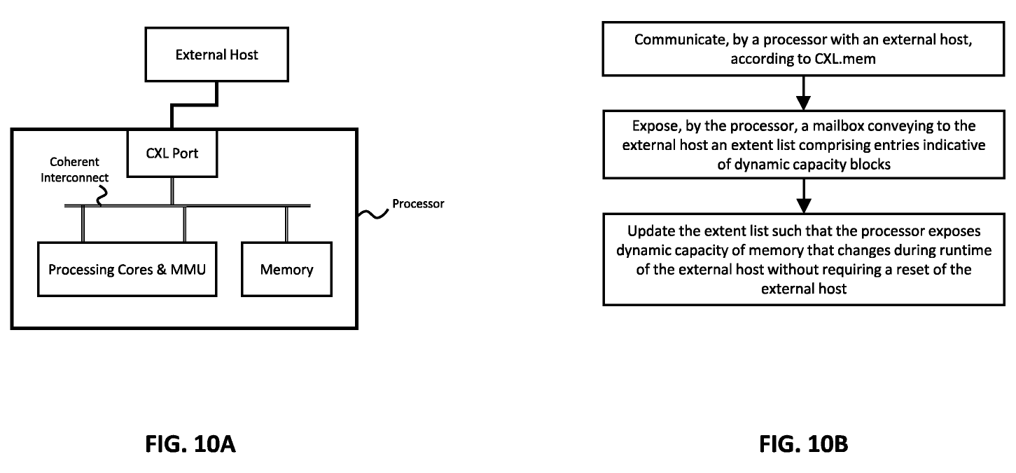

FIG. 10A illustrates an example of a processor comprising processing cores, MMU, and memory (such as DRAM) coupled to a coherent interconnect. The processor may expose, over the CXL port to an external host, a mailbox that conveys an extent list, and the extent list may indicate dynamic capacity blocks of memory residing within the memory.

In computing environments where memory installed in a processor exceeds the memory actively used by the processor's own workloads, there may be scenarios in which the processor makes a portion of its memory available to a separate external host over a CXL connection. The processor may expose, to the external host, a mailbox and an extent list that describe dynamic capacity blocks of memory, and may update the extent list during operation so that the capacity available to the external host changes while the external host continues running. The memory being exposed may remain within the processor's own physical address space and may be mapped by the processor for access by the external host, distinguishing the arrangement from a dedicated memory device whose media is not part of a processor's physical address space.

In various implementations, a processor comprising: processing cores coupled via a coherent interconnect, the processing cores configured to utilize physical addresses within a physical address space of the processor to access memory; a memory management unit (MMU) configured to translate virtual addresses to physical addresses within the physical address space of the processor; a Compute Express Link (CXL) port configured to communicate according to CXL.mem with an external host; wherein the processor is configured to expose, via the CXL port to the external host, a mailbox configured to convey, to the external host, an extent list comprising entries indicative of dynamic capacity blocks of memory exposed by the processor to the external host, the entries indicating at least starting device physical addresses and lengths of the dynamic capacity blocks of memory; and wherein the processor is further configured to update the extent list, such that the processor exposes to the external host, over CXL.mem and via the mailbox, dynamic capacity of memory that changes during runtime of the external host without requiring a reset of the external host. The processor may be implemented as a CPU, a GPU, a data processing unit, a system-on-chip, or as one or more chiplets within an integrated circuit package. The mailbox may be a command interface reachable by the external host over the CXL port, and may be implemented by firmware executing on the processing cores, by a controller, or by hardware circuitry, rather than as a dedicated physical block. Updating the extent list may be performed by a controller or by instructions executed on the processing cores, for example by: receiving an indication of memory available to be offered; writing an entry indicating a starting device physical address and a length; and signaling availability of the entry to the external host. The extent list may describe the dynamic capacity blocks of memory by starting device physical addresses and lengths regardless of how many blocks are described, so that the same mechanism may operate from a single block up to a number of blocks bounded by the memory of the processor; a low corner case may offer a single block of one allocation granule, and a high corner case may offer blocks spanning a large fraction of the memory. Fixed memory capacity may strand installed memory and may require a reboot of a consuming host to change the capacity available to it. Because the processor updates the extent list while the external host continues operating, the capacity available to the external host may change during runtime of the external host without a reset of the external host.

In some implementations of the processor, the processor is further configured to translate addresses, used by the external host to reference the dynamic capacity blocks of memory, to physical addresses within the physical address space of the processor. The translation may map a device-facing address carried in a memory request, such as a device physical address, to an address within the physical address space of the processor, and may be performed by a translation table, by range registers, or by the memory management unit. The device-facing address space and the physical address space of the processor may differ in base, size, or granularity, and the translation may accommodate such differences. Because the addresses are translated into physical addresses within the physical address space of the processor, the memory offered may be the same memory the processing cores access.

In some implementations of the processor, the processor is further configured to expose the dynamic capacity blocks of memory to the external host as a Dynamic Capacity Device (DCD), such that the external host accesses the dynamic capacity blocks of memory as byte-addressable memory by load operations and store operations of the external host. The DCD exposure may present the dynamic capacity blocks of memory so that the external host issues load operations and store operations to the dynamic capacity blocks of memory as it would to locally attached memory, rather than as block transfers or message passing. The load operations and store operations may operate at cache-line granularity. Because the dynamic capacity blocks of memory are accessed by load operations and store operations, software on the external host may use the offered memory without a separate data-copy step.

In some implementations of the processor, the CXL port is further configured to receive, from the external host, CXL.mem Master-to-Subordinate (M2S) requests addressing the dynamic capacity blocks of memory, and wherein the processor is further configured to service the CXL.mem M2S requests from memory within the physical address space of the processor. The CXL.mem M2S requests may include memory read requests and memory write requests directed to the dynamic capacity blocks of memory. The processor may service such a request by translating a carried address into physical addresses within the physical address space of the processor, and returning data from, or writing data to, the corresponding location, where the servicing may be performed by a memory controller of the processor or by a coherent agent. Because the requests are serviced from memory within the physical address space of the processor, the external host may read and write the offered capacity at memory-access latency.

In some implementations of the processor, the entries of the extent list further indicate an extent count and a starting extent index of the dynamic capacity blocks of memory, and wherein the processor is further configured to: convey the extent list to the external host in response to a command received from the external host via the mailbox; and receive, from the external host via the mailbox, a response accepting a dynamic capacity block of memory of the dynamic capacity blocks of memory. The extent count may indicate how many entries the extent list currently contains, and the starting extent index may identify a position from which the external host reads entries, allowing the extent list to be conveyed in portions. The command may request the current extent list, and the response may identify a dynamic capacity block of memory the external host agrees to bring into use. In some examples, the processor may withhold a dynamic capacity block of memory from use by the external host until the response is received.

In some implementations of the processor, the processor is further configured to update the extent list based at least in part on information, obtained via the coherent interconnect, indicative of utilization of the memory by the processing cores. The information may include occupancy of memory regions, access frequency, or allocation state, and may be sampled periodically or accumulated over an interval rather than computed per request. The processor may offer a dynamic capacity block of memory when the information indicates a region is idle, and may withhold or reclaim a dynamic capacity block of memory when the information indicates utilization has risen. Because the extent list is updated from the information, the offered capacity may track memory the processing cores are not using.

In some implementations of the processor, the coherent interconnect comprises at least one of: an Ultra Path Interconnect (UPI) fabric, a Caching/Home Agent (CHA) mesh fabric, an Infinity Fabric, a Coherent Hub Interface (CHI) fabric, or an NVLink Chip-to-Chip (NVLink-C2C) interconnect; and wherein the processor is further configured to derive the information from coherence transactions conveyed on the coherent interconnect. The coherence transactions may include snoop requests, snoop responses, and writeback messages observed on the coherent interconnect, from which occupancy or access frequency may be derived. A mesh-based coherent interconnect may expose per-slice activity counters, while a point-to-point coherent interconnect may expose per-link activity counters. The derivation may be performed by a coherent agent attached to the coherent interconnect.

In some implementations of the processor, the processor comprises a Central Processing Unit (CPU) configured to execute an operating system, wherein the dynamic capacity blocks of memory comprise memory within the physical address space of the processor that is unused by the operating system at a time the dynamic capacity blocks of memory are exposed to the external host, and wherein the processor is further configured to reclaim a dynamic capacity block of memory of the dynamic capacity blocks of memory in response to memory demand of the operating system. The operating system may manage the memory and may mark regions that are free or reclaimable, and the dynamic capacity blocks of memory may be drawn from such regions. Reclaiming a dynamic capacity block of memory in response to memory demand may include requesting return of the dynamic capacity block of memory from the external host and removing the corresponding entry once returned. In some examples, the processor may reclaim a least-recently-offered dynamic capacity block of memory. Because the dynamic capacity blocks of memory are memory the operating system is not using, the CPU may offer capacity without giving up memory needed by its own workloads.

In some implementations of the processor, the processing cores are further configured to execute program instructions, comprising at least one of firmware, an operating system, or a hypervisor, that cause the processor to: identify a portion of the memory that is unused by the processing cores; and update the extent list to add an entry indicative of a dynamic capacity block of memory of the dynamic capacity blocks of memory corresponding to the identified portion. The program instructions may be part of platform firmware, a host operating system, a hypervisor, or a memory-management agent executing on the processing cores. Identifying the portion may use page-table state, free-list scans, or telemetry counters. As an alternative to the processing cores performing the work, a portion may be offloaded to a service processor while the processing cores retain policy control. Because the update is performed by executed program instructions, the exposure policy may be changed by a software update.

In some implementations, the processor further comprises circuitry, distinct from the processing cores and coupled to the coherent interconnect, the circuitry configured to: monitor coherence transactions conveyed on the coherent interconnect; identify, based at least in part on the coherence transactions, a portion of the memory that is unused by the processing cores; and update the extent list to add an entry indicative of a dynamic capacity block of memory of the dynamic capacity blocks of memory corresponding to the identified portion, independently of the processing cores. The circuitry may be a finite state machine, a microcontroller, or fixed-function logic placed on the coherent interconnect. Monitoring the coherence transactions may use counters that aggregate activity per memory region, and the circuitry may apply a threshold to identify a region as unused. As an alternative, the circuitry may receive periodic summaries from a coherent agent rather than observing the coherence transactions directly. Because the update runs in the circuitry, the extent list may be maintained without consuming cycles of the processing cores.

In some implementations, the processor further comprises a memory controller configured to manage one or more memory channels coupling the processor to dynamic random-access memory (DRAM), wherein the memory comprises the DRAM, and wherein the processor is further configured to determine the dynamic capacity blocks of memory based at least in part on occupancy information of the DRAM maintained by the memory controller. The DRAM may be arranged as dual in-line memory modules on the one or more memory channels, and the occupancy information may include per-rank or per-region utilization maintained by the memory controller. The processor may select a dynamic capacity block of memory from a region the memory controller reports as lightly occupied. As an alternative, the occupancy information may be derived from a separate telemetry agent. Because the dynamic capacity blocks of memory are determined using the occupancy information, the dynamic capacity blocks of memory may be drawn from physical regions with capacity to spare.

In some implementations of the processor, the processor is further configured to expose the mailbox via the CXL port within a same integrated circuit package as the processing cores, such that the extent list is conveyed to the external host without traversal of an interconnect external to the integrated circuit package. The processing cores, the mailbox, and the CXL port may reside on a single die or on chiplets within the integrated circuit package, coupled by an on-package interconnect. As an alternative, the CXL port may be on a separate chiplet coupled to the processing cores by a package-level link. Because the mailbox reaches the CXL port within the integrated circuit package, the extent list may be conveyed to the external host without traversing a board-level interconnect, which may reduce latency.

In some implementations of the processor, the processor is further configured to: add an entry to the extent list, to expose an additional dynamic capacity block of memory to the external host during runtime of the external host; and remove an entry from the extent list, to reclaim a dynamic capacity block of memory of the dynamic capacity blocks of memory from the external host during runtime of the external host. Adding an entry may make a newly freed region available to the external host, and removing an entry may precede physical reuse of a region by the processor. In some examples, removal may follow an acknowledgment by the external host that the corresponding dynamic capacity block of memory has been released. Because entries are added and removed while the external host runs, the capacity offered to the external host may grow and shrink in response to changing availability.

In some implementations of the processor, the external host comprises a host running an operating system, and wherein the processor is further configured to make a dynamic capacity block of memory of the dynamic capacity blocks of memory available to the host, during runtime of the operating system and without a reset of the operating system, for use by at least one of: the operating system, a virtual machine, a container, or a function-as-a-service instance executing on the host. The operating system may present the dynamic capacity block of memory to a virtual machine, a container, or a function-as-a-service instance by hot-adding the dynamic capacity block of memory to a guest or workload address space. As an alternative, a hypervisor of the host may map the dynamic capacity block of memory directly to a guest. Because the dynamic capacity block of memory is made available during runtime of the operating system, a workload may gain memory without restarting.

In environments where a processor makes memory available to a separate external host, the processor and the external host may operate together as a system in which the external host actively consumes the offered capacity. The external host may read the extent list from the mailbox, may bring described dynamic capacity blocks of memory into use over CXL.mem, and may continue running as the capacity available to it changes.

In various implementations, a system comprising: a processor comprising processing cores coupled via a coherent interconnect, and a Compute Express Link (CXL) port configured to communicate according to CXL.mem; and an external host coupled to the processor via the CXL port; wherein the processor is configured to expose, via the CXL port to the external host, a mailbox configured to convey, to the external host, an extent list comprising entries indicative of dynamic capacity blocks of memory exposed by the processor to the external host, the entries indicating at least starting device physical addresses and lengths of the dynamic capacity blocks of memory; wherein the processor is further configured to update the extent list; and wherein the external host is configured to access, over CXL.mem and via the CXL port, the dynamic capacity blocks of memory, the dynamic capacity blocks of memory changing during runtime of the external host without requiring a reset of the external host. The system may be deployed as two servers coupled by a cable or backplane, as a host and an attached processor within a chassis, or as nodes within a rack coupled through a CXL fabric. The external host may be a server processor, an accelerator host, or a management host that reads the extent list from the mailbox and brings described dynamic capacity blocks of memory into use. The external host may access the dynamic capacity blocks of memory over CXL.mem regardless of how many dynamic capacity blocks of memory are offered, so that the same access path may operate whether one or many are offered; a single offered dynamic capacity block of memory and a large set of offered dynamic capacity blocks of memory may both be accessed without a change to the access path. A consuming host conventionally obtains added memory by reboot or by physically installed memory. Because the external host accesses dynamic capacity blocks of memory whose description changes while it runs, memory available to the external host may scale during runtime of the external host without a reset.

In some implementations of the system, the processor is further configured to expose, over CXL.mem and via the mailbox, respective dynamic capacity blocks of memory to two or more external hosts including the external host, the respective dynamic capacity blocks of memory changing during runtime of the two or more external hosts without requiring a reset of the two or more external hosts. The two or more external hosts may each be offered a separate set of dynamic capacity blocks of memory, and the processor may partition its memory so that a dynamic capacity block of memory offered to one external host is not concurrently offered to another. As an alternative, a dynamic capacity block of memory may be moved from the set offered to one external host to the set offered to another after release. Because respective dynamic capacity blocks of memory are offered to the two or more external hosts, the processor may rebalance memory across the two or more external hosts during their runtime.

In some implementations of the system, the external host is further configured to access the dynamic capacity blocks of memory as byte-addressable memory by load operations and store operations, and to add a dynamic capacity block of memory of the dynamic capacity blocks of memory to an address space of an operating system of the external host, during runtime of the operating system and without a reset of the operating system. The external host may map a dynamic capacity block of memory into the address space of the operating system using a hot-add path, and may issue load operations and store operations to the dynamic capacity block of memory thereafter. As an alternative, the operating system may place the dynamic capacity block of memory in a separate memory tier reserved for elastic capacity. Because the dynamic capacity block of memory is added during runtime of the operating system, applications may begin using the added memory without an operating-system restart.

In some method implementations, a processor may communicate with an external host according to CXL.mem, expose a mailbox conveying an extent list of dynamic capacity blocks of memory, and update the extent list during runtime of the external host. The method may be carried out by instructions stored in a memory and executed by processing cores of the processor, by hardware circuitry, or by a combination thereof.

In various implementations, a method, performed by a processor, comprising: communicating, by a Compute Express Link (CXL) port of the processor according to CXL.mem, with an external host; exposing, by the processor via the CXL port to the external host, a mailbox configured to convey, to the external host, an extent list comprising entries indicative of dynamic capacity blocks of memory exposed by the processor to the external host, the entries indicating at least starting device physical addresses and lengths of the dynamic capacity blocks of memory; and updating, by the processor, the extent list, such that the processor exposes to the external host, over CXL.mem and via the mailbox, dynamic capacity of memory that changes during runtime of the external host without requiring a reset of the external host. The communicating, exposing, and updating may be performed by a processor coupled to a memory storing instructions that, when executed by processing cores of the processor, carry out the operations, by firmware, or by hardware circuitry. Exposing the mailbox may include making a command interface reachable over the CXL port, and updating the extent list may include adding, modifying, or removing entries indicating starting device physical addresses and lengths. The method may proceed in the same manner regardless of how many dynamic capacity blocks of memory are described, so that it may apply from a single dynamic capacity block of memory to many. A capacity change conventionally requires a reset of a consuming host. Because the extent list is updated while the external host runs, the dynamic capacity available to the external host may change without a reset of the external host.

In some implementations of the method, updating the extent list comprises updating the extent list based at least in part on information, obtained via a coherent interconnect of the processor, indicative of utilization of memory of the processor by processing cores of the processor. Obtaining the information may include reading counters maintained by a coherent agent, sampling occupancy at intervals, or receiving summaries over the coherent interconnect. The updating may add an entry when the information indicates utilization is low and remove an entry when the information indicates utilization has risen. Because the updating follows the information, the offered capacity may track memory not in use by the processing cores.

In some implementations, the method further comprises translating, by the processor, addresses used by the external host to reference the dynamic capacity blocks of memory to physical addresses within a physical address space of the processor, wherein the dynamic capacity blocks of memory comprise memory within the physical address space of the processor that is unused by the processor at a time the dynamic capacity blocks of memory are exposed to the external host. Translating the addresses may map a device-facing address carried by a request to an address within the physical address space of the processor, using a table or range registers. The memory that is unused may be drawn from regions a memory manager reports as free. Because the translated memory is unused at the time of exposure, the processor may offer the memory without disturbing its own active allocations.

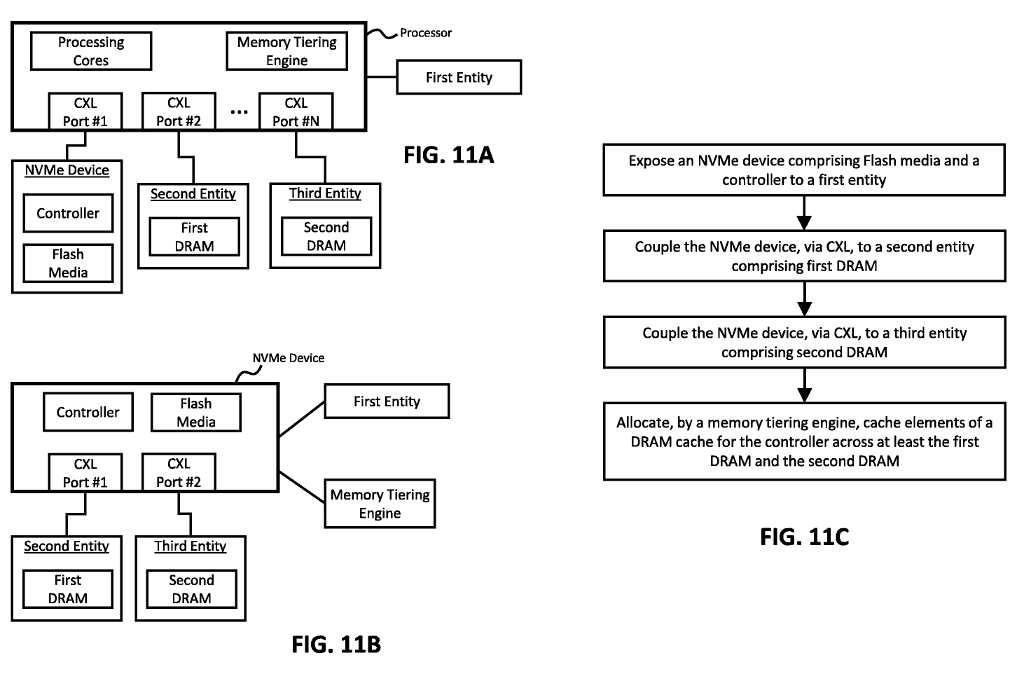

FIG. 11A illustrates an implementation in which a processor aggregates DRAM contributed via CXL from multiple entities and exposes the aggregated DRAM as a DRAM cache for the controller of an NVMe device. The processor may include processing cores, a memory tiering engine, and a plurality of CXL ports. The NVMe device, which may include a controller and Flash media, may be coupled to the processor via at least one CXL port of the plurality of CXL ports, and the NVMe device may be exposed by the processor to a first entity that consumes the NVMe device. A second entity, illustrated as a separate component from the processor, may include first DRAM and may be coupled to the processor via at least one CXL port of the plurality of CXL ports. A third entity, illustrated as a further separate component, may include second DRAM and may be coupled to the processor via at least one CXL port of the plurality of CXL ports. The memory tiering engine, illustrated within the processor, may allocate cache elements of a DRAM cache for the controller across at least the first DRAM and the second DRAM. The cache elements may include FTL mapping table entries, L2P address translation entries, write buffer entries pending program to the Flash media, or read cache lines populated from the Flash media. The first DRAM and the second DRAM, exposed to the controller via the plurality of CXL ports of the processor, may serve as the DRAM cache for the controller.

Disclosed are devices, systems, and methods relating to a memory architecture in which a DRAM cache of a controller of an NVMe device is mapped at least in part to DRAM contributed by multiple entities coupled via CXL. A memory tiering engine may allocate cache elements of the DRAM cache, such as FTL mapping table entries, L2P address translation entries, write buffer entries pending program to the Flash media, or read cache lines populated from the Flash media, across the contributing DRAMs. The architecture may reduce or eliminate reliance on DRAM physically located on the NVMe device, may scale total DRAM cache capacity by adding contributing entities, and may operate over CXL.io, CXL.cache, or CXL.mem, with the CXL link optionally tunneled or encapsulated over other scale-up interconnects.

In various implementations, a processor comprising: processing cores; a plurality of Compute Express Link (CXL) ports; a memory tiering engine; wherein the processor is configured to expose, to a first entity, a Non-Volatile Memory Express (NVMe) device comprising Flash media and a controller, the NVMe device being coupled to the processor via at least one CXL port of the plurality of CXL ports; wherein the processor is configured to be coupled, via at least one CXL port of the plurality of CXL ports, to a second entity comprising first dynamic random-access memory (DRAM); wherein the processor is further configured to be coupled, via at least one CXL port of the plurality of CXL ports, to a third entity comprising second DRAM; wherein the memory tiering engine is configured to allocate cache elements of a DRAM cache for the controller across at least the first DRAM and the second DRAM; and wherein the processor is further configured to expose at least the first DRAM and the second DRAM, via the plurality of CXL ports, to the controller as the DRAM cache for the controller. The processor may be implemented as a server CPU having processing cores, an on-package fabric, and CXL root ports; as a multi-die CPU having processor dies interconnected by a die-to-die interface and exposing CXL root ports; or as a system-on-chip integrating processing cores and CXL interface circuitry on a common substrate. The plurality of CXL ports may be CXL root ports of the processor, one or more of which may couple to the NVMe device directly and one or more of which may couple to a CXL switch through which the second entity and the third entity are reached. The memory tiering engine may be implemented as a controller (such as a finite state machine or an embedded microcontroller running firmware) coupled to the CXL ports through a coherent interconnect of the processor, or as instructions executed by one or more of the processing cores. The memory tiering engine may allocate the cache elements by, for example: (1) maintaining counters representing access frequency or recency of access from the controller for cache elements; (2) selecting a target DRAM among the first DRAM and the second DRAM based on a comparison among the counters of multiple cache elements or based on a comparison of a counter to a threshold; and (3) instructing the controller to place or relocate the cache element to the selected target DRAM, by updating a placement mapping that the controller reads when issuing CXL transactions or by issuing an administrative command to the controller via an NVMe administrative queue. The processor may expose the first DRAM and the second DRAM to the controller as the DRAM cache by translating address ranges of the contributing DRAMs into a memory window visible to the controller through CXL.mem or CXL.cache, by bridging CXL ports such that load and store transactions issued by the controller reach the contributing DRAMs, or by configuring decoders within the processor's fabric such that addresses targeting the DRAM cache are routed to the appropriate contributing entity. The processor may aggregate DRAM contributed via CXL from the second entity and from the third entity independently of the total DRAM capacity contributed by each, so that the same aggregation logic may operate across deployments having a small allocation of DRAM contributed by each entity to deployments having a larger allocation. At a low corner of the range, the contributed DRAM may be sized to a working set of Flash translation layer (FTL) mapping table entries currently being accessed; the contributed DRAM may be sized to hold the FTL mapping table for the entire Flash media together with read and write buffer entries for the controller. Because the DRAM cache for the controller is mapped to the first DRAM at the second entity and the second DRAM at the third entity supplied via the plurality of CXL ports of the processor, the on-device DRAM physically located on the NVMe device may be reduced in capacity or eliminated, the bill-of-materials cost and on-device power consumption of the NVMe device may be reduced, and the total DRAM cache capacity for the controller may scale by adding contributing entities without modification to the NVMe device.

In some implementations of the processor, the cache elements comprise at least one of a Flash translation layer (FTL) mapping table entry of the controller, a logical-to-physical (L2P) address translation entry of the controller, a write buffer entry pending program to the Flash media, or a read cache line populated from the Flash media. The cache elements may include FTL mapping table entries that map logical block addresses to physical Flash addresses, L2P address translation entries used by the controller during read and program operations, write buffer entries holding host data pending program to the Flash media, or read cache lines holding data populated from the Flash media for return to the first entity. The cache elements may be stored in and retrieved from the first DRAM and the second DRAM via the plurality of CXL ports. Because the cache elements may include FTL semantics, address-translation lookup latency for the controller may be reduced relative to caching host data alone.

In some implementations of the processor, the memory tiering engine comprises an autonomous tiering algorithm engine configured to allocate the cache elements based on access frequency metrics maintained per FTL mapping table entry, such that an FTL mapping table entry having a higher access frequency metric is placed on whichever of the first DRAM or the second DRAM the autonomous tiering algorithm engine determines to provide lower access latency to the controller. The autonomous tiering algorithm engine may maintain access frequency metrics in counters indexed by FTL mapping table entry, may sample a fraction of accesses to reduce counting overhead, and may rank entries by access frequency to identify entries for placement on lower-latency DRAM. The engine may use a least-recently-used algorithm, a least-frequently-used algorithm, or a sketch-based estimator such as Count-Min Sketch. Because placement is informed by access frequency at FTL mapping table entry granularity rather than at host-page granularity, address-translation latency for high-frequency Flash addresses may be reduced.

In some implementations of the processor, at least one cache element among the cache elements has a size of at least one of 4 kilobytes corresponding to a page-mapped FTL granularity of the controller, 16 kilobytes corresponding to a NAND physical page size of the Flash media, 64 kilobytes corresponding to a sequential-workload allocation unit of the controller, 2 megabytes aligned to an operating-system huge-page boundary, or a variable size determined by the memory tiering engine based on at least one of an access frequency metric or a hot/cold classification of the at least one cache element. The cache element size may be 4 kilobytes corresponding to a page-mapped FTL granularity for fine-grained mapping, 16 kilobytes corresponding to a NAND physical page size for write coalescing, 64 kilobytes corresponding to a sequential-workload allocation unit for large reads or writes, or 2 megabytes aligned to an operating-system huge-page boundary to reduce translation lookaside buffer pressure for large-region mappings. The variable-size option may correspond to a per-entry hot/cold classification, with hotter entries receiving smaller sizes for finer placement granularity and colder entries receiving larger sizes to amortize per-element overhead. Because the cache element size may match a structural boundary of the Flash media or the first entity, allocation overhead per cache element may be reduced.

In some implementations of the processor, The processor of claim 1, wherein: an on-device DRAM cache directly coupled to the controller and physically located on the NVMe device has an aggregate capacity below fifty percent of a total DRAM cache capacity available to the controller for caching FTL mapping table entries, write buffer entries, or read cache lines; a balance of the total DRAM cache capacity is supplied by the first DRAM, the second DRAM, or both via at least one CXL port of the plurality of CXL ports; and the aggregate capacity is zero in at least one configuration of the NVMe device, such that an entirety of the total DRAM cache capacity is supplied by the first DRAM, the second DRAM, or both via at least one CXL port of the plurality of CXL ports in the at least one configuration. The on-device DRAM cache may include one or more DRAM packages mounted on a printed circuit board of the NVMe device alongside the controller; the on-device DRAM capacity may be designed to a fraction of the total DRAM cache capacity, with the balance supplied via CXL. The zero-capacity configuration may correspond to a controller manufactured without on-device DRAM packages, in which all FTL mapping table entries, write buffer entries, and read cache lines may be stored in the first DRAM, the second DRAM, or both. Because on-device DRAM may be reduced in capacity or eliminated, the bill-of-materials cost, the physical footprint, and the power consumption of the NVMe device may be reduced.

In some implementations of the processor, the memory tiering engine is further configured to select, for a cache element among the cache elements, a redundancy mode from a set comprising at least mirroring, striping, and erasure coding; the selection of the redundancy mode for the cache element being based on at least one of an access frequency metric of the cache element, an importance classification of the cache element, or a current availability of the second entity or the third entity. The memory tiering engine may select, on a per-cache-element basis, mirroring for high-importance entries (such as FTL root pointers or write-pending buffer entries), striping for high-throughput buffer entries, or erasure coding for cold mapping table regions. The selection may be encoded in a per-cache-element redundancy descriptor maintained by the memory tiering engine. The importance classification may be based on whether the cache element is needed for recovery on power loss or to satisfy in-flight host commands. Because the redundancy mode may be selected per cache element rather than uniformly across the DRAM cache, durability and capacity overhead may be balanced per cache element.

In some implementations of the processor, the memory tiering engine is further configured to maintain a mirror copy of a cache element among the cache elements, such that the cache element is stored in the first DRAM at the second entity and the mirror copy is stored in the second DRAM at the third entity; and the memory tiering engine is further configured to select placement of the cache element and the mirror copy across the second entity and the third entity. The cache element and the mirror copy may be placed on different contributing entities so that loss of access to one entity does not destroy both copies. The memory tiering engine may update the cache element and the mirror copy on write by issuing two CXL write transactions to the respective contributing entities, or by issuing a single CXL write transaction to a fabric multicaster that propagates the write to both contributing entities. Because the cache element and the mirror copy are placed on distinct contributing entities, durability of cache elements against single-entity failure may improve.

In some implementations of the processor, the memory tiering engine is further configured to stripe a cache element among the cache elements across at least the first DRAM and the second DRAM as a collection of stripe units; and the memory tiering engine is further configured to adapt a stripe width of the collection of stripe units based on at least a liveness or a free capacity of the second entity or of the third entity. The stripe units may be sized to a CXL flit, to a NAND physical page, to a 4 KiB page, or to a larger aggregation, and may be distributed across the first DRAM and the second DRAM in a round-robin mapping or a hash-based mapping. The stripe width may adapt by, for example, removing inactive contributing entities from the stripe pattern and re-allocating in-flight stripe units to remaining contributing entities. Because the stripe width may adapt to contributor liveness and free capacity, striped placement may continue to operate during contributor flux.

In some implementations of the processor, the memory tiering engine is further configured to: divide a cache element among the cache elements into data blocks and parity blocks according to an erasure code; distribute the data blocks and the parity blocks across the first DRAM, the second DRAM, and third DRAM at a fourth entity, the fourth entity being coupled to the processor via at least one CXL port of the plurality of CXL ports and being different from the first entity, the second entity, and the third entity, the data blocks and the parity blocks being distributed such that a parity block corresponding to a data block is stored on a different DRAM among the first DRAM, the second DRAM, and the third DRAM than the data block; and reconstruct the cache element from a subset of the data blocks and the parity blocks responsive to a loss of access to one of the first DRAM, the second DRAM, or the third DRAM. The data blocks and the parity blocks may be generated by a Reed-Solomon (k, m) code, with k data blocks and m parity blocks distributed across the first DRAM, the second DRAM, and the third DRAM. The erasure-coding logic may be implemented within an erasure-coding circuit of the controller, within an erasure-coding circuit of the processor, or as instructions executed by one or more processing cores. The reconstruction may invoke any subset of k blocks among the data blocks and the parity blocks. Because data blocks and parity blocks are distributed across distinct contributing entities, multi-entity failure tolerance may be achieved with lower capacity overhead than mirroring.

In some implementations of the processor, The processor of claim 1, wherein: the second entity and the third entity are accelerators of a plurality of accelerators interconnected to each other via at least one of NVLink, UALink, or Ethernet Scale-Up Networking (ESUN), the plurality of accelerators forming a scale-up cluster; the plurality of accelerators are configured to issue cache element access transactions targeting the cache elements stored in the first DRAM and the second DRAM, the cache element access transactions being identified by respective accelerator identifiers within the scale-up cluster; the memory tiering engine is further configured to differentiate placement of the cache elements among the first DRAM and the second DRAM based on the accelerator identifiers; and the cache element access transactions are conveyed via at least one of (a) tunneling of CXL transactions over NVLink, UALink, or ESUN, (b) encapsulation of CXL packets into NVLink, UALink, or ESUN, or (c) translation of CXL transactions into native NVLink, UALink, or ESUN memory access transactions. Each accelerator in the scale-up cluster may be mapped an accelerator identifier such as a node identifier, a fabric address, or a CXL Caching Agent Identifier. The memory tiering engine may use the accelerator identifier to place cache elements expected to be accessed from a particular accelerator on the DRAM closest to that accelerator within the scale-up fabric. The cache element access transactions may be tunneled CXL flits over NVLink physical layers, encapsulated CXL packets within UALink frames, or memory access transactions native to ESUN translated from CXL transactions by a translation circuit. Because placement is differentiated by accelerator identifier and the transport may carry CXL semantics over multiple scale-up protocols, accelerator-local access latency for the cache elements may be reduced.

FIG. 11B illustrates an example of a system in which a DRAM cache for the controller of an NVMe device may be mapped to DRAM contributed by multiple entities coupled to the NVMe device via CXL. The system may include the NVMe device, a second entity that may include first DRAM, and a third entity that may include second DRAM. The NVMe device may include a controller and Flash media, and may be exposed to a first entity that consumes the NVMe device. The second entity may be coupled to the NVMe device via CXL, and the third entity may be coupled to the NVMe device via CXL. The first entity, the second entity, and the third entity may be different entities. A memory tiering engine, illustrated coupled to the NVMe device, may allocate cache elements of the DRAM cache for the controller across at least the first DRAM and the second DRAM. The DRAM cache for the controller may be mapped at least in part to the first DRAM and the second DRAM. The memory tiering engine may alternatively be located within the NVMe device, within a CXL switch in a path between the NVMe device and the contributing entities, or external to the NVMe device.

In various implementations, a system comprising: a Non-Volatile Memory Express (NVMe) device comprising Flash media and a controller, the NVMe device exposed to a first entity; a second entity comprising first dynamic random-access memory (DRAM) coupled to the NVMe device via Compute Express Link (CXL); a third entity comprising second DRAM coupled to the NVMe device via CXL; a memory tiering engine coupled to the NVMe device and configured to allocate cache elements of a DRAM cache for the controller across at least the first DRAM and the second DRAM; and wherein the DRAM cache for the controller is mapped at least in part to the first DRAM and the second DRAM. The system may be implemented as a server rack with the NVMe device installed in a server chassis and the second entity and the third entity hosted in separate chassis interconnected via a CXL fabric, as a multi-host chassis with the NVMe device on one host and the second entity and the third entity comprising other hosts of the chassis, or as a single-chassis appliance containing the NVMe device and the contributing entities. The CXL coupling between the NVMe device and the contributing entities may traverse one or more CXL switches, may traverse a Global Fabric-Attached Memory Device fabric, or may be direct from CXL ports of the NVMe device to ports of the contributing entities. The memory tiering engine coupled to the NVMe device may be implemented as a controller located within the NVMe device (for example within the controller or as a sibling controller of the NVMe device), as a controller located within a CXL switch in a path between the NVMe device and the contributing entities, or as instructions executed by a host processor of the first entity. The memory tiering engine may allocate the cache elements by maintaining access frequency information or recency information for cache elements identified by FTL logical addresses, write buffer indices, or read cache tags, and by selecting a target DRAM among the first DRAM and the second DRAM based on the access frequency or recency information together with one or more of contributor latency, contributor capacity, or contributor health. The DRAM cache for the controller may be mapped at least in part to the first DRAM at the second entity and the second DRAM at the third entity through a CXL-accessible memory window that the controller addresses using CXL load and store transactions. The memory window may span the second entity and the third entity by virtue of address decoders in CXL switches, in the controller, or in the memory tiering engine, routing addresses to the contributing entity holding the corresponding cache element. The system may operate with two contributing entities, and may scale to additional contributing entities by extending the address decoders and allocation tables of the memory tiering engine to cover further contributing entities; the same allocation logic may operate independently of the number of contributing entities. Because the DRAM cache for the controller is mapped to DRAM contributed by entities distinct from the first entity and from one another, on-device DRAM physically located on the NVMe device may be reduced or eliminated, the bill-of-materials cost and on-device power consumption of the NVMe device may be reduced, and the total DRAM cache capacity available to the controller may scale with the number of contributing entities and the capacity contributed by each.

In some implementations of the system, The system of claim 11, wherein: the memory tiering engine is integrated within the controller of the NVMe device; the controller is configured to initiate, on a CXL port of the NVMe device, CXL transactions to access the cache elements stored in the first DRAM at the second entity and in the second DRAM at the third entity; and the CXL transactions comprise transactions configured according to CXL.cache, such that updates to the cache elements made by the controller are observable by the first entity through cache coherence provided by CXL.cache. The memory tiering engine integrated within the controller may be implemented as a finite state machine within the controller's silicon, as firmware running on a microcontroller of the controller, or as a coprocessor coupled to the controller through an internal bus. The transactions configured according to CXL.cache may be issued by the controller acting as a CXL caching agent toward the first DRAM and the second DRAM, with coherence interactions visible to the first entity. Because the controller initiates transactions configured according to CXL.cache, the first entity may observe updates to the cache elements through CXL.cache without separate notification and may participate in coherence with the controller.

In some implementations of the system, the memory tiering engine is further configured to determine, for the second entity and the third entity, respective access latencies from the NVMe device to the first DRAM and to the second DRAM, and the memory tiering engine is further configured to place cache elements having higher access frequency on whichever of the first DRAM or the second DRAM has lower determined access latency, and to place cache elements having lower access frequency on whichever of the first DRAM or the second DRAM has higher determined access latency. The memory tiering engine may measure access latency by sampling round-trip times for test transactions to the second entity and the third entity, by reading static latency descriptors from a fabric manager, or by consulting a CXL Coherent Device Attribute Table reported during link enumeration. The memory tiering engine may place high-frequency cache elements on the lower-latency DRAM by issuing CXL copy or move transactions. Because placement is informed by measured access latency in addition to access frequency, average access latency for the cache elements may be reduced relative to a placement that does not consider latency.

In some implementations of the system, The system of claim 11, wherein: the second entity is one of a host computer, a graphics processing unit (GPU), an accelerator, or a programmable data-plane device; the third entity is one of a host computer, a GPU, an accelerator, or a programmable data-plane device; the second entity has a first main function being one of compute, artificial-intelligence acceleration, network processing, graphics rendering, or database execution; the third entity has a second main function being one of compute, artificial-intelligence acceleration, network processing, graphics rendering, or database execution; and the first main function and the second main function are independent of providing storage cache to the NVMe device. The second entity and the third entity may be a host computer running an operating system, a GPU running compute kernels, an accelerator such as a tensor processing unit, or a programmable data-plane device such as a smart network interface controller. The main function of the second entity and the main function of the third entity may run concurrently with the contribution of DRAM to the controller cache. The contributed DRAM may be capacity that the entity has not allocated to its main function, capacity that the entity has marked as donatable, or capacity that the entity allocates from its general-purpose memory pool. Because the main function is independent of providing storage cache to the NVMe device, the contributed DRAM may not require a dedicated CXL memory expansion device.

In some implementations of the system, The system of claim 11, wherein: the controller is further configured to transmit, to the second entity and the third entity via CXL, hints associated with the cache elements stored in the first DRAM and the second DRAM; the hints comprise at least one of a hot/cold classification, an access frequency indication, an importance indication, or a quality-of-service indication for the cache elements; and the second entity and the third entity are configured to set, based on the hints, at least one of a memory retention policy, a memory scrub policy, or a memory bandwidth allocation policy for the first DRAM and the second DRAM. The hints may be conveyed via CXL.io vendor-defined messages, CXL administrative messages, or CXL.cache snoop response metadata. The receiving entity may, in response, increase memory retention priority, alter scrub frequency, or reserve memory bandwidth for the corresponding DRAM region. The hot/cold classification may indicate that an FTL mapping table entry is accessed frequently or rarely; the importance indication may indicate that the cache element is needed for recovery on power loss.

In some implementations of the system, The system of claim 11, wherein, responsive to detection of a Compute Express Link disconnection of one of the second entity or the third entity, the memory tiering engine is further configured to: redirect subsequent access requests for cache elements previously mapped to the disconnected entity to a remaining one of the second entity or the third entity that remains connected via CXL; and cause the controller to rebuild, from the Flash media, at least a portion of Flash translation layer (FTL) mapping table entries among the cache elements affected by the disconnection. Detection of CXL disconnection may be based on link-layer signaling such as a CXL Link Training and Status State Machine transition out of an active state, on transaction timeout, or on a heartbeat protocol implemented at the application layer. The controller may rebuild affected FTL mapping table entries by reading corresponding Flash media metadata pages, such as page-level metadata or device-managed mapping logs. Because the memory tiering engine redirects requests and the controller rebuilds affected entries on CXL disconnection, the NVMe device may continue serving the first entity without quiescing input/output operations.

In some implementations of the system, The system of claim 11, wherein: the second entity and the third entity are accelerators of a plurality of accelerators interconnected to each other via at least one of NVLink, UALink, or Ethernet Scale-Up Networking (ESUN), the plurality of accelerators forming a scale-up cluster; the plurality of accelerators are configured to issue cache element access transactions targeting the cache elements stored in the first DRAM and the second DRAM, the cache element access transactions being identified by respective accelerator identifiers within the scale-up cluster; the memory tiering engine is further configured to differentiate placement of the cache elements among the first DRAM and the second DRAM based on the accelerator identifiers; and the cache element access transactions are conveyed via at least one of (a) tunneling of CXL transactions over NVLink, UALink, or ESUN, (b) encapsulation of CXL packets into NVLink, UALink, or ESUN, or (c) translation of CXL transactions into native NVLink, UALink, or ESUN memory access transactions. The plurality of accelerators in the scale-up cluster may be GPUs, artificial-intelligence accelerators, or programmable data-plane devices, each having an accelerator identifier such as a node identifier or a fabric address. The memory tiering engine may use the accelerator identifier to place cache elements expected to be accessed from a particular accelerator on the DRAM closest to that accelerator within the scale-up fabric. The CXL transactions may be tunneled as CXL flits within NVLink frames, encapsulated as CXL packets within UALink frames, or translated into native ESUN memory access transactions by a protocol-translation circuit. Because placement is differentiated by accelerator identifier and the transport accommodates multiple scale-up protocols, accelerator-local access latency for the cache elements may be reduced across heterogeneous scale-up clusters.

In some implementations, the system further comprises a fourth entity coupled to the NVMe device via CXL, the fourth entity being different from the first entity, the second entity, and the third entity; the fourth entity comprising third DRAM; the memory tiering engine being further configured to allocate the cache elements across at least the first DRAM, the second DRAM, and the third DRAM; and the DRAM cache for the controller being further mapped at least in part to the third DRAM. The fourth entity may be located in a different chassis or in a different rack than the second entity and the third entity, increasing geographic diversity of the contributing entities. The memory tiering engine may allocate cache elements across the first DRAM, the second DRAM, and the third DRAM by extending placement tables to cover the third DRAM. Additional contributing entities beyond the fourth may be added by further extending the placement tables. Because the DRAM cache is further mapped to a third contributing DRAM, total cache capacity and tolerance against entity failure may scale with the number of contributing entities.

In various implementations, a method comprising: exposing a Non-Volatile Memory Express (NVMe) device comprising Flash media and a controller to a first entity; coupling the NVMe device, via Compute Express Link (CXL), to a second entity comprising first dynamic random-access memory (DRAM); coupling the NVMe device, via CXL, to a third entity comprising second DRAM; and allocating, by a memory tiering engine coupled to the NVMe device, cache elements of a DRAM cache for the controller across at least the first DRAM and the second DRAM, such that the DRAM cache for the controller is mapped at least in part to the first DRAM and the second DRAM. The method may be performed by a processor coupled to a memory storing instructions that, when executed by the processor, cause the processor to perform the method. The exposing may be performed by an operating system instance running on a host processor that controls a PCIe Base Address Register of the NVMe device, by a hypervisor exposing namespaces of the NVMe device to a guest virtual machine, or by a CXL Fabric Manager that registers the NVMe device with a directory used by the first entity to discover available NVMe targets. The coupling of the NVMe device to the second entity and the third entity may be performed by configuring address decoders in CXL switches in a path between the NVMe device and the contributing entities, by completing CXL link training between CXL ports of the NVMe device and ports of the contributing entities, or by registering memory regions of the contributing entities with the controller of the NVMe device. The allocating may be performed by a memory tiering engine implemented as instructions executed by a host processor of the first entity, as firmware running on a microcontroller of the controller, or as a controller located in a CXL switch in the path. The allocating may include: maintaining access frequency information per cache element; selecting a target DRAM among the first DRAM and the second DRAM based on the access frequency information; and instructing the controller to place or relocate the cache element to the selected target DRAM. The method may operate independently of the number of contributing entities, with the same allocation steps applied as contributing entities join or leave the system. Because cache elements are allocated by a memory tiering engine across multiple contributing DRAMs over CXL, on-device DRAM physically located on the NVMe device may be reduced or eliminated and DRAM cache capacity available to the controller may scale with contributing entity count.

In some implementations, the method further comprises re-allocating, by the memory tiering engine, a cache element among the cache elements from the first DRAM to the second DRAM, or from the second DRAM to the first DRAM, based on a change in an access frequency metric of the cache element; the re-allocating being performed without quiescing input/output operations issued by the first entity against the NVMe device. The re-allocating may be triggered by an increase or decrease of an access frequency metric counter beyond a threshold, by promotion of a cache element from a hot tier to a cold tier within an access-frequency ranking, or by a change in contributor latency that affects the target DRAM for the cache element. The re-allocating may proceed by issuing a CXL copy transaction from a source DRAM to a target DRAM followed by a pointer or mapping update visible to the controller. Concurrent input/output operations issued by the first entity may be mapped to the source DRAM until the pointer update is visible, and from the target DRAM thereafter. Because the re-allocating may proceed without quiescing input/output operations, the NVMe device may continue serving the first entity during placement adjustments.

### Terminology

Some implementations described herein involve processors. A processor may be implemented as a processing element, an integrated circuit (IC), or a device that processes data and/or executes instructions, and may take the form of, for example, a CPU, a GPU, a TPU, an xPU, an FPGA, an ASIC, a DSP, a System-on-Chip (SoC), an embedded system, a network node, an xPU, or another IC incorporating processing capabilities, whether single-core or multi-core, and whether including embedded controllers and/or accelerators. A processor may be implemented in hardware only, such as fixed-function logic or an ASIC that processes data without executing programmable instructions, may be configured to execute programmable instructions, or may include a combination thereof. A processor may include one or more processors that individually or jointly process data and/or execute instructions, such that reference to a processor in the singular is intended to imply one or more processors that jointly perform the functions attributed to the processor.

Some implementations described herein involve circuits. A circuit may be implemented as a device, an integrated circuit (IC), a die, a chiplet, or a system that includes at least a processing element configured to perform a function, and may take the form of, for example, combinational logic, sequential logic, a discrete logic circuit, a programmable logic device, an embedded controller, a processor, an accelerator, a CPU, a GPU, a TPU, an FPGA, an ASIC, a DSP, a System-on-Chip (SoC), a chiplet die, an accelerator die, a System-in-Package (SiP) device, a switch, or another type of IC incorporating processing capabilities. The processing element may be of any type, such as combinational logic gates, a state machine, a lookup table, a microcontroller, a microprocessor, a single-core or multi-core processor, a firmware-controlled engine, or any combination thereof. A circuit may optionally include memory, such as registers, buffers, volatile or non-volatile storage media, or retention memory that preserves state across reset events. A circuit may optionally include a communication interface that allows the processing element to send and/or receive data, signals, or instructions, such as die-to-die interfaces, UALink-based ports, data link layers, physical layers, out-of-band management interfaces, or other arrangements facilitating data exchange. A circuit may include one or more circuits that individually or jointly perform a function, such that reference to a circuit in the singular is intended to imply one or more circuits that jointly perform the functions attributed to the circuit.

In an apparatus that comprises a processor or a circuit together with one or more interconnect interfaces or ports, an interface or port may be included in the processor or circuit, may be external to the processor or circuit, or may be partly included in and partly external to the processor or circuit. A recitation that a processor or circuit is coupled to, coupled between, or otherwise associated with one or more interfaces or ports does not require those interfaces or ports to be either included in or external to the processor or circuit, and contemplates both arrangements and combinations thereof. The processor or circuit may correspondingly be implemented as part of one or more of the interconnect interfaces or ports, as a separate component, or as a combination thereof. Unless the context indicates otherwise, operations attributed to the processor or circuit may be performed by one or more of the interconnect interfaces or ports, and conversely, relevant operations attributed to one or more of the interconnect interfaces or ports may be performed by the processor or circuit. This interchangeability applies to relevant processing operations described in this specification in relation to elements such as the processor, circuit, CPU, GPU, xPU, switch, or the interconnect interfaces or ports.

An inter-socket link (ISoL) refers to any current or future high-speed communication link, interconnect, protocol, and/or architecture that facilitates data transfer between processors, such as CPUs, GPUs, TPUs, accelerators, DSAs, and/or other types of processing units. The interface points for these technologies may be collectively referred to as "ISoL ports", though they may have technology-specific designations. ISoL may include direct inter-processor links, switched fabric designs, node controller-based topologies, optical interconnects, and/or heterogeneous computing interconnects linking different processor types. These interconnects may support various processor arrangements, including those soldered to PCBs, installed in motherboard sockets, or integrated as separate dies within chiplet-based designs. Examples of ISoL technologies include, without limitation, Intel's Coherent Processor Interconnect Protocol (ICPIP) for scalable multiprocessors with a shared physical address space, such as Ultra Path Interconnect (UPI); AMD's Infinity Fabric (IF) and its underlying External Global Memory Interconnect (xGMI); ARM's Coherent Hub Interface chip-to-chip (CHI C2C); NVIDIA's NVLink and NVLink chip-to-chip (NVLink-C2C); Ultra Accelerator Link (UALink); and Ethernet for Scale-Up Networking (ESUN). Each of these technologies, their successors, and other technologies developed in the future, may implement specific port, interface, and protocol designs for inter-processor communication. The interface points for these technologies may have technology-specific designations, such as "UPI port" or "UPI link" for Intel processors; "IF link" or "xGMI link" for AMD processors; "NVLink port", "NVLink link", or "NVLink interface" for NVIDIA GPUs; or "UALink port", "UPLI interface", or "UPLI interface port" for UALink implementations.

A memory pool may include a system, an apparatus, a device, and/or a logically or physically distinct collection of resources that may incorporate, manage, or otherwise control memory capacity (such as volatile memory (e.g., DRAM) and/or non-volatile memory), and that may provide the capability to provision, allocate, deallocate, expose, share, map, and/or otherwise make available portions or aspects of its memory capacity for use, access, sharing, allocation, and/or consumption by one or more entities external to the memory pool. Such entities may include, without limitation, hosts, servers, processors, accelerators, computing devices, virtual machines, containers, processes, applications, services, operating systems, hypervisors, or other memory pools. A memory pool may perform functions related to memory resource aggregation, management, provisioning, and/or sharing, irrespective of its commercial designation, physical form factor, architectural design, interconnection method, communication protocol(s), or implementation methodology. A memory pool may also be capable of running workloads, applications, and/or computational tasks, thereby functioning as both a memory entity and a compute entity. A memory pool may also be implemented as a logical entity that borrows, aggregates, or otherwise utilizes memory resources from other entities (such as hosts, devices, or other memory pools), rather than solely relying on dedicated physical memory resources under its direct control.

The terms "port" and "interface" may be used herein interchangeably, unless a particular context specifies a distinction between them. A port may include a physical or logical connection point configured to support communication with or within components, devices, or systems. A port may include, be included in, or be coupled to one or more interfaces or interface types, and an interface may include, be included in, or be coupled to one or more ports; either a port or an interface may support one or more communication protocols and/or may be a specialized type depending on the context.

### General Considerations

When referring to fields, operations, or operation types associated with communication protocols, the terms "opcode", "command", "TLP type", "request", "request type", "transaction", and "transaction type" may be used herein interchangeably as long as they refer to the same operation. This interchangeable usage may apply to data indicative of operation types (such as a field or a set of fields) within messages, packets (such as TLPs), flits, phits, frames, protocol data units (PDUs), or other protocol data structures, as well as to descriptions of protocol operations, requests, transactions, or communications across different communication protocols. For example, a "CXL.cache DirtyEvict opcode", a "CXL.cache DirtyEvict command", and a "CXL.cache DirtyEvict request" may refer to the same operation in which a device asks a host, such as via a D2H request message, to evict a full 64-byte modified cacheline. The same interchangeability applies across protocols; for example, an "ARM CHI ReadOnce" or a "UPLI read" may likewise be referred to as an opcode, command, request, or transaction specifying the same operation, whether referring to the actual field within a message or to the operation itself.

The CXL Specifications sometimes use message, transaction, command, opcode, request, and response in overlapping contexts; accordingly, a reference herein to a CXL message, transaction, command, opcode, request, or response may encompass a corresponding one of the others where they refer to the same operation. The CXL Specifications also describe CXL.cache and CXL.mem variously as protocols, sub-protocols, channels, interfaces, or transactional interfaces, which may be used herein interchangeably depending on the context.

The terms "UALink requests", "UALink UPLI requests", and "UPLI requests" may be used herein interchangeably, reflecting that UPLI is the protocol layer of UALink; unless a particular context distinguishes the physical layer aspects from the protocol layer aspects, these terms refer to the same underlying transactions.

In ARM CHI implementations, the terms "CHI messages", "CHI packets", and "CHI flits" may be used herein interchangeably unless a particular context specifies otherwise, reflecting that the CHI Architecture Specification defines communication granularity at different layers, including transactions at the protocol layer, packets at the network layer, and flow control units (flits) at the link layer. Therefore, any of these terms may be used herein to describe CHI protocol-level communications without implying a limitation to a specific layer or format.

The term "Coherent Hub Interface" (CHI) as used herein is intended to encompass presently available and future versions, variations, revisions, and equivalent implementations of the CHI interconnect architecture, including AMBA 5 CHI and subsequent issues or architectural extensions published or adopted by ARM or by other entities that may extend CHI. Unless a particular context specifies otherwise, translating between CHI and another protocol, such as translating between CHI and CXL, refers to converting CHI-related protocol data units (PDUs), such as CHI requests, CHI snoop requests, CHI data responses, and CHI snoop responses, to corresponding PDUs of the other protocol, such as to CXL.cache requests and responses, or to CXL.mem requests and responses, and vice versa, optionally including field value translations between the CHI domain and the other protocol domain, such as addresses, transaction identifiers, and/or cache state indications.

The term "NVLink" as used herein is intended to encompass previous, current, and future versions, variations, revisions, and equivalent implementations of NVIDIA's NVLink interconnect, including NVLink-C2C and NVLink used with NVSwitch and/or NVLink Switch fabrics, that provide a high-bandwidth, low-latency, scalable interconnect between GPUs, between GPUs and CPUs, and/or between other types of processing units. Unless a particular context specifies otherwise, translating between NVLink and another protocol, such as translating between NVLink and CXL, refers to converting NVLink-related protocol data units (PDUs), such as NVLink requests and NVLink responses, to corresponding PDUs of the other protocol, such as to CXL.io requests and completions, or to CXL.mem requests and responses, and vice versa, optionally including field value translations between the NVLink domain and the other protocol domain, such as Tags, error indications, and/or addresses.

Herein, terms such as send/ sending, receive/ receiving, communicate/ communicating, or exchange/ exchanging when used to describe elements (e.g., computer, processor, semiconductor device, switch, port, interface) involved in data, message, packet, or other information exchanges, may refer to direct or indirect operation(s) that facilitate information transfer to/ from/ between such elements. When a first element is said to send information to a second element, it is not required to directly transmit the information from the first element to the second element; similarly, when a first element is said to receive information from a second element, the first element is not required to directly obtain the information from the second element. Instead, the elements may initiate, cause, make available, control, direct, participate in, or otherwise facilitate such transfer. The information transfer may occur directly or indirectly utilizing one or more intermediary components, such as switches, retimers, redrivers, bridges, and/or protocol translators, and may include routing, forwarding, encryption, buffering, protocol conversion, or other suitable data transfer mechanisms over a suitable communication path and/or connection. Similarly, sentences in the form of "a port/interface configured to communicate with an entity" refer to direct or indirect coupling between the port/interface and the entity.

References to a protocol "based on" a specific standard or an industry standard (such as a protocol based on CXL, a CXL-based protocol, a protocol based on UALink, a UALink-based protocol, a protocol based on NVLink, an NVLink-based protocol, a protocol based on CHI, a CHI-based protocol, a protocol based on Ethernet, an Ethernet-based protocol, a protocol based on PCIe, or a PCIe-based protocol) are intended to encompass protocols that conform to the referenced standard, as well as protocols that retain communication logic and functional characteristics of the referenced standard while incorporating modifications, extensions, or variations. Non-limiting examples of such variations may include protocols that utilize renamed, reordered, or modified fields while preserving the same or similar message formats; protocols that implement the same or similar logical operations utilizing equivalent command sequences or opcodes; protocols that preserve addressing schemes, routing logic, and coherency models; vendor-specific implementations that add proprietary extensions while retaining functionality; protocols that implement subsets of the full standard specification; or protocols that adapt the standard for different physical layers or transport mechanisms while retaining protocol properties. For example, a CXL-based protocol may encompass implementations that rename CXL.mem opcodes but preserve their memory access properties, add vendor-defined fields to CXL message formats while maintaining backward compatibility, or that implement CXL transaction flows over alternative physical layers such as IEEE 802.3 PMA or UCIe. A UALink-based protocol may encompass implementations that add vendor-defined fields, packets, or commands while preserving the accelerator-to-accelerator communication model. A PCIe-based protocol may encompass implementations that utilize non-PCIe physical layers or carrier protocols for transferring PCIe TLPs. An NVLink-based protocol may encompass implementations that extend or modify the command encoding while retaining the interconnect functionality.

The drawings presented herein are schematic representations, meaning that the number, order, timings, dimensions, connections, and other properties of the elements illustrated in the drawings are non-limiting examples. Depending on the context, elements (such as lines, arrows, boxes, blocks, symbols, or labels) illustrated in the drawings may represent one or more actual elements. For example, a single box in a block diagram may represent multiple hardware components or software modules, a single arrow in a flowchart may represent multiple process steps or data transfers, and a single line in a circuit diagram may represent multiple electrical connections. Every modification, variation, or alternative allowed by current or future relevant specifications, standards, or common practices in the field is intended to be included within the scope of said drawings. Furthermore, the scope of the drawings extends to encompass implementations that may deviate from strict specifications due to factors such as hardware bugs, relaxed designs, implementation-specific optimizations, or practical constraints, provided such deviations do not fundamentally alter the underlying principles of the implementation.

A computer program (also referred to as software, firmware, or executable logic) encompasses any set of instructions, logic, or data structures executable or interpretable by a computing device. This includes compiled or interpreted code, scripts, and machine-learning models (e.g., neural network weights, biases, and configurations). The computer program may be deployed as a standalone application, autonomous agent, service, microservice, container, or distributed module, and may be organized within any storage architecture, including file systems, object storage, or memory-mapped configurations. The program may reside locally, in a distributed network, or a cloud environment, and may utilize static or dynamic execution paradigms.

As used herein, "non-transitory computer-readable medium" refers to any tangible medium capable of storing instructions, code, or data for access by a computing device, excluding transitory propagating signals. This encompasses all forms of volatile and non-volatile memory, including semiconductor memory (e.g., RAM, Flash, RRAM, MRAM), magnetic storage, optical storage, and emerging persistent storage technologies. The medium may be integral to a device, removable, or distributed across multiple locations (e.g., a distributed database or cloud storage). The instructions, logic, or data structures may be pre-installed or downloaded to the medium via a communication network, such as the Internet. A computer program product comprises such a non-transitory medium containing content that, when accessed by one or more processors, performs the disclosed methods.

The "computer-implemented methods" described herein refer to method operations executed by processing hardware based on logical instructions, firmware, and/or hardwired logic. The processing hardware may include general-purpose processors, ASICs, FPGAs, or other hardware logic that implements the method operations through software execution, firmware execution, dedicated circuitry, or combinations thereof. The execution environment may be centralized or distributed, encompassing standalone devices, networked systems, cloud-based platforms, edge computing nodes, virtualized or containerized environments, and hybrid combinations thereof. The instructions or logic defining the method may be stored on one or more non-transitory computer-readable media, encoded in hardware description languages, and/or implemented in circuit logic.

Unless specifically requiring a particular implementation form, functionality described as implemented in hardware may alternatively be implemented in software, firmware, or a combination thereof, and vice versa. Similarly, functions described as performed by a single component may be distributed across multiple components, and functions described as distributed may be consolidated into a single component. The allocation of functions between hardware and software, or between centralized and distributed implementations, does not limit the scope of the implementations unless explicitly required.

The methods, algorithms, logics, processes, operations, and system functions described herein are not limited by a particular order, timing, sequence, grouping, or a specific implementation or example described or illustrated, unless expressly stated otherwise. Steps, operations, and functions may be performed in any reasonable order, simultaneously or sequentially, in parallel or series, and may be combined, separated, modified, rearranged, omitted, supplemented, or distributed across multiple systems or components based on particular implementation requirements. Any process descriptions, steps, or blocks in flowcharts or other illustrations should be understood as potentially representing modules, segments, portions of code, or operations that may be executed in any reasonable order, combination, or concurrently, and are not necessarily limited to the particular sequence depicted.

Phrases such as "an implementation", "various implementations", "some implementations", "one or more implementations", "an embodiment", "some embodiments", "one embodiment", "an aspect", "a configuration", "an example", and similar phrases are used herein for convenience and do not imply that a disclosure relating to such phrase(s) is essential to the subject technology or that such disclosure applies to all implementations of the subject technology. Phrases such as "an implementation", "some implementations", or "various implementations" may refer to one or more implementations and vice versa, and this applies similarly to other foregoing phrases. Distinct references, including terms such as "one implementation", "another implementation", "various implementations", or "some implementations", do not necessarily denote separate implementations. Such references may describe the same implementation from different perspectives, highlight various aspects of a single implementation, or pertain to distinct implementations. References to examples or instances are to be understood as non-limiting.

Sentences in the form of "X is indicative of Y" mean that X includes information correlated with Y and/or describing Y, up to the case wherein X equals Y. Sentences in the form of "provide/receive an indication (of whether X happened)" may refer to any indication method. The word "most" of something is defined as above 50% of the something (including 100% of the something). The words "portion", "subset", "region", and "area" of something refer to a value between a non-zero fraction of the something and 100% of the something, inclusive; they indicate an open-ended claim language, thus, for example, sentences in the form of "a portion of the memory" or "a subset of the memory" encompass anything from just a small part of the memory to the entire memory, optionally together with additional memory region(s). Sentences in the form of "access the memory" encompass accessing at least a portion of the memory, where the portion may range from a minimal addressable unit to the entire memory capacity, indicating an open-ended claim language. "Coupled" indicates direct or indirect connection, cooperation, and/or interaction, such as direct or indirect physical contact, electrical connection, and/or software and/or hardware interface; the connection between coupled elements may (or may not) involve one or more of passive components, active components, translations, modulation change, modifications to schemes, message alterations, and/or other conversions to the data or signals being transmitted.

The use of "a" or "an" refers to one or more things. The phrase "based on" indicates an open-ended claim language, and encompasses "based, at least in part, on". Additionally, stating that a value is calculated "based on X" and following that, in a certain implementation, that the value is calculated "also based on Y", means that in the certain implementation, the value is calculated based on X and Y. Variations of the terms "utilize" and "use" indicate an open-ended claim language, such that sentences in the form of "detecting X utilizing Y" are intended to mean "detecting X utilizing at least Y", and sentences in the form of "use X to calculate Y" are intended to mean "calculate Y based on X". The terms first, second, and so forth serve merely as ordinal designations, and shall not be limited in themselves. The phrases "at least one of A or B" and "at least one of A and B" are intended to be interpreted broadly to encompass A alone, B alone, or a combination of both A and B; this interpretation applies regardless of the number of items in a list, or whether the items are connected by the conjunction 'and' or 'or'. A predetermined, predefined, or preselected value is a fixed value and/or a value determined before performing a calculation that utilizes the predetermined value. When appropriate, the word "value" may indicate a predetermined value. The word "threshold" indicates a threshold whose value, and/or the logic used to determine whether the threshold is reached, is established prior to performing the computation that utilizes the threshold, whether the threshold value is fixed, predefined, or dynamically determined.

The implementations of an invention may include a variety of combinations and/or integrations of the features of the implementations. Although some implementations may describe serial operations, the implementations may perform certain operations in parallel and/or in different orders from those described. Moreover, the use of repeated reference numerals and/or letters in the text and/or drawings is for the purpose of simplicity and clarity and does not in itself dictate a relationship between the various implementations and/or configurations discussed. Components and/or modules referred to by different reference numerals may or may not perform the same (or similar) functionality, and the fact they are referred to by different reference numerals and/or letters does not mean that they may not have same or similar functionalities.

Certain features of the implementations, which may have been, for clarity, described in the context of separate implementations, may also be provided in various combinations in a single implementation. Conversely, various features of the implementations, which may have been, for brevity, described in the context of a single implementation, may also be provided separately or in any suitable sub-combination. Implementations described in conjunction with specific examples are presented by way of example, and not limitation. Moreover, it is evident that many alternatives, modifications, and variations will be apparent to those skilled in the art. It is to be understood that other implementations may be utilized and structural changes may be made without departing from the scope of the implementations.

The drawings depict some of the couplings between elements, but not necessarily all. The depiction of elements as separate entities may be done to emphasize different functionalities of elements that may be implemented by the same software and/or hardware. Programs and/or elements illustrated and/or described as being single may be implemented via multiple programs and/or involve multiple hardware elements possibly in different locations. The implementations are not limited in their applications to the details of order, or sequence of method steps, or to details of implementation of the devices, set in the description, drawings, or examples. Individual blocks illustrated in the drawings may be functional in nature and therefore may not necessarily correspond to discrete hardware elements.

This disclosure describes potential advantages of some implementations. Not all implementations will necessarily manifest any or all of those advantages, and whether a given advantage is realized may depend on factors outside the scope of this disclosure. Any potential advantage described is not to be construed as a claim limitation that must be met to demonstrate infringement; the advantages illustrate the kinds of improvement that may be available to a person having the benefit of this disclosure.

Claims in the form of "A non-transitory computer-readable medium comprising instructions which, when executed by a processor, cause the processor to perform the method of claim X" are intended to encompass physical storage media capable of storing instructions, including but not limited to semiconductor memory, magnetic storage, optical storage, and other persistent storage technologies. The instructions may be in any form capable of directing a processor to perform the method, including but not limited to compiled code, interpreted code, bytecode, firmware, as well as other forms of directives such as natural language directives, declarative specifications, model parameters or configurations, and symbolic representations, among other formats that may be suitable for processing by processors, AI modules, neural processing units, or other current or future processing architectures. The processor may include any processing unit capable of executing or interpreting stored instructions, including but not limited to CPUs, microprocessors, microcontrollers, DSPs, GPUs, neural processing units, AI accelerators, and quantum processing units. The stored instructions may cause a single processor to perform the method, or may cause the processor to coordinate with one or more additional processors to collectively perform the method in a distributed manner.

Accordingly, this disclosure is intended to embrace all such alternatives, modifications, and variations that fall within the spirit and scope of the appended claims and their equivalents.

1. A system comprising:
a Compute Express Link (CXL) fabric comprising memory resources distributed across at least one of hosts, memory pools, or CXL switches;
a first analyzer associated with a first portion of the CXL fabric, the first analyzer configured to produce first telemetry of memory accesses at a first resolution, wherein the first telemetry comprises a multi-level heat-map characterizing intensity of accesses to memory regions in the first portion of the CXL fabric;
a second analyzer associated with a second portion of the CXL fabric, the second analyzer configured to produce second telemetry of memory accesses at a second resolution lower than the first resolution, wherein the second telemetry comprises a binary hot-or-cold classification of memory regions in the second portion of the CXL fabric; and
a computer configured to receive the first telemetry from the first analyzer and the second telemetry from the second analyzer, and to produce a representation of memory access tracking across the CXL fabric based on the first telemetry and the second telemetry, wherein the representation comprises values calculated based on the first telemetry and the second telemetry, and wherein the representation is usable by a memory tiering algorithm to determine mapping of memory regions across the CXL fabric.

2. The system of claim 1, wherein at least one of: (i) the first analyzer comprises a spatio-temporal (ST) analyzer, the ST analyzer comprising a counter database configured to maintain access counters associated with the memory regions in the first portion of the CXL fabric and a temporal decay function configured to reduce values of the access counters over time, wherein the multi-level heat-map is derived from values of the access counters of the counter database; (ii) the second analyzer comprises a CXL Hot-Page Monitoring Unit defined by a CXL specification, and the second telemetry comprises a hot list produced by the CXL Hot-Page Monitoring Unit and accessible to the computer; or (iii) the memory tiering algorithm comprises an autonomous tiering algorithm configured to issue, based on the representation, instructions to migrate at least a portion of the memory regions among the memory resources of the CXL fabric, without intervention by an operating system of any of the hosts of the CXL fabric.

3. The system of claim 1, wherein the computer comprises a Central Processing Unit (CPU), the CPU comprising processing cores coupled via a coherent interconnect, the computer configured to produce the representation by accessing the first telemetry and the second telemetry through the coherent interconnect, and wherein at least one of: (i) the computer is integrated in a same integrated circuit package as the processing cores, and the computer is configured to produce the representation without the first telemetry and the second telemetry traversing a link external to the integrated circuit package; (ii) the CPU comprises a memory controller, the computer is integrated with the memory controller, and the computer is configured to access at least one of the first telemetry or the second telemetry via the memory controller; (iii) the CPU comprises a Memory Management Unit (MMU) configured to translate virtual addresses to physical addresses within a host physical address (HPA) space, and the computer is configured to map at least one of the values of the representation from a device physical address space utilized by one of the analyzers to the HPA space, utilizing translations of the MMU; or (iv) the CPU comprises at least one CXL port configured to receive the second telemetry over a CXL link external to the CPU, and the first analyzer is integrated in the CPU and configured to produce the first telemetry from memory access requests traversing the coherent interconnect.

4. The system of claim 1, wherein at least one of: (i) the computer comprises a fabric manager, the fabric manager configured to receive the first telemetry and the second telemetry through a fabric management command interface defined by a CXL specification, and to provide the representation through the fabric management command interface to the memory tiering algorithm; or (ii) the computer comprises a fabric controller separate from the first analyzer and from the second analyzer, the fabric controller communicatively coupled to the first analyzer through a first link and to the second analyzer through a second link, the fabric controller configured to receive the first telemetry through the first link and the second telemetry through the second link.

5. The system of claim 1, wherein at least one of: (i) the first analyzer is integrated with a host of the CXL fabric, and the second analyzer is integrated with a CXL Type 3 device of the CXL fabric, the CXL Type 3 device exposing host-managed device memory (HDM) to the host; (ii) the first analyzer is integrated with a Central Processing Unit (CPU) of a host of the CXL fabric, and the second analyzer is integrated with at least one of a CXL memory pool, a CXL Global Fabric-Attached Memory Device (GFD), or a CXL switch; or (iii) the system further comprises a third analyzer associated with a third portion of the CXL fabric and integrated with a CXL switch of the CXL fabric, the third analyzer configured to produce third telemetry of memory accesses traversing the CXL switch, and the computer is further configured to produce the representation further based on the third telemetry.

6. The system of claim 1, wherein the computer is further configured to produce the representation by performing at least one of: (i) mapping the values calculated based on the first telemetry and the values calculated based on the second telemetry to a common intensity scale, and populating values of the representation per memory region of the CXL fabric on the common intensity scale; (ii) assigning, to memory regions classified by the second telemetry as hot, a first value on a common intensity scale, and assigning, to memory regions classified by the second telemetry as cold, a second value on the common intensity scale lower than the first value; (iii) combining the values calculated based on the first telemetry with the values calculated based on the second telemetry according to a weighting selected such that the values calculated based on the first telemetry contribute to the representation differently from the values calculated based on the second telemetry; (iv) producing a fabric-wide heat-map normalized across the first portion of the CXL fabric and the second portion of the CXL fabric, the fabric-wide heat-map providing intensity values per memory region on a common scale regardless of which of the first analyzer or the second analyzer produced the underlying telemetry for that memory region; or (v) determining, for at least one memory region within the second portion of the CXL fabric, an intensity value of the representation by combining a hot-or-cold value calculated based on the second telemetry for the at least one memory region and an auxiliary value calculated based on a previously-determined intensity for the at least one memory region maintained by the computer.

7. The system of claim 1, wherein the computer is further configured to perform at least one of: (i) issuing, based on the representation, a migration directive to at least one entity of the CXL fabric, the migration directive identifying at least one memory region of the CXL fabric for migration and a destination among the memory resources of the CXL fabric for the at least one memory region, wherein the at least one entity of the CXL fabric comprises at least one of a CXL switch or a host of the CXL fabric; or (ii) reconfiguring, based on the representation, at least one of the first analyzer or the second analyzer, wherein reconfiguring comprises adjusting at least one of an analysis granularity, an access-type filter, a sampling rate, an epoch duration, a threshold, or a range of memory regions analyzed.

8. The system of claim 1, wherein at least one of: (i) the first analyzer is configured to produce the first telemetry at a first temporal granularity, the second analyzer is configured to produce the second telemetry at a second temporal granularity coarser than the first temporal granularity, and the second temporal granularity is at least an order of magnitude longer than the first temporal granularity; (ii) the first telemetry characterizes accesses to memory regions of a first size corresponding to a cache-line granularity, and the second telemetry characterizes accesses to memory regions of a second size larger than the first size and corresponding to a page granularity; (iii) the first analyzer is associated with a CXL link configured to support CXL.mem traffic, the second analyzer is associated with a CXL link configured for at least one of CXL.cache traffic or CXL.io traffic, and the computer is further configured to produce the representation by combining the first telemetry and the second telemetry with weightings selected based on differences between the CXL protocols carrying the underlying memory access requests; or (iv) the first telemetry comprises a heat-map structure providing per-region intensity values, the second telemetry comprises an event-stream structure providing time-ordered indications of accesses, and the computer is further configured to derive intensity values from the event-stream structure for inclusion in the representation.

9. The system of claim 1, wherein at least one of the first analyzer, the second analyzer, or the computer is communicatively coupled to another entity through a link based on at least one of NVLink, Ultra Accelerator Link (UALink), or Ethernet Scale-Up Networking (ESUN), and wherein the representation comprises values characterizing memory access patterns to memory accessible through the link.

10. The system of claim 1, wherein the hosts of the CXL fabric comprise at least one of a server host, a graphics processing unit (GPU) host, or an artificial intelligence accelerator host, and wherein the mapping of memory regions across the CXL fabric determined by the memory tiering algorithm balances memory accessibility between memory of the hosts and memory of the memory pools according to access patterns indicated by the representation.

11. The system of claim 1, wherein the first analyzer comprises hardware counter circuitry configured to maintain multi-bit access counts per memory region of the first portion of the CXL fabric, wherein the second analyzer comprises a hot-page detection circuit configured to identify, per memory region of the second portion of the CXL fabric, whether an access count exceeds a configurable threshold during an epoch, and wherein the computer is further configured to incorporate, into the representation, the multi-bit access counts of the first analyzer and the hot-page identifications of the second analyzer mapped to a common intensity scale.

12. An apparatus comprising:
an integrated circuit (IC) package comprising processing cores coupled via a coherent interconnect;
at least one Compute Express Link (CXL) port within the IC package, the at least one CXL port configured to couple the apparatus to a CXL fabric, the CXL fabric comprising memory resources distributed across at least one of hosts, memory pools, or CXL switches; and
circuitry within the IC package coupled to the coherent interconnect, the circuitry configured to:
receive first telemetry produced by a first analyzer at a first resolution, wherein the first telemetry comprises a multi-level heat-map characterizing intensity of accesses to memory regions in a first portion of the CXL fabric;
receive second telemetry produced by a second analyzer at a second resolution lower than the first resolution, wherein the second telemetry comprises a binary hot-or-cold classification of memory regions in a second portion of the CXL fabric; and
produce, based on the first telemetry and the second telemetry, a representation of memory access tracking across the CXL fabric, wherein the representation comprises values calculated based on the first telemetry and the second telemetry, and wherein the representation is usable by a memory tiering algorithm to determine mapping of memory regions across the CXL fabric.

13. The apparatus of claim 12, wherein the first analyzer is within the IC package and configured to produce the first telemetry from memory access requests traversing the coherent interconnect, the second analyzer is external to the IC package and configured to produce the second telemetry from memory access requests received at a CXL device of the CXL fabric, and wherein at least one of: (i) the IC package further comprises a memory controller coupled to the coherent interconnect, and the circuitry is integrated with the memory controller and configured to access at least one of the first telemetry or the second telemetry via the memory controller, without traversal of a link external to the IC package for that access; or (ii) the IC package further comprises a Memory Management Unit (MMU) configured to translate virtual addresses to physical addresses within a host physical address space, and the circuitry is configured to translate, utilizing the MMU, addresses associated with the first telemetry or the second telemetry from a device physical address space utilized by one of the analyzers to the host physical address space, prior to populating values of the representation.

14. The apparatus of claim 12, wherein the circuitry is further configured to perform at least one of: (i) producing the representation by mapping the values calculated based on the first telemetry and the values calculated based on the second telemetry to a common intensity scale, the common intensity scale spanning the first portion of the CXL fabric and the second portion of the CXL fabric; (ii) issuing, based on the representation, a migration directive over the at least one CXL port to an entity of the CXL fabric, the migration directive identifying at least one memory region of the CXL fabric for migration and a destination among the memory resources of the CXL fabric for the at least one memory region; or (iii) reconfiguring, based on the representation, at least one of the first analyzer or the second analyzer by adjusting at least one of an analysis granularity, a sampling rate, an epoch duration, or a threshold.

15. The apparatus of claim 12, wherein at least one of: (i) the first analyzer comprises a spatio-temporal (ST) analyzer comprising a counter database and a temporal decay function configured to reduce values of access counters of the counter database over time; (ii) the second analyzer comprises a CXL Hot-Page Monitoring Unit defined by a CXL specification; or (iii) the circuitry is configured to operate as a fabric manager, the circuitry configured to expose a fabric management command interface defined by a CXL specification to a memory tiering algorithm executing on the processing cores or on a remote host, and to deliver the representation to the memory tiering algorithm through the fabric management command interface.

16. The apparatus of claim 12, wherein the IC package further comprises a CXL device exposing host-managed device memory (HDM) to at least one of the hosts of the CXL fabric, and wherein the circuitry is configured to identify, based on the representation, memory regions within the HDM that are candidates for promotion or demotion among the memory resources of the CXL fabric.

17. The apparatus of claim 12, wherein at least one of: (i) a CXL port of the at least one CXL port is further configured to operate over a physical layer based on a non-CXL scale-up interconnect comprising at least one of NVLink, Ultra Accelerator Link (UALink), or Ethernet Scale-Up Networking (ESUN), and the representation comprises values characterizing memory access patterns to memory accessible through the non-CXL scale-up interconnect; or (ii) the processing cores comprise at least one hidden core, the at least one hidden core isolated from user access and configured to execute at least a portion of the operations of the circuitry, the at least a portion of the operations comprising at least one of receiving the first telemetry, receiving the second telemetry, or producing the representation.

18. A method comprising:
producing, by a first analyzer associated with a first portion of a Compute Express Link (CXL) fabric, first telemetry of memory accesses at a first resolution, wherein the first telemetry comprises a multi-level heat-map characterizing intensity of accesses to memory regions in the first portion of the CXL fabric, and wherein the CXL fabric comprises memory resources distributed across at least one of hosts, memory pools, or CXL switches;
producing, by a second analyzer associated with a second portion of the CXL fabric, second telemetry of memory accesses at a second resolution lower than the first resolution, wherein the second telemetry comprises a binary hot-or-cold classification of memory regions in the second portion of the CXL fabric;
receiving, by a computer, the first telemetry from the first analyzer and the second telemetry from the second analyzer; and
producing, by the computer based on the first telemetry and the second telemetry, a representation of memory access tracking across the CXL fabric, wherein the representation comprises values calculated based on the first telemetry and the second telemetry, and wherein the representation is usable by a memory tiering algorithm to determine mapping of memory regions across the CXL fabric.

19. The method of claim 18, wherein the computer comprises a Central Processing Unit (CPU) comprising processing cores coupled via a coherent interconnect, and wherein at least one of: (i) the computer is integrated in a same integrated circuit package as the processing cores, and producing the representation is performed without the first telemetry and the second telemetry traversing a link external to the integrated circuit package; (ii) producing the representation comprises mapping the values calculated based on the first telemetry and the values calculated based on the second telemetry to a common intensity scale, and populating values of the representation per memory region of the CXL fabric on the common intensity scale; or (iii) producing the representation comprises combining the values calculated based on the first telemetry with the values calculated based on the second telemetry according to a weighting selected such that the values calculated based on the first telemetry contribute to the representation differently from the values calculated based on the second telemetry.

20. The method of claim 18, further comprising at least one of: (i) issuing, by the computer based on the representation, a migration directive to at least one entity of the CXL fabric, the migration directive identifying at least one memory region of the CXL fabric for migration and a destination among the memory resources of the CXL fabric for the at least one memory region; (ii) reconfiguring, by the computer based on the representation, at least one of the first analyzer or the second analyzer by adjusting at least one of an analysis granularity, a sampling rate, an epoch duration, or a threshold; or (iii) producing the first telemetry by the first analyzer at a first temporal granularity, and producing the second telemetry by the second analyzer at a second temporal granularity at least an order of magnitude coarser than the first temporal granularity.
